(19) United States
(12) Patent Application Publication
(10) Pub. No.: US 2023/0420674 A1
(43) Pub. Date: Dec. 28, 2023

(54) GRAPHENE, ELECTRODE, SECONDARY BATTERY, VEHICLE, AND ELECTRONIC DEVICE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Kazutaka KURIKI, Ebina, Kanagawa (JP); Taisuke NAKAO, Atsugi, Kanagawa (JP); Teruaki OCHIAI, Atsugi, Kanagawa (JP)

(21) Appl. No.: 18/252,959

(22) PCT Filed: Nov. 5, 2021
(86) PCT No.: PCT/IB2021/060243

§ 371 Date: May 15, 2023

(30) Foreign Application Priority Data
Nov. 17, 2020 (JP) 2020-191190

(51) Int. Cl. H01M 4/583; H01M 4/133; C01B 32/194

(52) U.S. Cl. CPC H01M 4/5835; H01M 4/133; C01B 32/194; C01B 2204/22; C01P 2006/40; C01P 2002/01; C01P 2002/85; C01P 2004/04; C01P 2002/82

(57) ABSTRACT

Novel graphene is provided. A novel graphene compound is provided. An electrode having a high output is provided. A novel electrode is provided. A secondary battery with little deterioration is provided. A secondary battery with a high degree of safety is provided. Graphene has a vacancy formed with a many-membered ring that is a nine- or more-membered ring composed of carbon atoms. One or more of the carbon atoms included in the many-membered ring are terminated with fluorine.

### TECHNICAL FIELD

The present invention relate to a secondary battery including a negative electrode active material and a method for fabricating the secondary battery including a negative electrode active material. The present invention relates to a secondary battery including a positive electrode active material and a method for fabricating the secondary battery including a positive electrode active material. The present invention relates to a secondary battery using graphene and a method for fabricating the secondary battery using graphene. The present invention relates to an electronic device such as a portable information terminal, a vehicle, and the like each including a secondary battery.

One embodiment of the present invention relates to an object, a method, or a fabrication method. Alternatively, the present invention relates to a process, a machine, manufacture, or a composition of matter. One embodiment of the present invention relates to a semiconductor device, a display device, a light-emitting device, a power storage device, a lighting device, an electronic device, or a fabrication method thereof.

Note that electronic devices in this specification mean all devices including power storage devices, and electro-optical devices including power storage devices, information terminal devices including power storage devices, and the like are all electronic devices.

Note that in this specification, power storage devices mean all elements and devices each having a function of storing power. For example, a power storage device (also referred to as a secondary battery) such as a lithium-ion secondary battery, a lithium-ion capacitor, and an electric double-layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential for today's information society as rechargeable energy supply sources.

Regarding lithium-ion secondary batteries, research on the crystal structure of a positive electrode active material is performed (Non-Patent Document 1).

In addition, improvement of a negative electrode with a coating film has been studied to increase the cycle performance and the capacity of a lithium-ion secondary battery (Patent Document 1).

Fluorine has high electronegativity and its reactivity has been studied variously. Non-Patent Document 2 describes a reaction of a compound containing fluorine.

A silicon-based material has high capacity and is used as an active material of a secondary battery. A silicon-based material can be characterized by a chemical shift value obtained from an NMR spectrum (Patent Document 2).

### REFERENCE

### Patent Document

[Patent Document 1] Japanese Published Patent Application No. 2015-88482
[Patent Document 2] Japanese Published Patent Application No. 2015-156355

### Non-Patent Document

[Non-Patent Document 1] Zhaohui Chen et al, “Staging Phase Transitions in LixCoO2”, Journal of The Electrochemical Society, 2002, 149(12) A1604-A1609
[Non-Patent Document 2] W. E. Counts et al, “Flouride Model Systems: II, The Binary Systems CaF₂—BeF₂, MgF₂—BeF₂, and LiF—MgF₂,” Journal of the American Ceramic Society, (1953) 36[1] 12-17. FIG. 01471

### SUMMARY OF THE INVENTION

### Problems to be Solved by the Invention

An object of one embodiment of the present invention is to provide novel graphene. Another object of one embodiment of the present invention is to provide a novel graphene compound. Another object of one embodiment of the present invention is to provide an electrode having high output. Another object of one embodiment of the present invention is to provide a novel electrode.

Another object of one embodiment of the present invention is to provide a novel method for fabricating graphene. Another object of one embodiment of the present invention is to provide a novel method for fabricating a graphene compound. Another object of one embodiment of the present invention is to provide a novel method for fabricating an electrode.

Another object of one embodiment of the present invention is to provide a secondary battery with little deterioration. Another object of one embodiment of the present invention is to provide a highly safe secondary battery. Another object of one embodiment of the present invention is to provide a novel secondary battery

Another object of one embodiment of the present invention is to provide a novel substance, novel active material particles, a novel secondary battery, a novel power storage device, or a novel fabrication method thereof.

Note that the description of these objects does not preclude the existence of other objects. One embodiment of the present invention does not need to achieve all these objects. Other objects can be derived from the description of the specification, the drawings, and the claims.

### Means for Solving the Problems

One embodiment of the present invention is a graphene including a vacancy formed with a many-membered ring that is a nine- or more-membered ring composed of carbon atoms.

In the graphene described above, one or more of the carbon atoms included in the many-membered ring are preferably terminated with fluorine.

The graphene preferably includes a first peak at 1580 cm⁻¹ or in the neighborhood thereof and a second peak at 1360 cm⁻¹ or in the neighborhood thereof when the graphene is analyzed by Raman spectroscopy.

Another embodiment of the present invention is an electrode including an active material particle and graphene, the graphene includes a vacancy formed with a many-membered ring that is a nine- or more-membered ring composed of carbon atoms, and the graphene covers at least part of a surface of the active material particle.

In the graphene included in the above electrode, one or more of the carbon atoms included in the many-membered ring are preferably terminated with fluorine.

The graphene included in the above electrode preferably includes a first peak at 1580 cm⁻¹ or in the neighborhood thereof and a second peak at 1360 cm⁻¹ or in the neighborhood thereof when the graphene is analyzed by Raman spectroscopy.

In the above structure, the active material particle is preferably a positive electrode active material particle.

In the above structure, the active material particle is preferably a negative electrode active material

Another embodiment of the present invention is a secondary battery including the electrode described in any of the above structures and an electrolyte.

Another embodiment of the present invention is an electronic device including the secondary battery described above.

Another embodiment of the present invention is a vehicle including the secondary battery described above.

### Effect of the Invention

According to one embodiment of the present invention, novel graphene can be provided. According to another embodiment of the present invention, a novel graphene compound can be provided. According to another embodiment of the present invention, an electrode having high output can be provided. According to another embodiment of the present invention, a novel electrode can be provided.

According to another embodiment of the present invention, a novel method for fabricating graphene can be provided. According to another embodiment of the present invention, a novel method for fabricating a graphene compound can be provided. According to another embodiment of the present invention, a novel method for fabricating an electrode can be provided.

According to another embodiment of the present invention, a secondary battery with little deterioration can be provided. According to another embodiment of the present invention, a secondary battery with high safety can be provided. According to another embodiment of the present invention, a novel secondary battery can be provided.

According to one embodiment of the present invention, a novel substance, novel active material particles, a novel secondary battery, a novel power storage device, or a fabrication method thereof can be provided.

Note that the description of these effects does not preclude the existence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1A, FIG. 1B, and FIG. 1C are diagrams illustrating an example of a cross section of an electrode.

FIG. 2A and FIG. 2B are diagrams illustrating an example of a cross section of an electrode.

FIG. 3 is a diagram illustrating crystal structures of a positive electrode active material.

FIG. 4 is a diagram illustrating crystal structures of a positive electrode active material.

FIG. 5 is a phase diagram.

FIG. 6A and FIG. 6B are diagrams each illustrating an example of a fabrication method.

FIG. 7 is a diagram illustrating an example of a method for fabricating an electrode of one embodiment of the present invention.

FIG. 8A and FIG. 8B are diagrams each illustrating an example of a method for fabricating a positive electrode active material of one embodiment of the present invention.

FIG. 9 is a diagram illustrating an example of a method for fabricating a positive electrode active material of one embodiment of the present invention.

FIG. 10 is a diagram illustrating an example of a method for fabricating a positive electrode active material of one embodiment of the present invention.

FIG. 11 is a diagram illustrating an example of a method for fabricating a positive electrode active material of one embodiment of the present invention.

FIG. 12A and FIG. 12B are examples of cross-sectional views of a secondary battery.

FIG. 13A and FIG. 13B are diagrams each illustrating examples of an exterior of a secondary battery.

FIG. 14A and FIG. 14B are diagrams illustrating an example of a method for fabricating a secondary battery.

FIG. 15A and FIG. 15B are diagrams for describing a method for fabricating a secondary battery.

FIG. 16 is a diagram illustrating an example of an exterior of a secondary battery.

FIG. 17 is a top view illustrating an example of a fabrication apparatus for a secondary battery.

FIG. 18 is a cross-sectional view illustrating an example of a method for fabricating a secondary battery.

FIG. 19A to FIG. 19C are perspective diagrams illustrating an example of a method for fabricating a secondary battery. FIG. 19D is a cross-sectional view corresponding to FIG. 19C.

FIG. 20A to FIG. 20F are perspective views illustrating an example of a method for fabricating a secondary battery.

FIG. 21 is a cross-sectional view illustrating an example of a secondary battery.

FIG. 22A is a diagram illustrating an example of a secondary battery. FIG. 22B and FIG. 22C are diagrams illustrating an example of a method for fabricating a stack.

FIG. 23A to FIG. 23C are diagrams illustrating an example of a method for fabricating a secondary battery.

FIG. 24A and FIG. 24B are cross-sectional views illustrating examples of a stack. FIG. 24C is a cross-sectional view illustrating an example of a secondary battery.

FIG. 25A and FIG. 25B are diagrams illustrating an example of a secondary battery. FIG. 25C is a diagram illustrating the internal state of the secondary battery.

FIG. 26A to FIG. 26C are diagrams illustrating an example of a secondary battery.

FIG. 27A is a perspective view illustrating an example of a battery pack. FIG. 27B is a block diagram illustrating an example of the battery pack. FIG. 27C is a block diagram illustrating an example of a vehicle including a motor.

FIG. 28A to FIG. 28E are diagrams illustrating examples of transport vehicles.

FIG. 29A is a diagram illustrating an electric bicycle, FIG. 29B is a diagram illustrating a secondary battery of the electric bicycle, and FIG. 29C is a diagram illustrating an electric motorcycle.

FIG. 30A and FIG. 30B are diagrams illustrating examples of a power storage device.

FIG. 31A to FIG. 31E are diagrams illustrating examples of electronic devices.

FIG. 32A to FIG. 32H are diagrams illustrating examples of electronic devices.

FIG. 33A to FIG. 33C are diagrams illustrating examples of electronic devices.

FIG. 34 is a diagram illustrating an example of an electronic device.

FIG. 35A to FIG. 35C are diagrams illustrating examples of electronic devices.

FIG. 36A to FIG. 36C are diagrams illustrating examples of electronic devices.

FIG. 37 is an optical micrograph.

FIG. 38A, FIG. 38B, and FIG. 38C show evaluation results of Raman spectroscopy.

FIG. 39 shows a Raman spectrum.

FIG. 40 is a TEM image.

FIG. 41A and FIG. 41B are FFT filtering images of the TEM image.

FIG. 42A and FIG. 42B are FFT filtering images of the TEM image. FIG. 42C is a TEM image obtained by calculation.

FIG. 43A is a STEM image. FIG. 43B shows an EDX analysis result.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing a minus sign (−) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is a region that is preferably less than or equal to 50 nm, further preferably less than or equal to 35 nm, still further preferably less than or equal to 20 nm from the surface, for example. A plane generated by a split and a crack may also be referred to as a surface. In addition, a region which is deeper than the surface portion is referred to as an inner portion.

In this specification and the like, the charge depth obtained when all the lithium that can be inserted and extracted is inserted into a positive electrode active material is 0, and the charge depth obtained when all the lithium that can be inserted and extracted in the positive electrode active material is extracted is 1.

In addition, in this specification and the like, charge refers to transfer of lithium ions from a positive electrode to a negative electrode in a battery and transfer of electrons from a positive electrode to a negative electrode in an external circuit. For a positive electrode active material, extraction of lithium ions is called charge. A positive electrode active material with a charge depth of greater than or equal to 0.7 and less than or equal to 0.9 may be referred to as a positive electrode active material charged with high voltage.

Similarly, discharge refers to transfer of lithium ions from a negative electrode to a positive electrode in a battery and transfer of electrons from a negative electrode to a positive electrode in an external circuit. Discharge of a positive electrode active material refers to insertion of lithium ions. Furthermore, a positive electrode active material with a charge depth of less than or equal to 0.06 or a positive electrode active material from which 90% or more of the charge capacity in a high-voltage charged state is discharged is referred to as a sufficiently discharged positive electrode active material.

In this specification and the like, an unbalanced phase change refers to a phenomenon that causes a nonlinear change in physical quantity. For example, an unbalanced phase change occurs before and after peaks in a dQ/dV curve obtained by differentiating capacitance (Q) with voltage (V) (dQ/dV), which can largely change the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

The discharging rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharge is performed with a current of X/5 (A) is rephrased as to perform discharge at 0.2 C. The same applies to the charging rate; the case where charge is performed with a current of 2X (A) is rephrased as to perform charge at 2 C, and the case where charge is performed with a current of X/5 (A) is rephrased as to perform charge at 0.2 C.

Constant current charge refers to a method of performing charge at a fixed charging rate, for example. Constant voltage charge refers to a charging method in which voltage is fixed when reaching the upper voltage limit, for example. Constant current discharge refers to a method of performing discharge at a fixed discharging rate, for example.

### Embodiment 1

In this embodiment, graphene and an electrode of one embodiment of the present invention are described.

Graphene of one embodiment of the present invention includes a vacancy formed with a many-membered ring composed of carbon atoms. The many-membered ring is preferably anine- or more-membered ring. Examples of the nine- or more-membered ring include a twelve-membered ring, an eighteen-membered ring, and a twenty two-membered ring.

A vacancy included in graphene of one embodiment of the present invention is preferably formed by mixing a material to be graphene as a first material, a compound containing halogen as a second material, and a compound to cause a eutectic reaction with the second material as a third material and heating the mixture. As the material to be graphene, graphene oxide can be used, for example.

Furthermore, graphene of one embodiment of the present invention preferably contains halogen. One or more of carbon atoms included in a many-membered ring are preferably terminated with a halogen atom. Fluorine is particularly preferable as halogen.

Graphene of one embodiment of the present invention preferably includes a functional group. A hydroxy group, an epoxy group, and a carboxy group are given as examples of the functional group included in graphene of one embodiment of the present invention. Furthermore, the functional group included in the graphene of one embodiment of the present invention may be bonded to carbon included in a many-membered ring included in the graphene of one embodiment of the present invention.

Graphene of one embodiment of the present invention has a sheet-like shape. Graphene has a two-dimensional structure formed with six-membered rings composed of carbon atoms. It can also be said that graphene is a sheet having a two-dimensional structure formed with six-membered rings composed of carbon atoms. Graphene of one embodiment of the present invention includes a vacancy formed with a many-membered ring composed of carbon atoms in part of the sheet.

An electrode of one embodiment of the present invention includes an active material particle and graphene. The graphene preferably covers at least part of a surface of the active material particle.

An electrode of one embodiment of the present invention includes an active material particle and a plurality of graphenes. At least part of the surface of the active material particle may be covered with the plurality of graphenes. The plurality of graphenes may include a region overlapping with each other and a region not overlapping with each other. Parts of the plurality of graphenes are allowed to overlap with each other, whereby a sheet having a larger area can be provided. For example, a first graphene includes a first region overlapping with the active material particle and a second graphene. The first region is placed over a surface of the active material particle. The first region is placed between the active material particle and the second graphene. The second graphene is allowed to overlap with the first region of the first graphene, so that parts of the first graphene and the second graphene can overlap with each other. The first graphene and the second graphene are sometimes bonded to each other in the region overlapping with each other. In addition, the first graphene and the second graphene sometimes attract each other by an intermolecular force in the region overlapping with each other.

Graphene is provided so as to cling to the surface of an active material particle. In addition, graphene preferably includes a region that makes a surface contact with the active material particle. Graphene is preferably provided to be attached to the surface of the active material.

An electrode of one embodiment of the present invention includes a plurality of active material particles and graphene. The graphene is preferably formed to cover at least part of each of surfaces of the plurality of active materials. The graphene preferably clings to the plurality of active material particles.

The electrode of one embodiment of the present invention includes a plurality of active material particles and a plurality of graphenes. The plurality of graphenes have regions overlapping with each other, whereby a sheet having a larger area can be provided. The sheet preferably covers at least part of the surface of each of the plurality of active material particles. The sheet preferably clings to the plurality of active materials.

In the electrode of one embodiment of the present invention, graphene has a pouch-like region. The pouch-like region may be formed with a plurality of graphenes. For example, the plurality of graphenes have a region overlapping with each other, whereby a pouch-like region can be formed. The plurality of active material particles are contained in a pouch-like region.

In the electrode of one embodiment of the present invention, a plurality of graphenes can form a three-dimensional conductive path. In the electrode of one embodiment of the present invention, the plurality of graphenes form a three-dimensional net-like structure in some cases.

The electrode of one embodiment of the present invention includes a current collector and an active material layer, for example. The active material layer is provided over the current collector. The active material layer includes an active material and graphene. The active material layer may include a binder.

As the current collector, a highly conductive material which is not alloyed with a carrier ion such as lithium, for example, a metal such as stainless steel, gold, platinum, zinc, iron, copper, aluminum, or titanium, or an alloy thereof can be used. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions of lithium or the like is preferably used for the current collector for a negative electrode.

As the current collector, a titanium compound may be stacked over the above-described metal element. As a titanium compound, for example, it is possible to use one selected from titanium nitride, titanium oxide, titanium nitride in which part of nitrogen is substituted by oxygen, titanium oxide in which part of oxygen is substituted by nitrogen, and titanium oxynitride (TiO_{z}N_{w}, where 0<z<2 and 0<w<1), or a mixture or a stack of two or more of them. Titanium nitride is particularly preferable because it has high conductivity and has a high capability of inhibiting oxidation. Forming a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, forming a titanium compound over aluminum can inhibit an oxidation reaction between the current collector and the graphene oxide.

In the electrode of one embodiment of the present invention, the plurality of graphenes are distributed in the electrode such that the plurality of graphenes spread three-dimensionally to cover active materials, which can increase the strength of the active material layer. Increasing the strength of the active material layer can inhibit, for example, the collapse of the active material layer. When part of each of the plurality of graphenes is in contact with the current collector, peeling from the current collector of the active material layer can be inhibited, for example. Graphene serves as a conductive agent that provides a conductive path and also serves as a binder for increasing the strengths of the active material layer and the electrode in the electrode in some cases.

In the longitudinal cross section of the active material layer, the sheet-like graphene is dispersed substantially uniformly in a region inside the active material layer. The plurality of graphenes are formed to partly cover the plurality of particulate active materials or adhere to the surfaces of the plurality of particulate active materials, so that the graphenes make surface contact with the active material particles. Here, the longitudinal cross section of the active material layer refers to, for example, a surface substantially perpendicular to the current collector.

Here, a plurality of graphenes can be bonded to each other to form a three-dimensional conductive path. A three-dimensional conductive path formed with bonding of the plurality of graphenes is hereinafter referred to as a graphene net. A graphene net that covers the active materials can function as a binder for bonding the active materials. Accordingly, the amount of the binder can be reduced, or the binder does not have to be used. This can increase the proportion of the active material in the electrode volume and the electrode weight. That is, the charge and discharge capacity of the secondary battery can be increased.

The active material layer can be formed using, for example, graphene oxide and an active material. Here, in forming the active material layer, preferably, graphene oxide is mixed with an active material to provide a layer to be an active material layer and then graphene is obtained by reducing the graphene oxide. That is, the formed active material layer preferably contains reduced graphene oxide. In formation of the active material layer, graphene oxide with extremely high dispersibility in a polar solvent is used, whereby graphene oxide can be uniformly dispersed in a slurry containing graphene oxide and an active material. Thus, graphene can be substantially uniformly dispersed in an inner region of the formed active material layer. The solvent is removed by volatilization from a dispersion medium containing the uniformly dispersed graphene oxide to reduce the graphene oxide; hence, graphenes remaining in the active material layer partly overlap with each other and are dispersed such that surface contact is made, thereby forming a three-dimensional conductive path. Note that graphene oxide may be reduced by heat treatment or with the use of a reducing agent, for example. Note that the slurry is, for example, a mixture of a source material of an active material layer and a solvent.

Alternatively, graphene serving as a conductive agent is formed as a coating film to cover at least part of the surfaces of active materials in advance with a spray dry apparatus, and the active materials provided with the coating film of graphene are further electrically connected to each other by graphene, thereby forming a conductive path.

Graphene in this specification and the like includes, for example, graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like, in some cases. The graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. The graphene compound may include a functional group. The graphene preferably has a bent shape. The graphene may be rounded like carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, for example, reduced graphene oxide contains carbon and oxygen, has a sheet-like shape, and has a two-dimensional structure formed of a six-membered ring composed of carbon atoms. The reduced graphene oxide may also be referred to as a carbon sheet. One sheet of the reduced graphene oxide can function by itself or a plurality sheets may be stacked. The reduced graphene oxide preferably includes a portion where the carbon concentration is higher than 80 atomic % and the oxygen concentration is higher than or equal to 2 atomic % and lower than or equal to 15 atomic %. With at least one or both of such a carbon concentration and such an oxygen concentration, the reduced graphene oxide can function as a conductive agent with high conductivity even with a small amount.

Graphene can sometimes be provided with a vacancy by reduction of graphene oxide.

In addition, the end portion of graphene may be terminated with a halogen atom, especially, fluorine.

When graphene is analyzed by a Raman spectroscopy method, a peak called a G band is observed in some cases. The G band indicates a peak at 1580 cm-¹ or in the neighborhood thereof in Raman spectrum. The observation of G band indicates a sp² bond of carbon. When a defect such as a vacancy is included in graphene, a peak called D band is observed in some cases. The D band indicates a peak at 1360 cm-¹ or in the neighborhood thereof in Raman spectrum.

When the ratio (D/G) in peak intensity of D band to G band is less than 1, it is indicated that the defect density of graphene is low, for example. When a defect such as a vacancy is included in graphene, D/G is greater than or equal to 1, for example, greater than or equal to 1 and less than or equal to 3 or greater than or equal to 1 and less than or equal to 2 in some cases.

It is possible that a bonding including a vacancy in graphene or a functional group bonded to an atom included in the vacancy can be overserved with ToF-SIMS. In addition, a vacancy included in graphene can be observed with TEM observation in some cases.

In observation of graphene with a high-resolution TEM image, a vacancy formed with a many-membered ring is sometimes observed.

In graphene of one embodiment of the present invention, a vacancy formed with a many-membered ring is preferably observed in TEM observation. Furthermore, in graphene of one embodiment of the present invention, a vacancy formed with a many-membered ring that is a nine- or more-membered ring is preferably observed in TEM observation, in particular.

Graphene can be observed, for example, with an FFT filtering image of TEM. The FFT filtering image is an image obtained in the following manner: a TEM image is processed by FFT (Fast Fourier Transform) processing and the obtained image is subjected to IFFT (Inverse Fast Fourier Transform) processing.

An electrode of one embodiment of the present invention can be favorably used for a lithium-ion secondary battery. In the electrode of one embodiment of the present invention, graphene includes a vacancy, and thus a lithium ion serving as a carrier ion can pass through the vacancy. Therefore, even in the case where graphene covers the active material surface, insertion and extraction of lithium into/from the active material is not hindered, leading to the achievement of superior secondary battery characteristics. For example, graphene including a vacancy formed with a many-membered ring that is a nine- or more-membered ring facilitates passage of lithium ions through the vacancy, which is preferable. In many-membered ring that is less than a nine-membered ring, a carbon atom included in the vacancy is close to a lithium ion when the lithium ion passes through the vacancy: thus, the barrier energy in passage of the lithium ion through the vacancy is high in some cases.

In the many-membered ring that is a nine- or more-membered ring, a carbon atom included in the vacancy is appropriately distant from a lithium ion, and the energy is stable, whereby the barrier energy in passage of the lithium ion through the vacancy becomes low in some cases. In addition, halogen, especially fluorine, has high electronegativity and is easily negatively charged. Thus, in the case where a carbon atom included in the vacancy is terminated with halogen, approach of positively-charged lithium ions causes interaction, whereby energy is stable and the barrier energy in passage of the lithium ion through the vacancy can be lowered.

Halogen, especially fluorine, can form a hydrogen bond with a hydrogen atom. In the case where graphene of one embodiment of the present invention contains halogen, and a region in which the active material is terminated with hydrogen or a region in which the active material is terminated with a functional group containing a hydrogen atom, a hydrogen bond can be formed and graphene can cling to the active material.

The electrode of one embodiment of the present invention can be used for a positive electrode and a negative electrode of a secondary battery. The secondary battery of one embodiment of the present invention includes a positive electrode including graphene of one embodiment of the present invention and a negative electrode including graphene of one embodiment of the present invention.

In the case where the electrode of one embodiment of the present invention is used as a positive electrode, a positive electrode active material can be used as the active material. In the case where the electrode of one embodiment of the present invention is used as a negative electrode, a negative electrode active material can be used as the active material.

### <Example of Electrode>

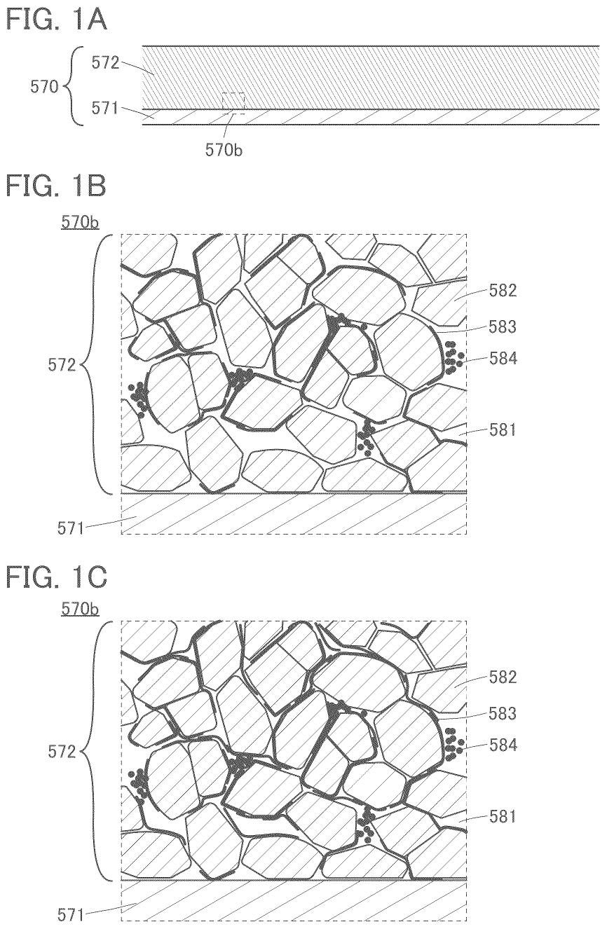

FIG. 1A is a schematic cross-sectional view illustrating an electrode of one embodiment of the present invention. An electrode 570 illustrated in FIG. 1A can be applied to a positive electrode and a negative electrode of a secondary battery. The electrode 570 includes at least a current collector 571 and an active material layer 572 formed in contact with the current collector 571.

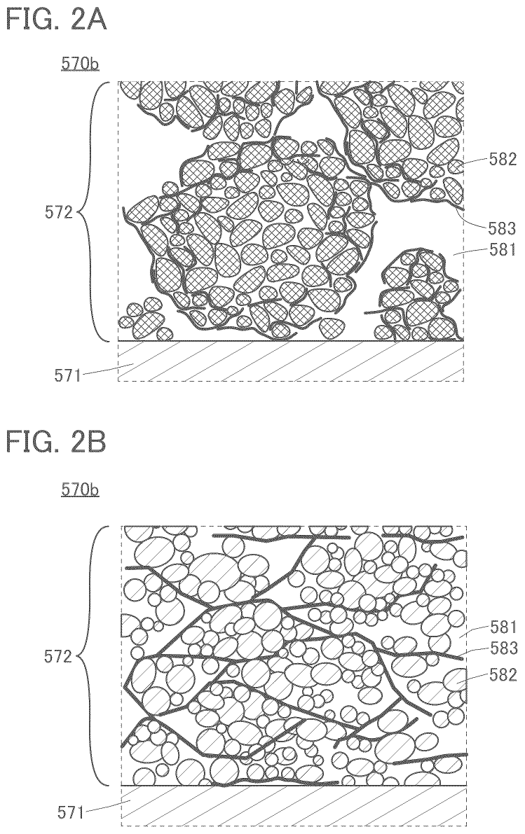

FIG. 1B, FIG. 1C, FIG. 2A, and FIG. 2B are enlarged views of a square region 570b surrounded by the dashed line in FIG. 1A. The active material layer 572 includes an electrolyte 581, a particle 582, and graphene 583.

The active material layer 572 in FIG. 1B includes the particle 582 covered with the graphene 583. In addition, in FIG. 1B, the graphene 583 covers surfaces of the plurality of particles 582 in some cases.

In the active material layer 572 in FIG. 1C, part of a surface of the particle 582 is covered with the graphene 583. The graphene 583 covers surfaces of the plurality of particles 582 in some cases. The graphene 583 is distributed so as to form a three-dimensional conductive path in the electrode.

In the active material layer 572 in FIG. 2A, the plurality of particles 582 are aggregated. Some of the plurality of particles 582 that are aggregated are covered with the graphene 583. The graphene 583 is distributed so as to form a three-dimensional conductive path in the electrode.

In the active material layer 572 in FIG. 2B, a plurality of graphenes 583 form a three-dimensional net-like structure, and the particles 582 are placed among the plurality of graphenes 583.

The particle 582 preferably functions as an active material. A material functioning as an active material can be used as the particle 582. Alternatively, the particle 582 preferably includes a material functioning as an active material, for example. In this specification and the like, the particle 582 is referred to as an active material particle. As the particle 582, various materials can be used. A material that can be used for the particle 582 will be described later.

The active material layer 572 includes the graphene 583. The graphene 583 can function as a conductive agent.

The active material layer 572 preferably contains a carbon-based material such as carbon black, graphite, carbon fiber, or fullerene, in addition to graphene. As the carbon black, acetylene black (AB) or the like can be used. As the graphite, natural graphite or artificial graphite such as mesocarbon microbeads can be used, for example. These carbon-based materials have high conductivity and can function as a conductive agent in the active material layer. Note that these carbon-based materials may each function as an active material. FIG. 1B and FIG. 1C illustrate an example in which the active material layer 572 includes acetylene black 584.

As carbon fiber, mesophase pitch-based carbon fiber, isotropic pitch-based carbon fiber, or the like can be used. As the carbon fiber, carbon nanofiber, carbon nanotube, or the like can be used. Carbon nanotube can be formed by, for example, a vapor deposition method.

The active material layer may include, as a conductive agent, one or more selected from metal powder and metal fiber of copper, nickel, aluminum, silver, gold, and the like, a conductive ceramic material, and the like.

The content of the conductive additive to the total amount of the active material layer is preferably greater than or equal to 1 wt % and less than or equal to 10 wt/o, and further preferably greater than or equal to 1 wt % and less than or equal to 5 wt %. In the case where the active material layer includes graphene and graphene oxide is used as a material to be graphene, the content of the graphene oxide is preferably greater than or equal to 1 wt % and less than or equal to 10 wt %, further preferably greater than or equal to 1 wt % and less than or equal to 5 wt % of the total amount of the active material, graphene oxide, and a binder in a slurry used for forming the active material layer.

Unlike a particulate conductive agent such as carbon black, which makes point contact with an active material, graphene is capable of making low-resistance surface contact; accordingly, the electrical conduction between the particulate active material and graphene can be improved with a smaller amount of graphene than that of a normal conductive agent. This can increase the proportion of the active material in the active material layer. Thus, discharge capacity of the secondary battery can be increased.

Furthermore, lithium easily passes through graphene of one embodiment of the present invention; therefore, the charge and discharge rate of the secondary battery can be increased.

A particulate carbon-containing compound such as carbon black or graphite and a fibrous carbon-containing compound such as carbon nanotube easily enter a microscopic space. A microscopic space refers to, for example, a region between a plurality of active materials or the like. When a carbon-containing compound that easily enters a microscopic space and a sheet-like carbon-containing compound such as graphene that can impart conductivity to a plurality of particles are used in combination, the density of the electrode increases and an excellent conductive path can be formed. When the secondary battery includes the electrolyte of one embodiment of the present invention, the operation of the secondary battery can be more stable. That is, the secondary battery of one embodiment of the present invention can have both high energy density and stability, and is useful as an in-vehicle secondary battery. When a vehicle becomes heavier with increasing number of secondary batteries, more energy is required to move the vehicle, which shortens the driving range. With the use of a high-density secondary battery, the driving range of the vehicle can be increased with almost no change in the total weight of a vehicle equipped with a secondary battery having the same weight.

Furthermore, since a secondary battery for a vehicle with high capacity requires more power for charging, charge with high-rate charging conditions is desirable for charging in a short time. What is called a regenerative charge, in which electric power is generated temporarily when the vehicle is braked and the generated electric power is stored for charging, is performed under high rate charging conditions; thus, a secondary battery for a vehicle is desired to have favorable rate characteristics.

Graphene has high conductivity, and thus the proportion of graphene in the electrode can be lowered. Thus, the surface area of the conductive agent in the electrode can be reduced, which can suppress the decomposition of an electrolytic solution. The decomposition of the electrolytic solution occurs dominantly at high temperatures. Thus, the secondary battery using the electrode of one embodiment of the present invention can suppress deterioration at high temperatures. Since graphene has high conductivity, the secondary battery can operate at high output even at low temperatures. Thus, with use of an electrode of one embodiment of the present invention, an in-vehicle secondary battery having a wide operation temperature range can be obtained. Furthermore, the use of an ionic liquid as an electrolyte can suppress decomposition of the electrolytic solution at high temperatures, and a secondary battery that operates at high temperatures can be provided.

In addition, the secondary battery of one embodiment of the present invention can be downsized owing to its high energy density, and can be charged fast owing to its high conductivity. Thus, the structure of the secondary battery of one embodiment of the present invention is useful also in a portable information terminal.

The active material layer 572 preferably includes a binder (not illustrated). The binder binds or fixes the electrolyte and the active materials, for example. In addition, the binder can bind or fix the electrolyte and a carbon-based material; the active material and a carbon-based material; a plurality of active materials; a plurality of carbon-based materials; or the like.

As the binder, it is preferred to use a material such as polystyrene, poly(methyl acrylate), poly(methyl methacrylate)(PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

Polyimide has extremely excellent thermal, mechanical, and chemical stability. In the case of using polyimide as a binder, a dehydration reaction and a cyclization (imidizing) reaction are performed. These reactions can be performed by heat treatment, for example. In an electrode of one embodiment of the present invention, when graphene including a functional group containing oxygen and polyimide are used as the graphene and the binder, respectively, the graphene can also be reduced by the heat treatment, leading to simplification of the process. Because of high heat-resistance, heat treatment can be performed at a heating temperature of 200° C. or higher. The heat treatment at a heating temperature of 200° C. or higher allows the graphene to be reduced sufficiently and the conductivity of the electrode to increase.

A fluorine polymer which is a high molecular material containing fluorine, specifically, polyvinylidene fluoride (PVDF) can be used, for example. PVDF is a resin having a melting point in the range higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used. Alternatively, fluororubber can be used as the binder.

As the binder, for example, water-soluble polymers are preferably used. As the water-soluble polymers, a polysaccharide or the like can be used, for example. As the polysaccharide, one or more selected from starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferred that such water-soluble polymers be used in combination with any of the above-described rubber materials.

A plurality of the above-described materials may be used in combination for the binder.

The graphene 583 is flexible and has a flexibility, and can cling to the particle 582, which is like natto (fermented soybeans). For example, the particle 582 and the graphene 583 can be likened to a soybean and a sticky ingredient, e.g., polyglutamic acid, respectively. By providing the graphene 583 as a bridge between materials included in the active material layer 572, such as the electrolyte, the plurality of active materials, and the plurality of carbon-based materials, it is possible to not only form a favorable conductive path in the active material layer 572 but also bind or fix the materials with use of the graphene 583. In addition, for example, a three-dimensional net-like structure or an arrangement structure of polygons, e.g., a honeycomb structure in which hexagons are arranged in matrix, is formed using the plurality of graphenes 583, and materials such as the electrolyte, the plurality of active materials, and the plurality of carbon-based materials are placed in meshes, whereby the graphenes form a three-dimensional conductive path and detachment of an electrolyte from the current collector can be inhibited. In the arrangement structure of polygons, polygons with different number of sides may be mixed together. Thus, in the active material layer 572, the graphene 583 functions as a conductive agent and may also function as a binder.

The particle 582 can have any of various shapes such as a rounded shape and an angular shape. In addition, on the cross section of the electrode, the particle 582 can have any of various cross-sectional shapes such as a circle, an ellipse, a shape having a curved line, and a polygon. For example, FIG. 2A illustrates an example in which the cross-sectional shape of the particle 582 has a rounded shape as an example; however, the cross-sectional shape of the particle 582 may be angular, for example. Alternatively, one part may be rounded and another part may be angular.

### <Example of Negative Electrode Active Material>

In the case where the electrode 570 is a negative electrode, a particle containing a negative electrode active material can be used as the particle 582. As the negative electrode active material, a material that can react with carrier ions of the secondary battery, a material into and from which carrier ions can be inserted and extracted, a material that enables an alloying reaction with a metal serving as a carrier ion, a material that enables melting and precipitation of a metal serving as a carrier ion, or the like is preferably used.

Silicon can be used as the negative electrode active material. In the electrode 570, a particle containing silicon is preferably used as the particle 582.

In addition, a metal or a compound containing one or more elements selected from tin, gallium, aluminum, germanium, lead, antimony, bismuth, silver, zinc, cadmium, and indium, can be used as the negative electrode active material. Examples of an alloy-based compound containing such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

A material whose resistance is lowered by addition of an impurity element such as phosphorus, arsenic, boron, aluminum, or gallium to silicon may be used. Furthermore, a silicon material pre-doped with lithium may be used. Examples of a pre-doping method include annealing of a mixture of silicon with lithium fluoride, lithium carbonate, or the like and mechanical alloying of a lithium metal and silicon. A secondary battery may be fabricated in the following manner: an electrode is formed and doped with lithium by a charge and discharge reaction in combination with an electrode made of a lithium metal or the like, and then, the doped electrode and a counter electrode (for example, a positive electrode opposite to the pre-doped negative electrode) are used together to form a secondary battery.

For example, silicon nanoparticles can be used as the particle 582. The average diameter of silicon nanoparticles is, for example, preferably greater than or equal to 5 nm and less than 1 μm, further preferably greater than or equal to 10 nm and less than or equal to 300 nm, still further preferably greater than or equal to 10 nm and less than or equal to 100 nm.

The silicon nanoparticles may have crystallinity. The silicon particles may include a region with crystallinity and an amorphous region.

As a material containing silicon, a material represented by SiO_{z} (z is preferably less than 2, further preferably greater than or equal to 0.5 and less than or equal to 1.6) can be used, for example.

As a material containing silicon, a morphology in which a single particle includes a plurality of crystal grains, for example, can be used. For example, a morphology where a single particle includes one or more silicon crystal grains can be used. The single particle may also include silicon oxide around the silicon crystal grain(s). The silicon oxide may be amorphous. A particle in which graphene cling to a secondary particle of silicon may be used.

As a compound containing silicon, Li₂SiO₃ and Li₄SiO₄ can be used, for example. Each of Li₂SiO₃ and Li₄SiO₄ may have crystallinity or may be amorphous.

The analysis of the compound containing silicon can be performed by NMR, XRD, Raman spectroscopy, SEM, TEM, EDX, or the like.

As the negative electrode active material, it is possible to use, for example, a carbon-based material such as graphite, graphitizing carbon, non-graphitizing carbon, carbon nanotube, carbon black, or graphene.

Furthermore, as the negative electrode active material, an oxide containing one or more elements of titanium, niobium, tungsten, and molybdenum can be used, for example.

As the negative electrode active material, a plurality of the above-described metals, materials, compounds, and the like can be used in combination.

As the negative electrode active material, an oxide such as SnO, SnO₂, titanium dioxide (TiO₂), lithium titanium oxide (Li₄Ti₅O₁₂), a lithium-graphite intercalation compound (Li₂C₆), niobium pentoxide (Nb₂O₅), tungsten oxide (WO₂), or molybdenum oxide (MoO₂) can be used, for example.

Alternatively, as the negative electrode active material, Li_{3-z}M_{z}N (M=Co, Ni, or Cu and z is greater than or equal to 0 and less than 3) with a Li₃N structure, which is a composite nitride of lithium and a transition metal, can be used. For example, Li_{2.6}Co_{0.4}N₃ is preferable because of high charge and discharge capacity (900 mAh/g).

A composite nitride of lithium and a transition metal is preferably used as the negative electrode material, in which case the negative electrode material can be used in combination with a material for a positive electrode material that does not contain lithium ions, such as V₂O₅ or Cr₃O₈. Note that in the case of using a material containing lithium ions as a positive electrode material, the composite nitride of lithium and a transition metal can be used as the negative electrode material by extracting the lithium ions contained in the positive electrode material in advance.

Alternatively, a material that causes a conversion reaction can be used as the negative electrode active material. For example, a transition metal oxide that does not cause an alloying reaction with lithium, such as cobalt oxide (CoO), nickel oxide (NiO), and iron oxide (FeO), may be used as the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides may be used as the positive electrode material because of its high potential.

The volume of the particle 582 sometimes changes in charging and discharging; however, an electrolyte containing fluorine between the plurality of particles 582 in the electrode maintains smoothness and suppresses generation of a crack even when the volume changes in charging and discharging, so that an effect of dramatically increasing cycle performance is obtained. It is important that an organic compound containing fluorine exists between a plurality of active materials included in the electrode.

### <Example of Positive Electrode Active Material>

In the case where the electrode 570 is a positive electrode, a particle containing a positive electrode active material can be used as the particle 582. Examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the positive electrode active material, it is preferable to mix lithium nickel oxide (LiNiO₂ or LiNi_{1-z}Mj_{z}O₂ (0<z<1) (Mj=Co, Al, or the like)) with a lithium-containing material that has a spinel crystal structure and contains manganese, such as LiMn₂O₄. This composition can improve the characteristics of the secondary battery.

As the positive electrode active material, a lithium-manganese composite oxide that can be represented by a composition formula LiₐMn_{b}Mk_{c}O_{d} can be used. Here, the element Mk is preferably silicon, phosphorus, or a metal element other than lithium and manganese, further preferably nickel. In the case where all particles of a lithium-manganese composite oxide are measured, it is preferred to satisfy the following at the time of discharging: 0<a/(b+c)<2; c>0; and 0.26≤(b+c)/d<0.5. Note that the proportions of metals, silicon, phosphorus, and other elements in all particles of a lithium-manganese composite oxide can be measured with, for example, an ICP-MS (inductively coupled plasma mass spectrometer). In addition, the proportion of oxygen in the whole particle of a lithium-manganese composite oxide can be measured by, for example, EDX (energy dispersive X-ray spectroscopy). Alternatively, the proportion can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one element selected from the group consisting of chromium, cobalt, aluminum, nickel, iron, magnesium, molybdenum, zinc, indium, gallium, copper, titanium, niobium, silicon, phosphorus, and the like.

As the positive electrode active material, a particle containing a plurality of the positive electrode active materials listed above may be used. For example, a particle may be used, having a structure in which one of the above-described positive electrode active materials and another one thereof are used and the another positive electrode active material covers at least part of the one of the positive electrode active material. Such a particle in which the another positive electrode active material covers at least part of the one positive electrode active material is referred to as a positive electrode active material composite in some cases. As the composite-making process, any one or more of composite-making processes utilizing mechanical energy such as a mechanochemical method, a mechanofusion method, and a ball mill method; composite-making processes utilizing a liquid phase reaction such as a coprecipitation method, a hydrothermal method, and a sol-gel method; and composite-making processes utilizing a gas phase reaction such as a barrel sputtering method, an ALD (Atomic Layer Deposition) method, an evaporation method, and a CVD (Chemical Vapor Deposition) method can be used, for example. Heat treatment is preferably performed after the composite-making process. Note that the composite-making process is also referred to as a surface coating process or a coating process in some cases. Note that the positive electrode active material particles form a secondary particle in some cases. For example, in the structure illustrated in FIG. 1B and FIG. 1C, the particle 582 may be replaced with a secondary particle formed of the positive electrode active material particles.

### [Structure of Positive Electrode Active Material]

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiMO₂ is given. The element M is one or more elements including a transition metal, for example. The element M is one or more metals including cobalt. The element M can include, for example, one or more elements of magnesium, calcium, zirconium, lanthanum, barium, copper, potassium, sodium, and zinc, in addition to one or more metals including cobalt.

Alternatively, the positive electrode active material of one embodiment of the present invention includes lithium, the element M, and an additive element X. Examples of the additive element X include magnesium, calcium, zirconium, lanthanum, barium, copper, potassium, sodium, zinc, titanium, yttrium, nickel, aluminum, cobalt, manganese, vanadium, iron, chromium, niobium, hafnium, silicon, sulfur, phosphorus, boron, arsenic, chlorine, and fluorine.

It is known that the Jahn-Teller effect in a transition metal compound varies in degree depending on the number of electrons in the d orbital of the transition metal.

In a compound containing nickel, distortion is likely to be caused because of the Jahn-Teller effect in some cases. Accordingly, when LiNiO₂ is subjected to high-voltage charge and discharge, the crystal structure might be lost because of the distortion. The influence of the Jahn-Teller effect is suggested to be small in LiCoO₂; hence, LiCoO₂ is preferable because it has superior resistance to high-voltage charge and discharge in some cases.

Here, the composition of the lithium composite oxide represented by LiMO₂ is not limited to Li M:0=1:1:2. As the lithium composite oxide represented by LiMO₂, lithium cobalt oxide, lithium nickel-cobalt-manganese oxide, lithium nickel-cobalt-aluminum oxide, lithium nickel-cobalt-manganese-aluminum oxide, and the like can be given.

Using cobalt at greater than or equal to 75 atomic %, preferably greater than or equal to 90 atomic %, further preferably greater than or equal to 95 atomic % as the element M brings many advantages such as relatively easy synthesis, easy handling, and excellent cycle performance.

Using nickel at greater than or equal to 33 atomic %, preferably greater than or equal to 60 atomic %, further preferably greater than or equal to 80 atomic % as the element M is preferable because the cost of the raw materials is lower than that of the case of using a large amount of cobalt and charge and discharge capacity per weight is increased in some cases.

When nickel at greater than or equal to 33 atomic %, preferably greater than or equal to 60 atomic %, further preferably greater than or equal to 80 atomic % is used as the element M, the particle diameter is reduced in some cases. Therefore, the above-described third particle preferably contains nickel as the element M at greater than or equal to 33 atomic %, preferably greater than or equal to 60 atomic %, further preferably greater than or equal to 80 atomic %, for example.

Moreover, when nickel is partly contained as the element M together with cobalt, a shift in a layered structure formed of octahedrons of cobalt and oxygen is sometimes inhibited. This enables higher stability of the crystal structure particularly in a high-temperature charged state in some cases, which is preferable. This is presumably because nickel is easily diffused into the inner portion of lithium cobalt oxide and exists in a cobalt site at the time of discharging but can be positioned in a lithium site owing to cation mixing at the time of charging. Nickel existing in the lithium site at the time of charging functions as a pillar supporting the layered structure formed of octahedrons of cobalt and oxygen and presumably contributes to stabilization of the crystal structure.

Note that manganese is not necessarily included as the element M. In addition, nickel is not necessarily included. Furthermore, cobalt is not necessarily included.

At the time of charging, lithium is extracted from the particle surface; accordingly, the surface portion of the particle tends to have a lower lithium concentration than the inner portion and tends to suffer loss of the crystal structure.

The particles of one embodiment of the present invention include lithium, the element M, and oxygen. The particles of one embodiment of the present invention include the lithium composite oxide represented by LiMO₂. The particles of one embodiment of the present invention include one or more selected from magnesium, fluorine, aluminum, and nickel in their surface portions. When the particles of one embodiment of the present invention include one or more of these elements in the surface portions, a structure change owing to charge and discharge is reduced and generation of a crack can be inhibited in the surface portions of the particles. Furthermore, an irreversible structure change in the surface portions of the particles can be inhibited, whereby capacity reduction due to the repetitive charge and discharge can be inhibited. The concentrations of these elements in the surface portion are preferably higher than the concentrations of these elements in the whole particle. In the surface portions of the particles of one embodiment of the present invention, the lithium composite oxide may have a structure in which one or more selected from magnesium, fluorine, aluminum, and nickel is substituted for some atoms, for example.

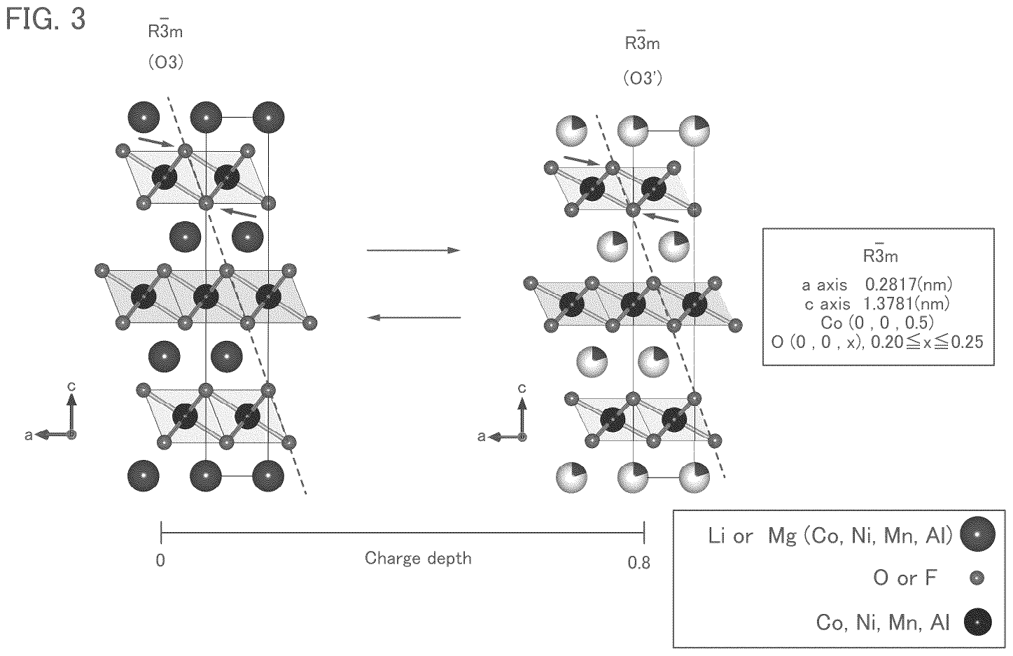

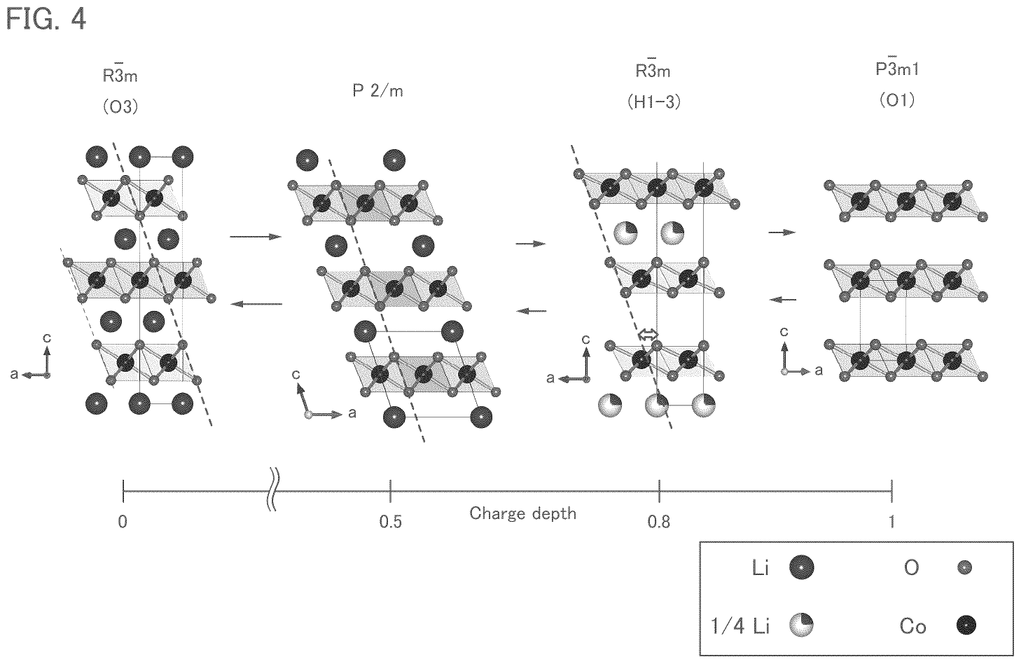

The positive electrode active material will be described with reference to FIG. 3 and FIG. 4.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

In addition, in this specification and the like, a rock-salt crystal structure refers to a structure which has a cubic crystal structure with the space group Fm-3m or the like and includes cations and anions alternately arranged. Note that a cation or anion vacancy may exist.

The orientations of crystals in two regions being substantially aligned with each other can be determined, for example, from a TEM (Transmission Electron Microscope) image, a STEM (Scanning Transmission Electron Microscope) image, a HAADF-STEM (High-Angle Annular Dark Field Scanning TEM) image, an ABF-STEM (Annular Bright-Field Scanning Transmission Electron Microscope) image, or the like. XRD (X-ray Diffraction), electron diffraction, neutron diffraction, and the like can also be used for determination. For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when the angle between the bright lines is greater than or equal to 0 degrees and less than or equal to 5 degrees or greater than or equal to 0 degrees and less than or equal to 2.5 degrees in the TEM image, it can be determined that the crystal planes are substantially aligned with each other, that is, orientations of the crystals are substantially aligned with each other. Similarly, when the angle between the dark lines is 5 degrees or less or 2.5 degrees or less, it can be determined that orientations of the crystals are substantially aligned with each other.

In the positive electrode active material formed according to one embodiment of the present invention, a shift in the CoO₂ layers can be small in repetition of high-voltage charge and discharge. Furthermore, the change in the volume can be small. Thus, the compound can realize excellent cycle performance. In addition, the compound can have a stable crystal structure in a high-voltage charged state. Thus, the compound sometimes makes it difficult for short-circuiting to occur in the case where the high-voltage charged state is maintained; this is preferable because the safety is further improved.

The compound has a small change in the crystal structure and a small difference in volume per the same number of transition metal atoms between a sufficiently discharged state and a high-voltage charged state.

FIG. 3 illustrates examples of the crystal structures of the positive electrode active material before and after charging and discharging. The positive electrode active material in FIG. 3 preferably has a layered rock-salt crystal structure belonging to the space R-3m in the discharge state. The surface portion of the positive electrode active material may include a crystal containing titanium, magnesium, and oxygen and exhibiting a structure different from a layered rock-salt crystal structure in addition to or instead of the region exhibiting a layered rock-salt crystal structure. For example, a crystal containing titanium, magnesium, and oxygen and exhibiting a spinel structure may be included.

A theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., x in LiₓCoO₂ or x in LiₓMO₂. In this specification, LiₓCoO₂ can be replaced with LiₓMO₂ as appropriate. In the case of a positive electrode active material in a secondary battery, x can be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂, or x=0.2. Small x in LiₓCoO₂ means, for example, 0.1<x≤0.24.

Lithium cobalt oxide to be used for a positive electrode, which has been appropriately synthesized and almost satisfies the stoichiometric proportion, is LiCoO₂ with the occupancy rate x of Li, x=1. For a secondary battery after its discharge ends, it can be said that lithium cobalt oxide is LiCoO₂ and x=1. Here, “discharge ends” means that a voltage becomes lower than or equal to 2.5 V (vs. Li counter electrode) at a current of 100 mA/g, for example. In a lithium-ion secondary battery, the voltage rapidly decreases when the occupancy rate of lithium in the lithium sites becomes x=1 and no more lithium enter the sites. At this time, it can be said that the discharge ends. In general, in a lithium-ion secondary battery using LiCoO₂, the discharge voltage rapidly decreases until discharge voltage reaches 2.5 V; thus, discharge ends under the above-described conditions.

The charge depth 0 indicates a state when x is 1, for example. In addition, the increase in the charge depth means that the value of x becomes smaller in the above, for example.

Charge capacity and/or discharge capacity used for calculation of x in LiₓCoO₂ is preferably measured under the condition where there is no influence or small influence of a short circuit and/or decomposition of an electrolyte. For example, data of a secondary battery that is measured while a sudden change in capacity that seems to be derived from a short circuit should not be used for calculation of x.

The crystal structure with a charge depth of 0 (the state where discharge ends) in FIG. 3 is R-3m (O3), which is the same as that in FIG. 4. The positive electrode active material illustrated in FIG. 3 includes a crystal having a structure different from H1-3 crystal structure, in the case of the charge depth indicating being sufficiently charged, for example, when x is less than or equal to 0.24, e.g., approximately 0.2 or 0.12 in the above. This structure is a space group R-3m, having the same symmetry of the CoO₂ layer as that of O3. Accordingly, this structure is referred to as an O3′ type crystal structure. Note that although lithium exists in any of lithium sites at an approximately 20% probability when x is 0.2 in the diagram of the O3′ type crystal structure illustrated in FIG. 3, the structure is not limited thereto. Lithium may exist in only some certain lithium sites. In addition, in both the O3 type crystal structure and the O3′ type crystal structure, a slight amount of magnesium preferably exists between the CoO₂ layers, i.e., in lithium sites. In addition, a slight amount of halogen such as fluorine may exist in oxygen sites at random.

Note that in the O3′ type crystal structure that belongs to the space group R-3m, an ion of cobalt, magnesium, or the like occupies a site coordinated to six oxygen atoms. Note that a light element such as lithium sometimes occupies a site coordinated to four oxygen atoms.

The O3′ type crystal structure can also be regarded as a crystal structure that contains Li between layers at random but is similar to a CdCl₂ crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have cubic closest packed structures (face-centered cubic lattice structures). Anions of an O3′ type crystal are also presumed to have cubic closest packed structures. Thus, when a layered rock-salt crystal and a rock-salt crystal are in contact with each other, there is a crystal plane at which orientations of cubic close-packed structures composed of anions are aligned with each other. Note that a space group of the layered rock-salt crystal and the O3′ type crystal is R-3m, which is different from the space group Fm-3m of a rock-salt crystal (a space group of a general rock-salt crystal); thus, the Miller index of the crystal plane satisfying the above conditions in the layered rock-salt crystal and the O3′ type crystal is different from that in the rock-salt crystal. In the layered rock-salt crystal, the O3′ type crystal, and the rock-salt crystal, a state where the orientations of the cubic close-packed structures composed of anions are aligned is sometimes referred to as a state where crystal orientations are substantially aligned in this specification.

In the positive electrode active material illustrated in FIG. 3, a change in the crystal structure when high-voltage charge is performed and a large amount of lithium is released is more inhibited than in the positive electrode active material illustrated in FIG. 4. As denoted by the dotted lines in FIG. 3, for example, the CoO₂ layers hardly shift between the crystal structures.

More specifically, the structure of the positive electrode active material illustrated in FIG. 3 is highly stable even when a charge voltage is high. For example, the positive electrode active material illustrated in FIG. 3 can maintain the R-3m (O3) crystal structure even at a charge voltage that makes a positive electrode active material illustrated in FIG. 4 have the H1-3 type crystal structure, e.g., a voltage of approximately 4.6 V with reference to the potential of a lithium metal. The positive electrode active material illustrated in FIG. 3 can include a region with the O3′ crystal structure even at a higher charge voltage, e.g., approximately 4.65 V to 4.7 V with reference to the potential of a lithium metal. When the charge voltage is further increased to be higher than 4.7 V, sometimes the H1-3 type crystal is observed in the positive electrode active material shown in FIG. 3. In addition, the positive electrode active material illustrated in FIG. 3 can have the O3′ type crystal structure even at a lower charge voltage (e.g., a charge voltage higher than or equal to 4.5 V and lower than 4.6 V with reference to the potential of a lithium metal), in some cases. Note that in the case where graphite is used as the negative electrode active material in the secondary battery, for example, the voltage of the secondary battery is lower than the above voltage with reference to the potential of the lithium metal by the potential of graphite. The potential of graphite is approximately 0.05 V to 0.2 V with reference to the potential of a lithium metal. Thus, even when the voltage of the secondary battery including graphite as the negative electrode active material is higher than or equal to 4.3 V and lower than or equal to 4.5 V, for example, the positive electrode active material illustrated in FIG. 3 can maintain the R-3m (O3) crystal structure and moreover, includes a region that can have the O3′ type crystal structure at higher voltages, e.g., at a voltage of the secondary battery higher than 4.5 V and lower than or equal to 4.6 V. In addition, the positive electrode active material illustrated in FIG. 3 can have the O3′ type crystal structure at lower charge voltages, e.g., at a voltage of the secondary battery of higher than or equal to 4.2 V and lower than 4.3 V, in some cases.

Thus, in the positive electrode active material illustrated in FIG. 3, the crystal structure is less likely to be lost even when high-voltage charge and discharge are repeated.

The crystal structure in FIG. 4 is denoted by R-3m (O3), and the crystal structure is included in a lithium cobalt oxide when x in LiₓCoO₂ is 1. In this crystal structure, lithium occupies octahedral sites and a unit cell includes three CoO₂ layers. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

The lithium cobalt oxide, illustrated in FIG. 4, with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

When x is 0, the positive electrode active material has a trigonal crystal structure of the space group P-3m1, and one CoO₂ layer exists in a unit cell. Thus, this crystal structure is referred to as an O1 type structure or a trigonal O1 type structure in some cases. Moreover, in some cases, this crystal structure is referred to as a hexagonal O1 type structure when a trigonal crystal is converted into a composite hexagonal lattice.

The lithium cobalt oxide illustrated in FIG. 4 with x of approximately 0.12 has the crystal structure belonging to the space group R-3m. This structure can also be regarded as a structure in which CoO₂ structures such as trigonal O1 type structures and LiCoO₂ structures such as R-3m (O3) are alternately stacked. Thus, this crystal structure is referred to as an H1-3 type crystal structure in some cases. Note that since insertion and extraction of lithium do not necessarily uniformly occur in reality, the H1-3 type crystal structure starts to be observed when x is approximately 0.25 experimentally. The number of cobalt atoms per unit cell in the actual H1-3 type crystal structure is twice that in other structures. However, in drawings mentioned in this specification and the like, the c-axis of the H1-3 type crystal structure is illustrated to be half that of the unit cell for easy comparison with the other crystal structures in some cases.

For the H1-3 type crystal structure, as disclosed in Non-Patent Document 1, the coordinates of cobalt and oxygen in the unit cell can be expressed as follows, for example: Co (0, 0, 0.42150±0.00016), O₁ (0, 0, 0.2767110.00045), and O₂ (0, 0, 0.1153510.00045). O₁ and O₂ are each an oxygen atom. A unit cell suitable for representing a crystal structure in a positive electrode active material can be determined by Rietveld analysis of XRD pattern, for example. In this case, a unit cell with a small GOF (goodness of fit) value may be selected.

The change in the crystal structure between the discharge state when x in LixCoO₂ is 1 and the state when x in LixCoO₂ is 0.24 or less in the positive electrode active material in FIG. 3 is smaller than that in FIG. 4. Specifically, a shift in the CoO₂ layers between the state with x being 1 and the state with x being 0.24 or less can be small. Furthermore, a change in the volume can be small in the comparison between the states with the same number of cobalt atoms.

In the positive electrode active material illustrated in FIG. 3, the difference in volume between the R-3m (O3) in the discharged state and the O3′ type crystal structure that contain the same number of cobalt atoms, is 2.5% or less, specifically 2.2% or less, typically 1.8%.

Note that in the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 0.2797≤a≤0.2837 (nm), further preferably 0.2807≤a≤0.2827 (nm), typically a=0.2817 (nm). The lattice constant of the c-axis is preferably 1.3681≤c≤1.3881 (nm), further preferably 1.3751≤c≤1.3811 (nm), typically, c=1.3781 (nm).

A slight amount of magnesium existing between the CoO₂ layers, i.e., in lithium sites at random, has an effect of inhibiting a shift in the CoO₂ layers in high-voltage charge. Thus, the existence of magnesium between the CoO₂ layers makes it easier to obtain the O3′ type crystal structure.

However, cation mixing occurs when the heat treatment temperature is excessively high; thus, magnesium is highly likely to enter cobalt sites. Magnesium in the cobalt sites is less effective in maintaining the R-3m structure in high-voltage charge in some cases. Furthermore, heat treatment at an excessively high temperature might cause an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium throughout the particle. The addition of the halogen compound decreases the melting point of the lithium cobalt oxide. The decreased melting point makes it easier to distribute magnesium throughout the particle at a temperature at which the cation mixing is unlikely to occur. Furthermore, it is expected that the existence of the fluorine compound can improve corrosion resistance to hydrofluoric acid generated by decomposition of an electrolyte.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material fabricated in accordance with one embodiment of the present invention is preferably more than or equal to 0.001 times and less than or equal to 0.1 times, further preferably more than 0.01 times and less than 0.04 times, still further preferably approximately 0.02 times the number of cobalt atoms. The magnesium concentration described here may be a value obtained by performing element analysis entirely on particles of the positive electrode active material using ICP-MS or the like, or may be a value based on the ratio of raw materials mixed in the process of fabricating the positive electrode active material, for example.

The number of nickel atoms in the positive electrode active material is preferably 7.5% or lower, preferably 0.05% or higher and 4% or lower, further preferably 0.1% or higher and 2% or lower the number of cobalt atoms. The nickel concentration described here may be a value obtained by performing element analysis entirely on particles of the positive electrode active material using ICP-MS or the like, or may be a value based on the ratio of raw materials mixed in the process of fabricating the positive electrode active material, for example.

### <Particle Diameter>

Too large a particle diameter of the positive electrode active material causes problems such as difficulty in lithium diffusion and too much surface roughness of an active material layer in application on a current collector. By contrast, too small a particle diameter causes problems such as difficulty in loading of the active material layer in application on the current collector and overreaction with the electrolyte. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material exhibits the O3′ type crystal structure when charged at a high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described so far, the positive electrode active material has a feature of a small change in the crystal structure between a high-voltage charged state and a discharged state. A material in which a crystal structure largely changing between a high-voltage charged state and a discharged state accounts for 50 wt % or more is not preferred because the material cannot withstand high-voltage charge and discharge. In addition, it should be noted that an objective crystal structure is not obtained in some cases only by addition of impurity elements. For example, there is a case where the O3′ type crystal structure accounts for 60 wt % or more in a high-voltage charged state, and a case where the H1-3 type crystal structure accounts for 50 wt % or more in a high-voltage charged state, although the positive electrode active materials contains magnesium and fluorine in common. Furthermore, at a predetermined voltage, the O3′ type crystal structure accounts for almost 100 wt % of, and with an increase in the predetermined voltage, the H1-3 type crystal structure is generated in some cases. Thus, the crystal structure of the positive electrode active material is preferably analyzed by XRD or the like. The combination with XRD measurement or the like enables more detailed analysis.

However, the crystal structure of a positive electrode active material in a high-voltage charged state or a discharged state may be changed by exposure to the air. For example, the O3′ type crystal structure changes into the H1-3 type crystal structure in some cases. Thus, all samples are preferably handled in an inert atmosphere such as an atmosphere containing argon.

The positive electrode active material illustrated in FIG. 4 is lithium cobalt oxide (LiCoO₂) to which the additive element X is not added. The crystal structure of the lithium cobalt oxide illustrated in FIG. 4 changes depending on a charge depth.

As illustrated in FIG. 4, lithium cobalt oxide with a charge depth of 0 (discharged state) includes a region having the crystal structure belonging to the space group R-3m, and includes three CoO₂ layers in a unit cell. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state. Lithium cobalt oxide with a charge depth of 1 has the crystal structure belonging to the space group P-3m1 and includes one CoO₂ layer in a unit cell. Thus, this crystal structure is referred to as an O1 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification and the like including FIG. 4, the c-axis of the H1-3 type crystal structure is described half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell containing one cobalt and two oxygen. Meanwhile, the O3′ type crystal structure of one embodiment of the present invention is preferably represented by a unit cell including one cobalt and one oxygen. This means that the symmetry of cobalt and oxygen differs between the O3′ type crystal structure and the H1-3 type structure, and the amount of change from the O3 structure is smaller in the O3′ type crystal structure than in the H1-3 type structure. A unit cell suitable for representing a crystal structure in a positive electrode active material can be selected such that the value of GOF (good of fitness) is smaller in Rietveld analysis of XRD pattern, for example.

When charge at a high voltage of 4.6 V or higher with reference to the redox potential of a lithium metal or charge at a large charge depth of 0.8 or more and discharge are repeated, a change in the crystal structure of lithium cobalt oxide between the H1-3 type crystal structure and the R-3m (O3) structure in a discharged state (i.e., an unbalanced phase change) occurs repeatedly.

However, there is a large shift in the CoO₂ layers between these two crystal structures. As indicated by a dotted line and a two-headed arrow in FIG. 4, the CoO₂ layer in the H1-3 type crystal structure largely shifts from that in R-3m (O3). Such a dynamic structural change can adversely affect the stability of the crystal structure. A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as P-3m1 (O1), included in the H1-3 type crystal structure is highly likely to be unstable.

Thus, the repeated high-voltage charge and discharge causes loss of the crystal structure of lithium cobalt oxide. The loss of the crystal structure triggers degradation of the cycle performance. This is probably because the loss of the crystal structure reduces sites where lithium can stably exist and makes it difficult to insert and extract lithium.

### <Example of Fabrication Method of Graphene>

An example of a method for fabricating graphene in accordance with one embodiment of the present invention is described below.

The graphene 583 can be fabricated in the following manner: a material to be graphene as a material 801 is mixed with a compound containing halogen as a material 802 and heat treatment is performed. As the material 801, for example, graphene oxide can be used here.

In addition to the material 802, a material causing a eutectic reaction with the material 802 may be mixed as a material 803. The eutectic point in the eutectic reaction is preferably lower than at least one of the melting point of the material 802 and the melting point of the material 803. With a decrease in the melting point due to the eutectic reaction, the material 802 and the material 803 easily react with the material 801 in some cases in the heat treatment. Furthermore, the material 802 and the material 803 easily cover the surface of the material 801 in the heat treatment, which increases the coverage in some cases.

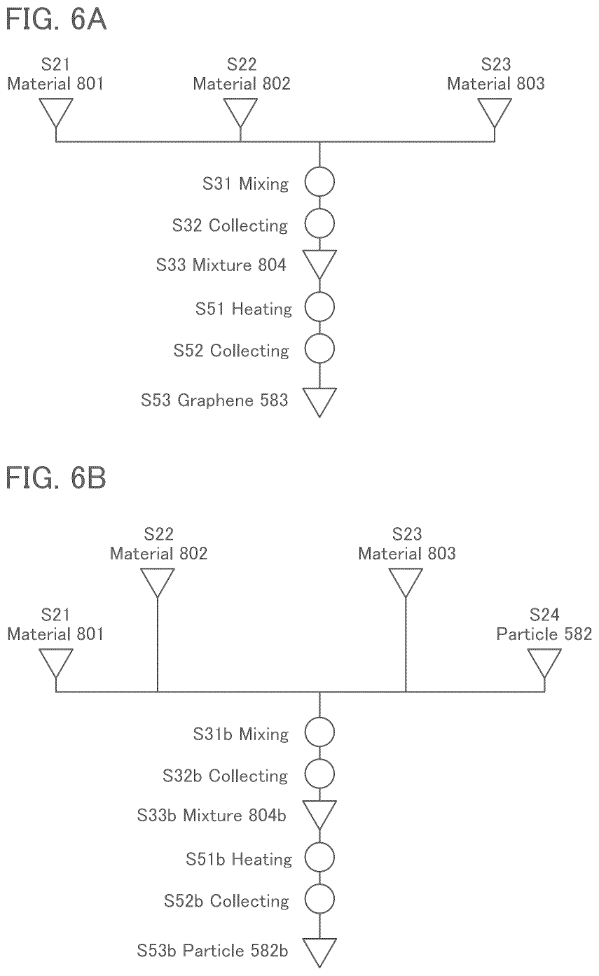

As the material 802 and the material 803, a compound a metal whose ion functions as a carrier ion in the reaction of the secondary battery is used, whereby such a metal can contribute to charge and discharge using its carrier ion, in some cases, when the metal is included in a negative electrode active material. A detailed example of a fabrication method using the material 801, the material 802, and the material 803 will be described later with reference to FIG. 6.

As the material 803, a compound containing oxygen and carbon can be used, for example. As the compound containing oxygen and carbon, carbonate can be used, for example. Alternatively, as the compound containing oxygen and carbon, an organic compound can be used, for example.

Alternatively, as the material 803, hydroxide may be used.

Materials such as carbonate and hydroxide are preferable because many of them are inexpensive and have a high level of safety. Furthermore, carbonate, hydroxide, and the like have a eutectic point with a compound containing halogen, which is preferable.

More specific examples of the material 802 and the material 803 are described. In the use of lithium fluoride as the material 802, lithium fluoride is sometimes difficult to melt and react with the material 801 when lithium fluoride is mixed with the material 801 and heated. In that case, a compound that causes a eutectic reaction with lithium fluoride is used as the material 803, whereby the eutectic reaction between lithium fluoride and the material 803 is caused and fluorine contained in the lithium fluoride and the material 801 are easily reacted.

As an example of the material 803 causing a eutectic reaction with lithium fluoride, lithium carbonate is described.

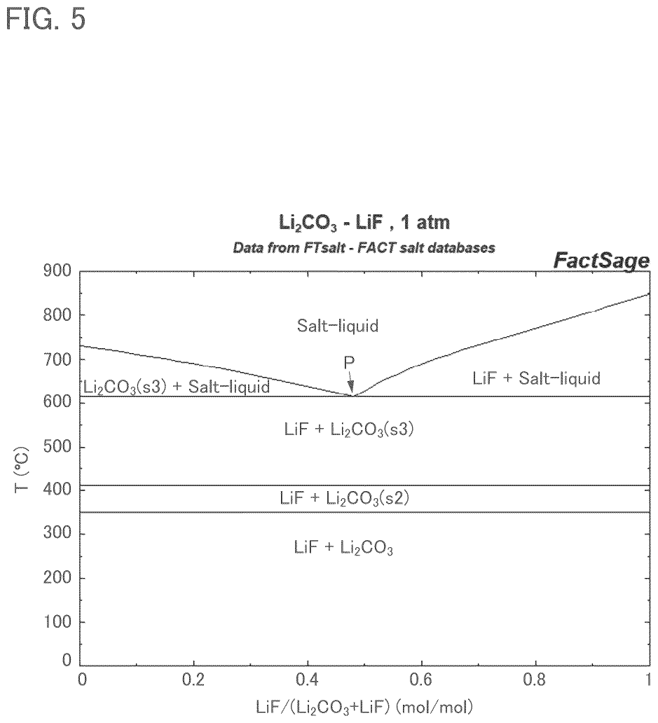

FIG. 5 is a phase chart showing the relation between temperatures and rates of LiF and Li₂CO₃. Data extracted from FACT Salt Phase Diagrams is used in FIG. 5. As shown in FIG. 5, the melting point of LiF is approximately 850° C., but the melting point can be decreased by mixing with Li₂CO₃. For example, at the same heating temperature, dissolution easily occurs and a reaction with the material 801 is easily caused in the case where LiF and Li₂CO₃ are mixed as compared with the case where only LiF is used. In addition, the temperature in heating can be lowered.

With the eutectic reaction, the affinity with the surface of the material 801 can be increased. For example, when graphene is used as the material 801, a C—H bond in graphene has a low affinity with fluorine in some cases, for example. With the eutectic reaction between LiF and Li₂CO₃, the affinity between the C—H bond and the material containing fluorine is increased, whereby the reactivity can be improved.

The molar quantity of LiF with respect to the total molar quantity of LiF and Li₂CO₃ [LiF/(Li₂CO₃+LiF)] is approximately 0.48 at a point P in FIG. 5, which shows the lowest melting point. In other words, at a molar ratio of LiF to Li₂CO₃ (LiF:Li₂CO₃) set to a1: (1−a1), the lowest melting point can be obtained when a1 is in the neighborhood of 0.48. The temperature at the point P is approximately 615° C.

Thus, for example, a1 is preferably a value higher than 0.2, further preferably a value higher than or equal to 0.3. In particular, when a1 is set to a value higher than 0.48, the fluorine content in graphene can be further increased. However, when the fluorine content is too high, the coverage might be poor due to an increase in the melting point. For example, al is preferably a value lower than 0.9, further preferably a value lower than or equal to 0.8.

An example of a method for fabricating graphene of one embodiment of the present invention is described with reference to the flowchart illustrated in FIG. 6A.

In Step S21, the material 801 is prepared. The material 801 is a source material of graphene of one embodiment of the present invention. The material 801 is graphene before fluorine is added, for example. The material 801 is graphene before being reduced, for example. Graphene oxide is used as the material 801 here.

In Step S22, a compound containing halogen is prepared as the material 802. As the compound containing halogen, a halogen compound containing a metal A1 can be used. As the metal A1, one or more elements selected from lithium, magnesium, aluminum, sodium, potassium, calcium, barium, lanthanum, cerium, chromium, manganese, iron, cobalt, nickel, zinc, zirconium, titanium, vanadium, and niobium can be used, for example. As the halogen compound, for example, a fluoride or a chloride can be used. The halogen contained in the compound containing halogen is represented by an element Z. Examples of Z include fluorine and chlorine.

Here, lithium fluoride is prepared as an example.

In Step S23, a compound containing oxygen and carbon is prepared as the material 803. As the compound containing oxygen and carbon, a carbonate containing a metal A2 can be used, for example. As the metal A2, one or more selected from lithium, magnesium, aluminum, sodium, potassium, calcium, barium, lanthanum, cerium, chromium, manganese, iron, cobalt, and nickel can be used, for example.

Here, lithium carbonate is prepared as an example.

Next, in Step S31, the material 801, the material 802, and the material 803 are mixed. In Step S32, a mixture is collected. In Step S33, a mixture 804 is obtained.

The material 802 and the material 803 are preferably mixed in the ratio of (the material 802): (the material 803)=a1:(1−a1) [unit:mol.] where a1 is preferably greater than 0.2 and less than 0.9, further preferably greater than or equal to 0.3 and less than or equal to 0.8.

Furthermore, the material 801 and the material 802 are preferably mixed in the ratio of (the material 801): (the material 802)=1:b1 [unit:mol.] where bi is preferably larger than or equal to 0.001 and smaller than or equal to 0.2.

Next, in Step S51, the mixture 804 is heated.

It is preferable that the heating be performed in a reduction atmosphere because the oxidation of the surface of the material 801 can be inhibited. The reduction atmosphere may be a nitrogen atmosphere or a rare gas atmosphere, for example. Furthermore, two or more types of gases of nitrogen and a rare gas may be mixed and used. The heating may be performed under reduced pressure.

In the case where the melting point of the material 802 is represented by M₂ [K], the heating temperature is preferably higher than (M₂−550) [K] and lower than (M₂+50) [K], further preferably higher than or equal to (M₂−400) [K] and lower than or equal to M₂ [K].

Moreover, in a compound, solid-phase diffusion occurs easily at a temperature higher than or equal to the Tamman temperature. The Tamman temperature of an oxide, for example, is 0.757 times the melting point. Thus, the heating temperature is preferably higher than or equal to 0.757 times the eutectic point or higher than its neighborhood, for example.

In the case of lithium fluoride that is a typical example of the material 802, the amount of evaporation increases rapidly at a temperature higher than or equal to the melting point. Thus, the heating temperature is preferably lower than or equal to the melting point of the material 802, for example.

In the case where the eutectic point of the material 802 and the material 803 is represented by M₂₃ [K], the heating temperature is, for example, preferably higher than (M₂₃×0.7) [K] and lower than (M₂+50) [K], preferably higher than or equal to (M₂₃×0.75) [K] and lower than or equal to (M₂+20) [K], preferably higher than M₂₃ [K] and lower than (M₂+10) [K], further preferably higher than or equal to (M₂₃×0.8) [K] and lower than or equal to M₂ [K], further preferably higher than or equal to (M₂₃) [K] and lower than or equal to M₂ [K].

In the case where lithium fluoride is used as the material 802 and lithium carbonate is used as the material 803, the heating temperature is, for example, preferably higher than 350° C. and lower than 900° C., further preferably higher than or equal to 390° C. and lower than or equal to 850° C., still further preferably higher than or equal to 520° C. and lower than or equal to 910° C., still further preferably higher than or equal to 570° C. and lower than or equal to 860° C., yet still further preferably higher than or equal to 610° C. and lower than or equal to 860° C.

The heating time is preferably longer than or equal to 1 hour and shorter than or equal to 60 hours, further preferably longer than or equal to 3 hours and shorter than or equal to 20 hours, for example.

Next, in Step S52, the heated mixture is collected, whereby the graphene 583 is obtained in Step S53. The graphene 583 fabricated in this example described here is graphene to which fluorine is added, for example. The graphene 583 fabricated in this example described here is, for example, a reduced graphene oxide or graphene to which fluorine is added.

Through the steps described above, graphene of one embodiment of the present invention can be obtained.

### <Example of Forming Method of Particle>

As illustrated in FIG. 6B, it is possible that the particle 582 is used in Step S24, the material 801, the material 802, the material 803, and the particle 582 are added and mixed in Step S31b, and subjected to collection in Step S32b to give the mixture 804b in Step S33b. By using the flowchart illustrated in FIG. 6B, a particle covered with the graphene can be formed. For Step S31b and Step S32b, the descriptions of Step S31 and Step S32 can be referred to. The mixture 804b is heated in Step S51b, the mixture heated is collected in Step S52b, and the particle 582 covered with graphene (hereinafter referred to as a particle 582b) is obtained in Step S53b. For Step S51b and Step S52b, the descriptions of Step S51 and Step S52 can be referred to. In Step S53b, the particle 582 not covered with graphene and graphene not covering the particle 582 are obtained together with the particle 582b in some cases. The particle 582b is, for example, the particle 582 covered with graphene to which fluorine is added. The particle 582b is, for example, the particle 582 that is covered with graphene and contains fluorine.

### <Method for Fabricating Electrode>

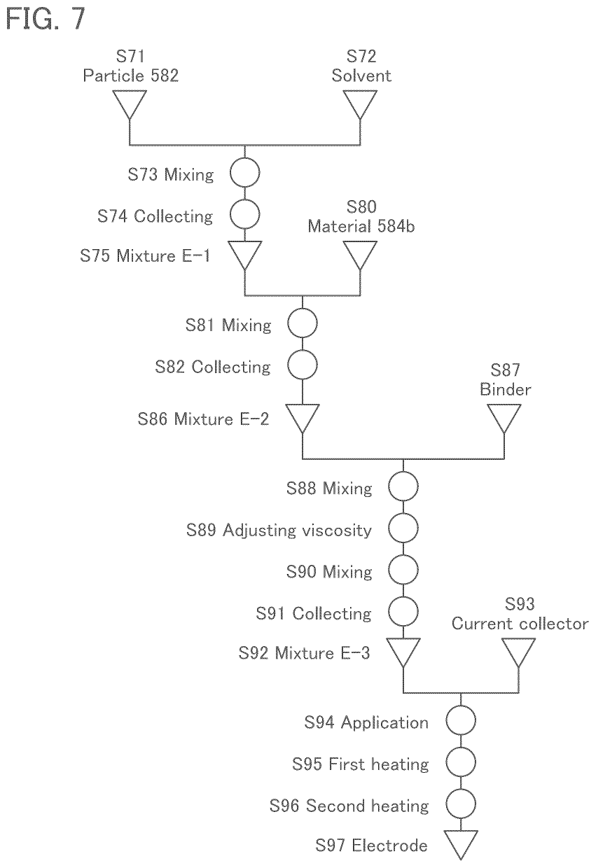

FIG. 7 is a flowchart illustrating an example of a method for fabricating an electrode of one embodiment of the present invention.

In Step S71, the particle 582 is prepared first. Here, a particle containing silicon is prepared. Alternatively, the particle 582b described in the above forming manner can be used in place of the particle 582.

Next, in Step S72, a solvent is prepared. For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as the solvent.

Next, in Step S73, the particle 582 prepared in Step S71 and the solvent prepared in Step S72 are mixed, a mixture is collected in Step S74, whereby a mixture E-1 is obtained in Step S75. A kneader or the like can be used for the mixing. As the kneader, a planetary centrifugal mixer can be used, for example.

Next, in Step S80, a material 584b that later serves as graphene is prepared. Here, graphene oxide can be used as the material 584b. Alternatively, the graphene 583 fabricated in accordance with the flowchart illustrated in FIG. 6 may be used.

Next, the mixture E-1 and the material 584b prepared in Step S80 are mixed in Step S81 and the mixture is collected in Step S82, whereby a mixture E-2 is obtained (Step S86). Note that in the mixing, kneading (kneading with high viscosity) may be performed. In the case where the kneading is performed, a solvent may be added to lower the viscosity and mixing may be further performed, after kneading is performed.

Next, a binder is prepared in Step S87. For the binder, any of the materials described above can be used. Here, polyimide is used. Note that in Step S87, a precursor of a material used as the binder is prepared in some cases. For example, a precursor of polyimide is prepared.

Next, in Step S88, the mixture E-2 is mixed with the binder prepared in Step S87 or a precursor of the binder. Then, in Step S89, the viscosity is adjusted. Specifically, for example, a solvent of the same kind as the solvent prepared in Step S72 is prepared and is added to a mixture obtained in Step S88. By adjusting the viscosity, for example, the thickness, density, and the like of the electrode obtained in Step S97 later can be adjusted in some cases.

Next, the mixture whose viscosity is adjusted in Step S89 is mixed in Step S90 and collected in Step S91, whereby a mixture E-3 is obtained (Step S92). The mixture E-3 obtained in Step S92 is referred to as a slurry, for example.

Next, a current collector is prepared in Step S93.

Next, in Step S94, the mixture E-3 is applied onto the current collector prepared in Step S93. For the application, a slot die method, a gravure method, a blade method, or combination of any of the methods can be used, for example. Furthermore, a continuous coater or the like may be used for the application.

Next, first heating is performed in Step S95. By the first heating, the solvent is volatilized. The first heating is preferably performed at a temperature in the range from 50° C. to 200° C. inclusive, further preferably from 60° C. to 150° C. inclusive.

For example, heat treatment may be performed using a hot plate at 30° C. or higher and 70° C. or lower in an air atmosphere for 10 minutes or longer, and then, for example, heat treatment may be performed at room temperature or higher and 100° C. or lower in a reduced-pressure environment for 1 hour to 10 hours inclusive.

Alternatively, heat treatment may be performed using a drying furnace or the like. In the case of using a drying furnace, for example, heat treatment at a temperature of 30° C. or higher and 120° C. or lower for 30 seconds or longer and 2 hours or shorter may be performed. In addition, the temperature may be increased in stages. For example, after heat treatment is performed at 60° C. or lower for 10 minutes or shorter, heat treatment may further be performed at 65° C. or higher for 1 minute or longer.

Next, second heating is performed in Step S96. When polyimide is used as a binder, a cycloaddition reaction of polyimide is preferably caused by the second heating. In addition, a dehydration reaction of polyimide is caused by the second heating in some cases. Alternatively, a dehydration reaction of polyimide is caused by the first heating in some cases. In the first heating, a cycloaddition reaction of polyimide may be caused. Moreover, a reduction reaction of the material 584b is preferably caused by the second heating.

In Step S97, an electrode provided with an active material layer over the current collector is obtained. The electrode obtained in Step S97 is an electrode including graphene.

The thickness of the active material layer formed in this manner is preferably greater than or equal to 5 μm and less than or equal to 300 μm, further preferably greater than or equal to 10 μm and less than or equal to 150 μm, for example. The loading amount of the active material of the active material layer may be greater than or equal to 2 mg/cm² and less than or equal to 50 mg/cm², for example.

The active material layer may be formed on both surfaces of the current collector or on only one surface of the current collector. Alternatively, there may be regions of both surfaces where the active material layer is partly formed.

After the solvent is volatilized from the active material layer, pressing may be performed by a compression method such as a roll press method and a flat plate press method. In the pressing, heat may be applied.

A fabrication method of one embodiment of the present invention is employed to fabricate an electrode, which enables a three-dimensional conductive path using a plurality of graphenes to be formed in an active material layer of the electrode. In addition, the plurality of graphenes configured in a net-like shape can be included in the electrode.

### <Graphene>

Graphene of one embodiment of the present invention can be obtained in Step S53 in FIG. 6A, Step S53b in FIG. 6B, and Step S97 in FIG. 7. The graphenes obtained in the steps may have different fluorine concentrations and different frequencies of vacancies. In addition, the graphenes obtained in the steps may have different oxygen concentrations.

At least part of graphene obtained in Step S53b of FIG. 6B of one embodiment of the present invention, for example, covers the particle 582.

The graphene obtained in Step S97 in FIG. 7 of one embodiment of the present invention is included inside the electrode. In addition, at least part of graphene obtained in Step S97 in FIG. 7 of one embodiment of the present invention, covers the particle 582, for example. Furthermore, the plurality of graphenes obtained in Step S97 in FIG. 7 of one embodiment of the present invention has a three-dimensional structure in the electrode.

This embodiment can be used in appropriate combination with any of the other embodiments.

### Embodiment 2

In this embodiment, a method for fabricating a positive electrode active material of one embodiment of the present invention is described.

An example of a method for forming the material with a layered rock-salt crystal structure, represented by LiMO₂, is described below. The metal M contains a metal Mel. The metal Mel is one or more kinds of metals containing cobalt. The metal M can contain a metal X in addition to the metal Mel. The metal X is one or more metals selected from magnesium, calcium, zirconium, lanthanum, barium, copper, potassium, sodium, and zinc.

### [Formation Method 1 of Positive Electrode Active Material]

### <Step S11>

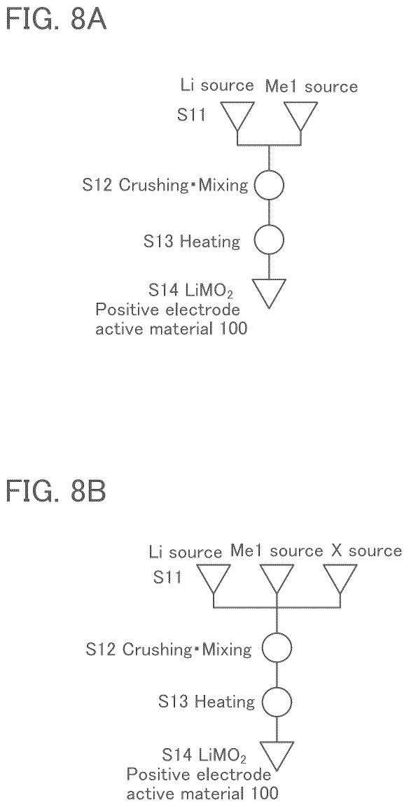

In Step S11 in FIG. 8A, a lithium source and a transition metal source are prepared as materials for lithium and a transition metal. Note that the transition metal source is shown as an Me1 source in the drawing.

As the lithium source, lithium carbonate or lithium fluoride can be used, for example.

For example, at least one of manganese, cobalt, and nickel can be used as the transition metal source. As the transition metal source, cobalt alone; nickel alone; two elements of cobalt and manganese; two elements of cobalt and nickel; or three elements of cobalt, manganese, and nickel may be used, for example.

As the transition metal source used in synthesis, a high-purity material is preferably used. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a secondary battery and/or increase the reliability of a secondary battery.

In addition, it is preferred that the transition metal source here have high crystallinity. For example, the transition metal source preferably includes single crystal particles. Evaluation of the crystallinity of the transition metal source can be determined on the basis of a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. For evaluation of the crystallinity of the transition metal source, X-ray diffraction (XRD), electron diffraction, neutron diffraction, and the like can also be used as materials for determination. Note that the above evaluation of crystallinity can also be employed to evaluate the crystallinity of a primary particle or a secondary particle other than the transition metal source.

When metals that can form a layered rock-salt composite oxide are used, cobalt, manganese, and nickel are preferably mixed at the ratio at which the composite oxide can have a layered rock-salt crystal structure. In addition, an additive element X may be added to these transition metals as long as the composite oxide can have a layered rock-salt crystal structure. FIG. 8B illustrates an example of a step of adding the additive element X. The lithium source, the transition metal source, and an additive element X source are prepared in Step S11, and then Step S12 is performed.

As the additive element X, one or more selected from magnesium, calcium, zirconium, lanthanum, barium, titanium, yttrium, nickel, aluminum, cobalt, manganese, vanadium, iron, chromium, niobium, copper, potassium, sodium, zinc, chlorine, fluorine, hafnium, silicon, sulfur, phosphorus, boron, and arsenic can be used. In addition to the above elements, bromine and beryllium may be used as the additive elements X. Note that the additive elements X given earlier are more suitable because bromine and beryllium are elements having toxicity to living things.

As the transition metal source, an oxide or a hydroxide of the metal described as an example of the transition metal, or the like can be used. As a cobalt source, cobalt oxide, cobalt hydroxide, or the like can be used.

As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S12>

Next, in Step S12, the lithium source and the transition metal source are crushed and mixed. The crushing and mixing can be performed by a dry method or a wet method. Specifically, it is preferable to use super dehydrated acetone whose moisture content is less than or equal to 10 ppm and whose purity is greater than or equal to 99.5% for crushing. Note that in this specification and the like, the term crushing can be rephrased as grinding. For the mixing, a ball mill, a bead mill, or the like can be used, for example. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. For example, mixing may be performed at a peripheral speed of 838 mm/s (the number of rotations: 400 rpm, the ball mill diameter: 40 mm). By using the above-described dehydrated acetone for the crushing and mixing, impurities that might enter the material can be reduced.

### <Step S13>

Next, in Step S13, the materials mixed in the above manner are heated. The heating in this step is preferably performed at higher than or equal to 800° C. and lower than 1100° C., further preferably at higher than or equal to 900° C. and lower than or equal to 1000° C., still further preferably at approximately 950° C. An excessively low temperature might lead to insufficient decomposition and melting of the lithium source and the transition metal source. An excessively high temperature might lead to a defect due to evaporation of lithium from the lithium source and/or excessive reduction of the metal used as the transition metal source, for example. When cobalt is used as the transition metal, for example, a defect in which cobalt has a valence of two might be caused.

For example, the heating time can be longer than or equal to 1 hour and shorter than or equal to 100 hours, and is preferably longer than or equal to 2 hours and shorter than or equal to 20 hours. The heating is preferably performed in an atmosphere with little water, such as dry air (e.g., the dew point is lower than or equal to −50° C., and the dew point is further preferably lower than or equal to −80° C.). For example, the heating may be performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, in the case where the heating is performed at 1000° C. for 10 hours, it is preferable that the temperature rising rate be 200° C./h and the flow rate of dry air be 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S13 is not essential.

Note that a crucible used in the heating in Step S13 is suitably made of a material which is difficult to release impurities. For example, a crucible made of alumina with a purity of 99.9% may be used.

It is suitable to collect the materials that have been subjected to the heating in Step S13 after the materials are transferred from the crucible to a mortar because impurities are prevented from entering the materials. The mortar is suitably made of a material which is difficult to release impurities. Specifically, it is suitable to use a mortar made of alumina with a purity of 90% or higher, preferably 99% or higher. Note that conditions equivalent to those in Step S13 can be employed in an after-mentioned heating step other than Step S13.

### <Step S14>

Through the above steps, the positive electrode active material 100 of one embodiment of the present invention can be formed (Step S14). The positive electrode active material 100 is sometimes referred to as a composite oxide containing lithium, the transition metal, and oxygen (LiMO₂). Note that the positive electrode active material of one embodiment of the present invention only needs to have a crystal structure of a lithium composite oxide represented by LiMO₂, and the composition is not strictly limited to Li:M:O=1:1:2.

A positive electrode active material is formed using a high-purity material for the transition metal source used in synthesis and using a process which hardly allows entry of impurities in the synthesis, whereby a material that has a low impurity concentration, in other words, is highly purified can be obtained. Moreover, the positive electrode active material obtained by such a method for forming a positive electrode active material is a material having high crystallinity. With the positive electrode active material obtained by the method for forming the positive electrode active material of one embodiment of the present invention, the capacity of a secondary battery can be increased and/or the reliability of a secondary battery can be increased.

### [Formation Method 2 of Positive Electrode Active Material]

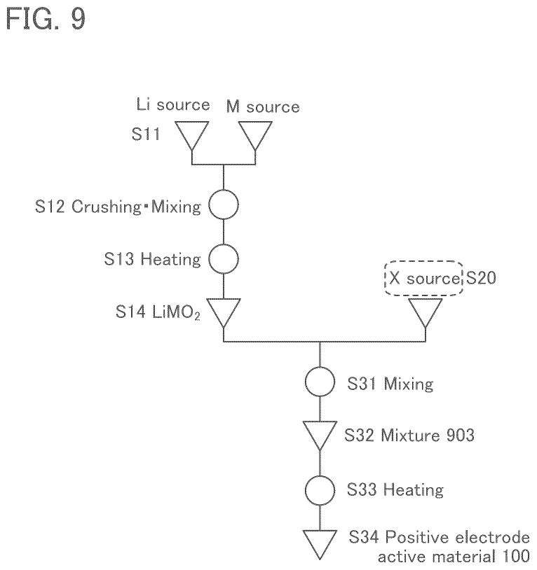

Next, another example of a method for forming a positive electrode active material of one embodiment of the present invention will be described with reference to FIG. 9.

In FIG. 9, Steps S11 to S14 are performed as in FIG. 8A to prepare a composite oxide containing lithium, a transition metal, and oxygen (LiMO₂).

Note that a pre-synthesized composite oxide may be used in Step S14. In that case, Step S11 to Step S13 can be omitted. In the case where a pre-synthesized composite oxide is prepared, a high-purity material is preferably used. The purity of the material is higher than or equal to 99.5%, preferably higher than or equal to 99.9%, further preferably higher than or equal to 99.99%.

Note that a step of performing heating may be provided between Step S14 and the following Step S20. The heating can make a surface of the composite oxide smooth, for example. For the heating, the conditions that are the same as the atmosphere and temperature for Step S33 are used and the treatment time is shorter than that for Step S33. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

<Step S20>

In Step S20 in FIG. 9, an additive element X source is prepared. As the additive element X source, the above-described material can be used. A plurality of elements may be used as the additive elements X. For the addition of the additive element X, a solid phase method, a liquid phase method such as a sol-gel method, a sputtering method, an evaporation method, a CVD (chemical vapor deposition) method, a PLD (pulsed laser deposition) method, or the like can be used.

As the additive element X source, a magnesium source (Mg source) and a fluorine source (F source) are prepared. In addition, a lithium source may be prepared together with the magnesium source and the fluorine source.

As the magnesium source, for example, magnesium fluoride, magnesium oxide, magnesium hydroxide, or magnesium carbonate can be used.

As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. The fluorine source is not limited to a solid, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. A plurality of fluorine sources may be mixed to be used. Among them, lithium fluoride, which has a relatively low melting point of 848° C., is preferable because it is easily melted in a heating step described later.

As the lithium source, for example, lithium fluoride or lithium carbonate can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at approximately LiF:MgF₂=65:35 (molar ratio), the effect of reducing the melting point becomes the highest (Non-Patent Document 2). On the other hand, when the amount of lithium fluoride increases, cycle performance might deteriorate because of too large an amount of lithium. Therefore, the molar ratio of lithium fluoride LiF to magnesium fluoride MgF₂ is preferably LiF:MgF₂=k:1 (0≤k≤1.9), further preferably LiF:MgF₂=k:1 (0.1≤k≤0.5), still further preferably LiF:MgF₂=k:1 (k=0.33 and the neighborhood thereof). Note that in this specification and the like, the neighborhood means a value greater than 0.9 times and less than 1.1 times a certain value.

In the case where the following mixing and crushing step is performed by a wet method, a solvent is prepared. As the solvent, it is preferable to use a protic solvent that hardly reacts with lithium, e.g., ketone such as acetone, alcohol such as ethanol or isopropanol, ether, dioxane, acetonitrile, or N-methyl-2-pyrrolidone (NMP).

Next, the above-described materials are mixed and crushed. Although the mixing can be performed by a dry method or a wet method, a wet method is preferable because the materials can be crushed to a smaller size. For example, a ball mill, a bead mill, or the like can be used for the mixing. When a ball mill is used, zirconia balls are preferably used as media, for example. Conditions of the ball mill or the bead mill may be similar to those in Step S12.

Next, the crushed and mixed materials are collected to obtain the additive element X source. Note that the additive element X source is formed using a plurality of materials and can be referred to as a mixture.

For example, D50 (median diameter) of the mixture is preferably greater than or equal to 600 nm and less than or equal to 20 μm, further preferably greater than or equal to 1 μm and less than or equal to 10 pm. When mixed with a composite oxide containing lithium, the transition metal, and oxygen in the later step, the mixture pulverized to such a small size is easily attached to surfaces of composite oxide particles uniformly. The mixture is preferably attached to the surfaces of the composite oxide particles uniformly, in which case halogen and magnesium are easily distributed to the vicinity of the surface of the composite oxide particle after heating. When there is a region containing neither halogen nor magnesium in the vicinity of the surface, the positive electrode active material might be less likely to have the O3′ type crystal structure described above in the charged state.

Note that the method in which two kinds of materials are mixed is described above, but one embodiment of the present invention is not limited thereto. For example, four kinds of materials (a magnesium source (Mg source), a fluorine source (F source), a nickel source (Ni source), and an aluminum source (Al source)) may be mixed to prepare the additive element X source. Alternatively, a single material, that is, one kind of material may be used to prepare the additive element X source. Note that as a nickel source, nickel oxide, nickel hydroxide, or the like can be used. As an aluminum source, aluminum oxide, aluminum hydroxide, or the like can be used.

### <Step S31>

Next, in Step S31 in FIG. 9, LiMO₂ obtained in Step S14 and the additive element X source are mixed. The ratio of the number of the transition metal atoms Min the composite oxide containing lithium, the transition metal, and oxygen to the number of magnesium atoms Mg contained in the additive element X source is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the particles of the composite oxide. For example, conditions with a lower rotation frequency or shorter time than the mixing in Step S12 are preferable. In addition, it can be said that the dry method has a milder condition than the wet method. For example, a ball mill, a bead mill, or the like can be used for the mixing. When a ball mill is used, zirconia balls are preferably used as media, for example.

In this embodiment, the mixing is performed with a ball mill using zirconia balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 9, the materials mixed in the above are collected, whereby a mixture 903 is obtained.

Note that this embodiment describes a method for adding the mixture of lithium fluoride and magnesium fluoride to lithium cobalt oxide with few impurities; however, one embodiment of the present invention is not limited thereto. A mixture obtained through heating after addition of a magnesium source, a fluorine source, and the like to the starting material of lithium cobalt oxide may be used instead of the mixture 903 in Step S32. In that case, there is no need to separate steps of Step S11 to Step S14 and steps of Step S21 to Step S23, which is simple and productive.

Alternatively, lithium cobalt oxide to which magnesium and fluorine are added in advance may be used. When lithium cobalt oxide to which magnesium and fluorine are added is used, the process can be simpler because the steps up to Step S32 can be omitted.

Alternatively, a magnesium source and a fluorine source may be further added to the lithium cobalt oxide to which magnesium and fluorine are added in advance.

### <Step S33>

Next, in Step S33, the mixture 903 is heated in an oxygen-containing atmosphere. The heating is preferably performed to prevent particles of the mixture 903 from adhering to one another.

The additive is preferably added to the entire surface of the particle not unevenly but uniformly. However, when particles of the mixture 903 adhere to one another during the heating, the additive might be unevenly added to part of the entire surface. There is a possibility that a surface of the particle, which is preferably smooth and even, becomes uneven due to adhered particles and have more defects such as a split and/or a crack. This is probably because the adhesion of the mixture 903 reduces the contact area with oxygen in the atmosphere and blocks a path through which the additives diffuse.

As the heating in Step S33, heating by a rotary kiln may be performed. Heating by a rotary kiln can be performed while stirring is performed in either case of a sequential rotary kiln or a batch-type rotary kiln. As the heating in Step S33, heating by a roller hearth kiln may be performed.

The heating temperature in Step S33 needs to be higher than or equal to the temperature at which a reaction between LiMO₂ and the additive element X source proceeds. Here, the temperature at which the reaction proceeds is preferably a temperature at which interdiffusion between elements contained in LiMO₂ and the additive element X source occurs. Thus, the heating temperature can be lower than the melting temperatures of these materials in some cases. For example, in an oxide, solid-phase diffusion occurs at a temperature that is 0.757 times (Tamman temperature Td) or more the melting temperature Tₘ [K]. Accordingly, the heating temperature in Step S33 is higher than or equal to 500° C., for example.

Note that a temperature higher than or equal to the temperature at which at least part of the mixture 903 is melted is preferable because the reaction proceeds more easily. For example, in the case where LiF and MgF₂ are included as the additive element X source, the eutectic point of LiF and MgF₂ is around 742° C., and the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the heating temperature is further preferably higher than or equal to 830 C.

A higher heating temperature is preferable because it facilitates the reaction, shortens the heating time, and enables high productivity.

Note that the heating temperature needs to be lower than a decomposition temperature of LiMO₂ (1130° C. in the case of LiCoO₂). At a temperature in the neighborhood of the decomposition temperature, a slight amount of LiMO₂ might be decomposed. Thus, the heating temperature in Step S33 is preferably lower than 1130° C., further preferably lower than or equal to 1000° C., further preferably lower than or equal to 950° C., further preferably lower than or equal to 900° C.

Therefore, the temperature of the heating in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C. In addition, at the time of heating the mixture 903, the partial pressure of fluorine or a fluoride in the atmosphere is preferably controlled to be within an appropriate range.

In the formation method described in this embodiment, some of the materials, e.g., LiF as the fluorine source, function as a flux in some cases. Owing to this function, the heating temperature can be lower than or equal to the decomposition temperature of LiMO₂, e.g., a temperature higher than or equal to 742° C. and lower than or equal to 950° C., which allows distribution of the additive such as magnesium in the vicinity of the surface and formation of the positive electrode active material having favorable characteristics.

However, since LiF in a gas phase has a specific gravity less than that of oxygen, heating might volatilize LiF and in this case, LiF in the mixture 903 decreases. As a result, the function of a flux deteriorates. Thus, heating needs to be performed while volatilization of LiF is inhibited. Note that even when LiF is not used as the fluorine source or the like, there is a possibility in that Li and F at a surface of LiMO₂ react with each other to generate LiF and volatilize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

In the case of using a rotary kiln for the heating, the flow rate of an oxygen-containing atmosphere in the kiln is preferably controlled while the mixture 903 is heated. For example, the flow rate of an oxygen-containing atmosphere is preferably set low, or no flow in the atmosphere is preferably performed after an atmosphere is purged first and an oxygen atmosphere is introduced into the kiln.

In the case of using a roller hearth kiln for the heating, the mixture 903 can be heated in an atmosphere containing LiF with the container containing the mixture 903 covered with a lid, for example.

The heating is preferably performed for an appropriate time. The appropriate heating time is changed depending on conditions, such as the heating temperature, and the particle size and composition of LiMO₂ in Step S14. In the case where the particle size is small, a lower temperature or for a shorter time is preferred to that in the case where the particle size is large, in some cases.

When the average particle diameter (D50) of the particles of the composite oxide in Step S14 in FIG. 9 is approximately 12 μm, for example, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example.

On the other hand, when the average particle diameter (D50) of the particles of the composite oxide in Step S14 is approximately 5 pm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. The temperature decreasing time after the heating is, for example, preferably longer than or equal to 10 hours and shorter than or equal to 50 hours.

### <Step S34>

Then, the heated materials are collected, whereby the positive electrode active material 100 is formed. Here, the collected particles preferably pass through a sieve. Through the above steps, the positive electrode active material 100 of one embodiment of the present invention can be obtained (Step S34).

### [Formation Method 3 of Positive Electrode Active Material]

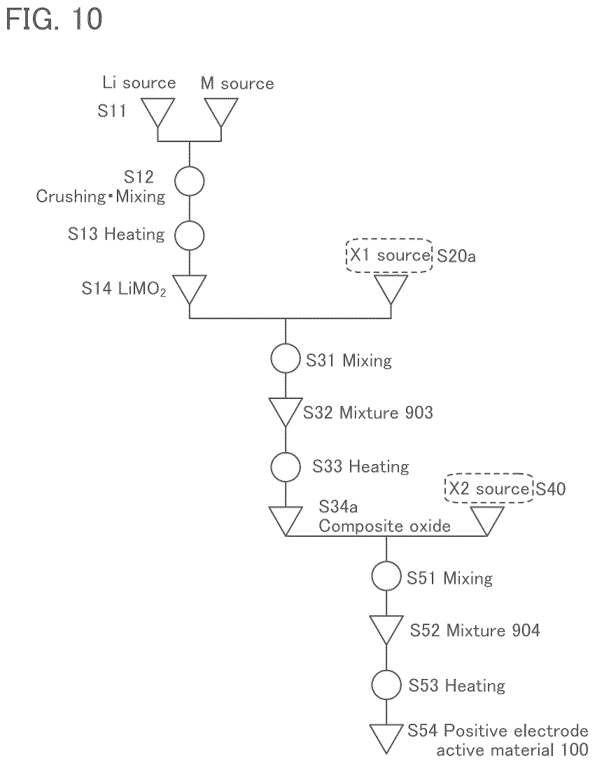

Next, another example of a method for forming a positive electrode active material of one embodiment of the present invention will be described with reference to FIG. 10.

In FIG. 10, Steps S11 to S14 are performed as in FIG. 8A to prepare a composite oxide containing lithium, a transition metal, and oxygen (LiMO₂).

Note that a pre-synthesized composite oxide containing lithium, the transition metal, and oxygen may be used in Step S14. In that case, Step S11 to Step S13 can be omitted.

Note that a step of performing heating may be provided between Step S14 and Step S20 as described with reference to FIG. 9. For the heating, the conditions that are the same as the atmosphere and temperature for Step S33 are used and the treatment time is shorter than that for Step S33.

### <Step S20a>

In Step S20a in FIG. 10, an additive element XI source is prepared. For the additive element X1 source, any of the above-described additive elements X can be selected to be used. For example, one or more selected from magnesium, fluorine, and calcium can be suitably used as the additive element X1. For the addition of the additive element X1, a solid phase method, a liquid phase method such as a sol-gel method, a sputtering method, an evaporation method, a CVD (chemical vapor deposition) method, a PLD (pulsed laser deposition) method, and the like can be used.

Here, a magnesium source (Mg source) and a fluorine source (F source) are prepared as the first additive element X1. Next, with reference to the description of Step S20 illustrated in FIG. 9, crushing, mixing, heating, and the like of the magnesium source and the fluorine source can be performed as appropriate and the additive element source (XI source) can be obtained.

Steps S31 to S33 shown in FIG. 10 can be performed in a manner similar to that of Steps S31 to S33 shown in FIG. 9.

### <Step S34a>

Next, the material heated in Step S33 is collected to form a composite oxide.

### <Step S40>

Then, in Step S40 in FIG. 10, an additive element X2 source is prepared. For the additive element X2 source, any of the above-described additive elements X can be selected to be used. For example, one or more selected from nickel, titanium, boron, zirconium, and aluminum can be suitably used as the additive element X2. In this embodiment, nickel and aluminum are used as the additive elements X2. For the addition of the additive element X2, a solid phase method, a liquid phase method such as a sol-gel method, a sputtering method, an evaporation method, a CVD (chemical vapor deposition) method, a PLD (pulsed laser deposition) method, or the like can be used.

With reference to Step S20 illustrated in FIG. 9, crushing, mixing, heating, and the like are performed as appropriate so that an additive element source (X2 source) can be obtained in Step S40 illustrated in FIG. 10.

In addition, in the case where a plurality of elements are included as the second additive element source, the elements that has been separately subjected to steps up to crushing may be prepared. Accordingly, in Step S40, a plurality of second additive element sources (X2 sources) are prepared separately.

In the case of employing the sol-gel method for addition of the additive element X2, a solvent used for the sol-gel method is prepared as well as the additive element X2 source. For the sol-gel method, a metal alkoxide can be used as the metal source, for example, and alcohol can be used as the solvent, for example. In the case of performing addition of aluminum, aluminum isopropoxide can be used as the metal source and isopropanol (2-propanol) can be used as the solvent, for example. In the case of performing addition of zirconium, zirconium(IV) tetrapropoxide can be used as the metal source and isopropanol can be used as the solvent, for example.

### <Step S51 to Step S53>

Next, Step S51 in FIG. 10 is a step of mixing the composite oxide obtained in Step S34a and the additive element X2 source obtained in Step S40. Note that Step S51 in FIG. 10 can be performed in a manner similar to that in Step S31 illustrated in FIG. 9. In addition, Step S52 in FIG. 10 can be performed in a manner similar to that in Step S32 illustrated in FIG. 9. Note that a material formed in Step S52 in FIG. 10 is a mixture 904. The mixture 904 is a material containing, in addition to the material of the mixture 903, the additive element X2 source added in Step S40. Step S53 in FIG. 10 can be performed in a manner similar to that in Step S33 illustrated in FIG. 9.

### <Step S54>

Then, the heated materials are collected, whereby the positive electrode active material 100 is fabricated. Here, the collected particles preferably pass through a sieve. Through the above steps, the positive electrode active material 100 of one embodiment of the present invention can be obtained (Step S54).

When the step of introducing the transition metal, the step of introducing the additive element X1, and the step of introducing the additive element X2 are separately performed as illustrated in FIG. 10, the element concentration profiles in the depth direction can be made different from each other in some cases. For example, the concentration of an additive can be made higher in the region in the vicinity of the surface than in the inner portion of the particle. Furthermore, with the number of atoms of the transition metal as a reference, the ratio of the number of atoms of the additive element to the reference can be higher in the vicinity of the surface than in the inner portion.

The formation method in which a high-purity material is used for the transition metal source used in synthesis; a process which hardly allows entry of the transition metal source and impurities in the synthesis is employed; entry of impurities in the synthesis is thoroughly prevented; and desired additive elements (the additive element X, the additive element X1, or the additive element X2) are controlled to be introduced into the positive electrode active material can provide a positive electrode active material in which a region with a low impurity concentration and a region where the additive elements are introduced are controlled. In addition, the positive electrode active material having high crystallinity can be obtained. Furthermore, the positive electrode active material obtained by the method for forming a positive electrode active material, which is one embodiment of the present invention, can increase the capacity of a secondary battery and/or increase the reliability of the secondary battery.

### [Formation Method 4 of Positive Electrode Active Material]

Next, as one embodiment of the present invention, a method different from the formation methods 1 to 3 of positive electrode active materials is described.

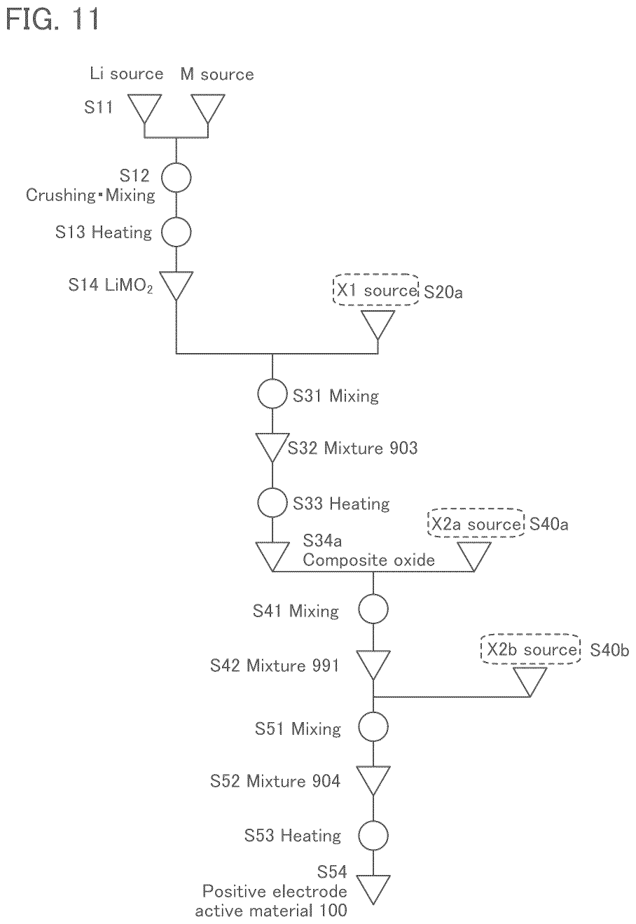

As described above, the additive element X may be added to the composite oxide in a range that allows a layered rock salt crystal structure to be formed. In FIG. 11, Steps S1 to S34a are performed in a manner similar to FIG. 10. In description of this formation method 4, two or more steps of adding the second additive element (X2) are performed.

### <Step S40a>

In Step S40a illustrated in FIG. 11, one second additive element source (hereinafter, denoted by X2a source) is prepared. As the X2a source, a material selected from the additive elements X described for Step S20 with reference to FIG. 9 can be used. For example, one or more selected from nickel, titanium, boron, zirconium, and aluminum can be suitably used as an additive element X2a.

For the addition of the additive element X2a, a solid phase method, a liquid phase method such as a sol-gel method, a sputtering method, an evaporation method, a CVD (chemical vapor deposition) method, a PLD (pulsed laser deposition) method, or the like can be used.

FIG. 11 illustrates an example in which nickel is used as the additive element X2a.

With reference to Step S20 illustrated in FIG. 9, crushing, mixing, heating, and the like are performed as appropriate so that the second additive element source (X2a source) can be obtained in Step S40a illustrated in FIG. 11. For example, a nickel source is obtained as the second additive element source (X2a source) by a solid phase method.

In the case where a plurality of additive element sources are prepared, the additive element sources may be crushed independently.

### <Step S40b>

In Step S40b illustrated in FIG. 11, another second additive element source (hereinafter, denoted by X2b source) can be obtained. For example, the second additive element source (X2b source) is obtained by a sol-gel method. Differently from Step S40a, in the case of using the sol-gel method, independent steps are preferable for preparation. A formation step of the second additive element source (X2b source) using the sol-gel method is described.

In the case of using the sol-gel method, a solvent used in the sol-gel method is prepared in addition to the second additive element (X2b). For the sol-gel method, a metal alkoxide can be used as the metal source, for example, and alcohol can be used as the solvent, for example. In the case where an aluminum source is prepared, aluminum isopropoxide can be used as aluminum alkoxide. In the case where a zirconium source is prepared, zirconium isopropoxide can be used as zirconium alkoxide and isopropanol can be used as a solvent.

Next, aluminum alkoxide, zirconium alkoxide, and isopropanol are mixed (stirred). The sol-gel reaction may be promoted at this time or in the next step. When the sol-gel reaction is promoted, heating may be performed during the mixing. In this manner, a mixture (also referred to as a mixed solution) containing an aluminum source and a zirconium source is prepared as the second additive element source (X2b source).

### <Step S51 to Step S53>

Next, fabrication under conditions similar to those of Steps S31 to S33 illustrated in FIG. 9 can be performed in Steps S51 to S53 illustrated in FIG. 11. Through the above process, the positive electrode active material 100 of one embodiment of the present invention can be fabricated in Step S54. The sol-gel reaction can be promoted in Step S53.

This embodiment can be used in combination with any of the other embodiments.

### Embodiment 3

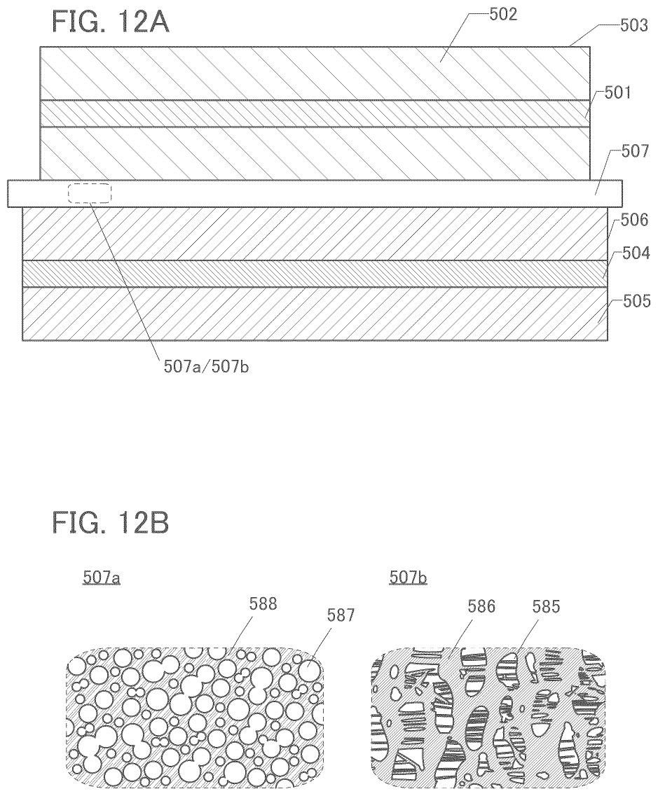

In this embodiment, an example of a lithium-ion secondary battery of one embodiment of the present invention is described with reference to FIG. 12A. The secondary battery includes an exterior body (not illustrated), a positive electrode 503, a negative electrode 506, a separator 507, and an electrolyte in which a lithium salt or the like is dissolved. The separator 507 is provided between the positive electrode 503 and the negative electrode 506.

The positive electrode 503 contains a positive electrode active material. The positive electrode 503 includes a positive electrode active material layer 502 provided over a positive electrode current collector 501. The positive electrode active material layer 502 contains, for example, a positive electrode active material, a conductive agent, and a binder. The electrode described in the above embodiment can be used as a positive electrode of one embodiment of the present invention.

The negative electrode 506 includes a negative electrode active material. The negative electrode 506 includes a negative electrode active material layer 505 provided on a negative electrode current collector 504. The negative electrode active material layer 505 includes, for example, a negative electrode active material, a conductive agent, and a binder. The electrode described in the above embodiment can be used as a negative electrode of one embodiment of the present invention.

### [Electrolyte]

The electrolyte preferably contains a solvent and a metal salt serving as a carrier ion. As the solvent of the electrolyte, an aprotic organic solvent is preferably used; for example, one of ethylene carbonate (EC), propylene carbonate (PC), butylene carbonate, chloroethylene carbonate, vinylene carbonate, y-butyrolactone, y-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of them can be used in an appropriate combination at an appropriate ratio.

One or more ionic liquids (room temperature molten salts) that are less likely to burn and volatize can be used as the solvent of the electrolyte to prevent the secondary battery from exploding or catching fire, for example, even when the secondary battery internally shorts out and the internal temperature increases owing to overcharging or the like. An ionic liquid contains a cation and an anion, specifically, an organic cation and an anion. Examples of the organic cation used for the electrolyte include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the salt dissolved in the above-described solvent, one of lithium salts such as LiPF₆, LiClO₄, LiAsF₆, LiBF₄, LiAlCl₄, LiSCN, LiBr, LiI, Li₂SO₄, Li₂BioCl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte used for the secondary battery is preferably highly purified and contains a small number of dust particles and elements other than the constituent elements of the electrolyte (hereinafter, also simply referred to as impurities). Specifically, the weight ratio of impurities to the electrolyte is preferably less than or equal to 1%, further preferably less than or equal to 0.1%, still further preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte. The concentration of the material to be added is, for example, higher than or equal to 0.1 wt % and lower than or equal to 5 wt % with respect to the whole solvent. VC and LiBOB are particularly preferable because they facilitate formation of a favorable coating film.

A solution containing a solvent and a salt serving as a carrier ion is referred to as an electrolyte solution in some cases.

A polymer gel electrolyte in which a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

As the polymer, a polymer having a polyalkylene oxide structure, such as polyethylene oxide (PEO); PVDF; polyacrylonitrile; or the like can be used. Moreover, a copolymer or the like containing any of them can be used. For example, PVDF-HFP, which is a copolymer of PVDF and hexafluoropropylene (HFP), can be used. The formed polymer may be porous.

As the electrolyte, a solid electrolyte containing an inorganic material such as a sulfide-based and oxide-based inorganic material or a solid electrolyte containing a polymer material such as a PEO (polyethylene oxide)-based polymer material can be used. When the solid electrolyte is used, one or more of a separator and a spacer do not need to be provided. Furthermore, the battery can be entirely solidified; therefore, there is no fear of liquid leakage and thus the safety of the battery is dramatically improved.

### [Separator]

As the separator 507, for example, a separator formed using paper, nonwoven fabric, glass fibers, ceramics, or the like can be used. Alternatively, a separator formed using nylon (polyamide), vinylon (polyvinyl alcohol-based fibers), polyester, acrylic, polyolefin, polyurethane, polypropylene, polyethylene, or the like can be used. The separator is preferably processed to have an envelope-like shape to wrap one of the positive electrode and the negative electrode.

As the separator 507, for example, a polymer film containing polypropylene, polyethylene, polyimide, or the like can be used. Polyimide is further preferably used as the material of the separator 507 in some cases because of its high wettability to an ion liquid.

The polymer film containing polypropylene, polyethylene, or the like can be formed by a dry process or a wet process. The dry process is a process in which the polymer film containing polypropylene, polyethylene, polyimide, or the like is drawn while heated so that spaces are formed between crystals to make minute holes. The wet process is a process in which a resin and a solvent mixed in advance are formed into a film shape and then the solvent is extracted to make holes.

The left view of FIG. 12B is an enlarged view of a region 507a, which illustrates an example of the separator 507 (formed by the wet process). This example shows a structure in which a polymer film 588 has a plurality of holes 587. The right view of FIG. 12B is an enlarged view of a region 507b, which illustrates another example of the separator 507 (formed by the dry process). This example shows a structure in which a polymer film 586 has a plurality of holes 585.

The diameters of the holes in the separator may vary between a surface portion of a surface that faces the positive electrode and a surface portion of a surface that faces the negative electrode after charging and discharging. In this specification and the like, the surface portion of the separator is preferably a region that is less than or equal to 5 μm, further preferably less than or equal to 3 μm from the surface, for example.

The separator may have a multilayer structure. For example, a structure in which two types of polymer materials are stacked may be employed.

Alternatively, a structure in which the polymer film containing polypropylene, polyethylene, polyimide, or the like is coated with a ceramic-based material, a fluorine-based material, a polyamide-based material, a mixture thereof, or the like can be employed, for example. Alternatively, a structure in which nonwoven fabric is coated with a ceramic-based material, a fluorine-based material, a polyamide-based material, a mixture thereof, or the like can be employed, for example. Polyimide is further preferably used as the material used for coating in some cases because of its high wettability to an ion liquid.

Examples of the fluorine-based material include PVDF and polytetrafluoroethylene.

Examples of the polyamide-based material include nylon and aramid (meta-based aramid and para-based aramid).

### [Exterior Body]

For an exterior body included in the secondary battery, one or more selected from a metal material such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be used in appropriate combination with any of the other embodiments.

### Embodiment 4

In this embodiment, a method for fabricating a secondary battery will be described.

### <Fabrication Method of Laminated Secondary Battery 1>

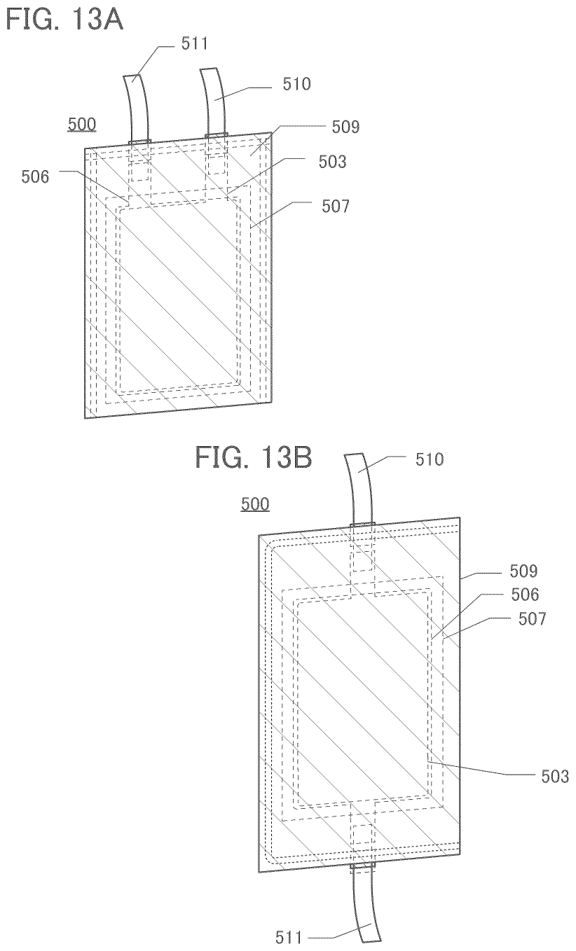

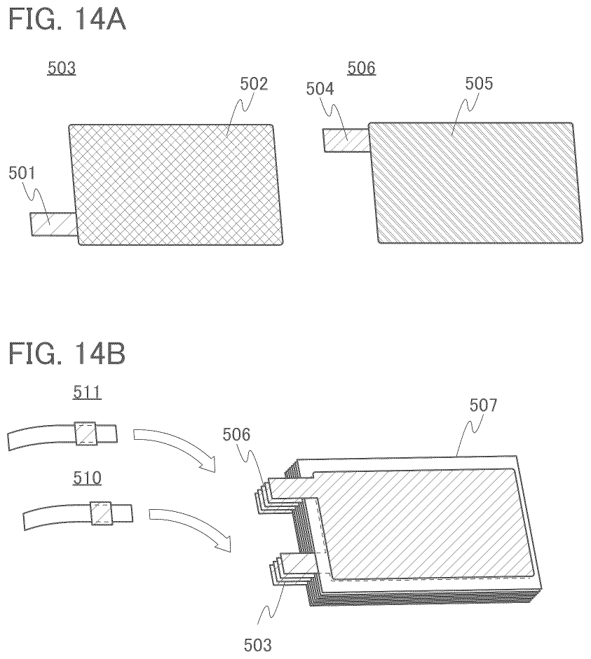

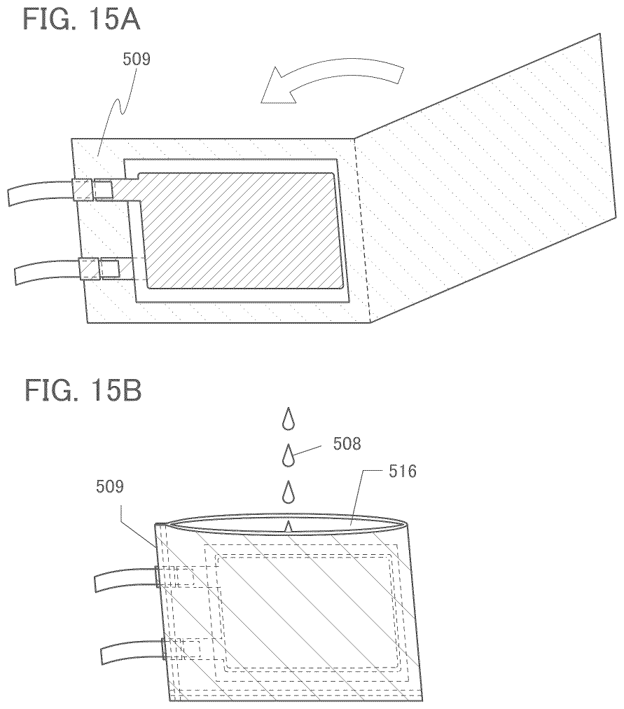

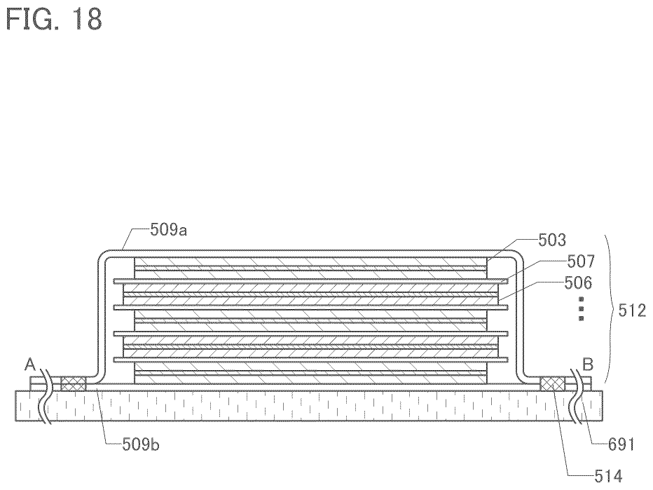

Here, an example of a method for fabricating laminated secondary batteries whose external views are illustrated in FIG. 13A and FIG. 13B will be described with reference to FIG. 14A and FIG. 14B and FIG. 15A and FIG. 15B. Secondary batteries 500 illustrated in FIG. 13A and FIG. 13B each include the positive electrode 503, the negative electrode 506, the separator 507, an exterior body 509, a positive electrode lead electrode 510, and a negative electrode lead electrode 511. Note that as a cross-sectional view of the laminated secondary battery illustrated in FIG. 13A or the like, for example, it is possible to employ a structure in which the positive electrodes, the separators, and the negative electrodes are stacked and surrounded by an exterior body as illustrated in FIG. 18 described later.

First, the positive electrode 503, the negative electrode 506, and the separator 507 are prepared. FIG. 14A illustrates examples of the positive electrode 503 and the negative electrode 506. The positive electrode 503 includes the positive electrode active material layer 502 over the positive electrode current collector 501. The positive electrode 503 preferably includes a tab region where the positive electrode current collector 501 is exposed. The negative electrode 506 includes the negative electrode active material layer 505 over the negative electrode current collector 504. The negative electrode 506 preferably includes a tab region where the negative electrode current collector 504 is exposed.

Next, the negative electrode 506, the separator 507, and the positive electrode 503 are stacked. FIG. 14B illustrates the negative electrodes 506, the separators 507, and the positive electrodes 503 that are stacked. Here, an example in which 5 negative electrodes and 4 positive electrodes are used is shown, which can also be referred to as a stack including the negative electrodes, the separators, and the positive electrodes.

Then, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

Next, the negative electrode 506, the separator 507, and the positive electrode 503 are placed over the exterior body 509.

Subsequently, the exterior body 509 is folded along a portion shown by a dashed line as illustrated in FIG. 15A. Then, the outer edges of the exterior body 509 are bonded to each other. The bonding is performed by thermocompression bonding, for example. At this time, an unbonded region (hereinafter referred to as an inlet 516) is provided for part (or one side) of the exterior body 509 so that an electrolyte 508 can be introduced later.

Next, as illustrated in FIG. 15B, the electrolyte 508 is introduced into the exterior body 509 from the inlet 516 of the exterior body 509. The electrolyte 508 is preferably introduced in a reduced-pressure atmosphere or in an inert atmosphere. Lastly, the inlet 516 is bonded. In the above manner, the laminated secondary battery 500 can be fabricated.

In the above, the positive electrode lead electrode 510 and the negative electrode lead electrode 511 on the same side are led out to the outside of the exterior body, whereby the secondary battery 500 illustrated in FIG. 13A is fabricated. The positive electrode lead electrode 510 and the negative electrode lead electrode 511 on opposite sides are led out to the outside of the exterior body, whereby the secondary battery 500 illustrated in FIG. 13B can be fabricated.

### <Fabrication Method of Laminated Secondary Battery 2>

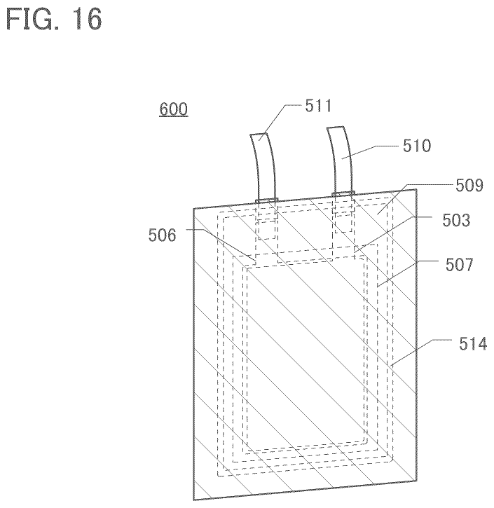

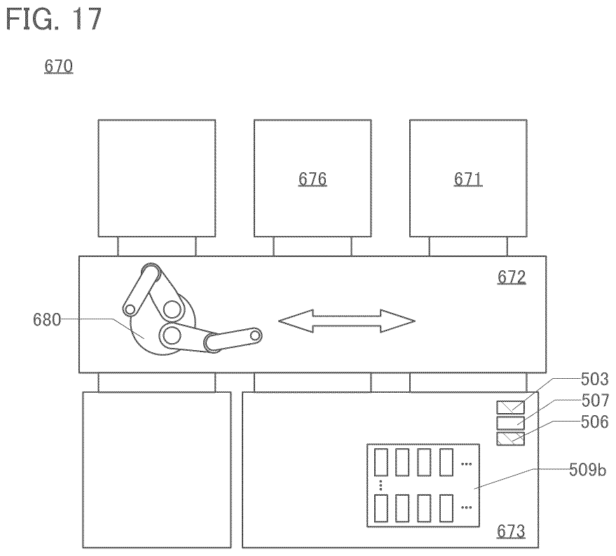

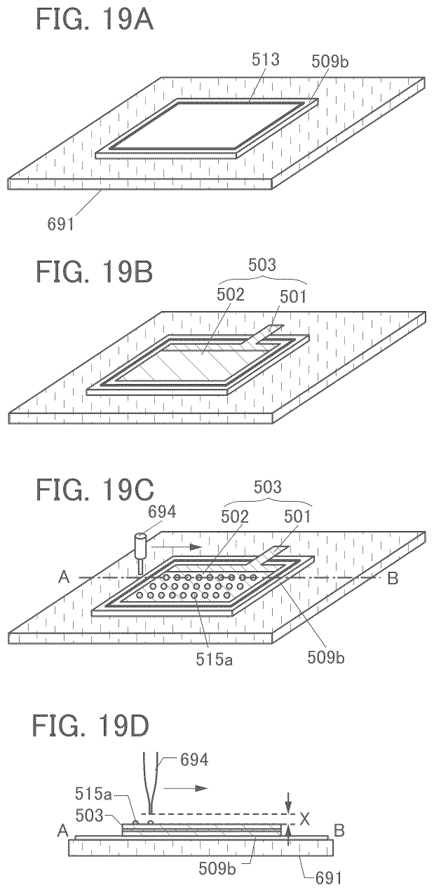

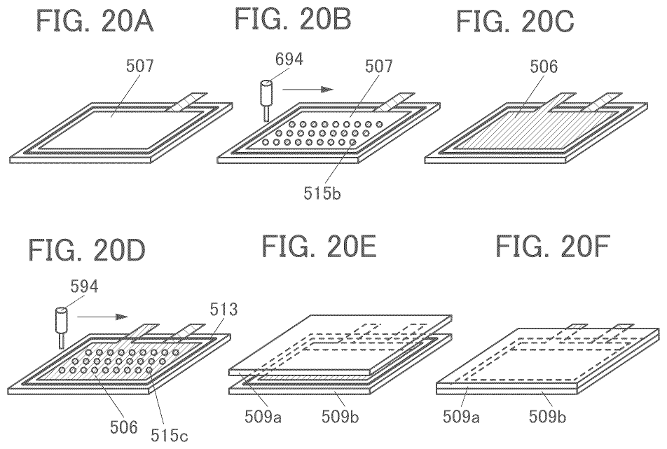

Next, an example of a method for fabricating a laminated secondary battery 600 whose external view is shown in FIG. 16 will be described with reference to FIG. 17, FIG. 18, FIG. 19A to FIG. 19D, and FIG. 20A to FIG. 20F. The secondary battery 600 illustrated in FIG. 16 includes the positive electrode 503, the negative electrode 506, the separator 507, the exterior body 509, the positive electrode lead electrode 510, and the negative electrode lead electrode 511. The exterior body 509 is sealed in a region 514.

The laminated secondary battery 600 can be fabricated using a fabricating apparatus illustrated in FIG. 17, for example. A fabricating apparatus 670 illustrated in FIG. 17 includes a component introduction chamber 671, a transfer chamber 672, a processing chamber 673, and a component extraction chamber 676. A structure can be employed in which each chamber is connected to a variety of exhaust mechanisms depending on usage. A structure can be employed in which each chamber is connected to a variety of gas supply mechanisms depending on usage. An inert gas is preferably supplied into the fabricating apparatus 670 to inhibit entry of impurities into the fabricating apparatus 670. Note that a gas that has been highly purified by a gas purifier before introduction into the fabricating apparatus 670 is preferably used as the gas supplied into the fabricating apparatus 670. The component introduction chamber 671 is a chamber for introducing the positive electrode, the separator, the negative electrode, the exterior body, and the like into the fabricating apparatus 670. The transfer chamber 672 includes a transfer mechanism 680. The treatment chamber 673 includes a stage and an electrolyte dripping mechanism. The component extraction chamber 676 is a chamber for extracting the fabricated secondary battery to the outside of the fabricating apparatus 670.

A procedure for fabricating the laminated secondary battery 600 is as follows.

First, an exterior body 509b is placed over a stage 691 in the treatment chamber 673, and then the positive electrode 503 is placed over the exterior body 509b (FIG. 19A and FIG. 19B). Next, an electrolyte 515a is dripped on the positive electrode 503 from a nozzle 694 (FIG. 19C and FIG. 19D). FIG. 19D is a cross-sectional view taken along the dashed-dotted line A-B in FIG. 19C. Note that to avoid complexity of the diagram, the stage 691 is not illustrated in some cases. As a dripping method, any one of a dispensing method, a spraying method, an inkjet method, and the like can be used, for example. In addition, an ODF (One Drop Fill) method can be used for dripping the electrolyte.

With movement of the nozzle 694, the electrolyte 515a can be dripped on the entire surface of the positive electrode 503. Alternatively, with movement of the stage 691, the electrolyte 515a may be dripped on the entire surface of the positive electrode 503.

It is preferable to drip the electrolyte from a position whose shortest distance X from a surface where the electrolyte is dripped is greater than 0 mm and less than or equal to 1 mm.

The viscosity of the electrolyte dripped from the nozzle or the like is preferably adjusted as appropriate. When the viscosity of the whole electrolyte falls within the range from 0.3 mPa·s to 1000 mPa·s at room temperature (25° C.), the electrolyte can be dripped from the nozzle.

Since the viscosity of the electrolyte changes depending on the temperature of the electrolyte, the temperature of the electrolyte to be dripped is preferably adjusted as appropriate. The temperature of the electrolyte is preferably higher than or equal to the melting point and lower than or equal to the boiling point and flash point of the electrolyte.

Then, the separator 507 is placed over the positive electrode 503 to overlap with the entire surface of the positive electrode 503 (FIG. 20A). Next, an electrolyte 515b is dripped on the separator 507 using the nozzle 694 (FIG. 20B). Then, the negative electrode 506 is placed over the separator 507 (FIG. 20C). The negative electrode 506 is placed to overlap with the separator 507 so that it does not protrude from the separator 507 in a top view. Next, an electrolyte 515c is dripped on the negative electrode 506 using the nozzle 694 (FIG. 20D). After that, the stacks including the positive electrodes 503, the separators 507, and the negative electrodes 506 are further stacked, so that a stack 512 illustrated in FIG. 18 can be fabricated. Next, the positive electrodes 503, the separators 507, and the negative electrodes 506 are sealed with an exterior body 509a and the exterior body 509b (FIG. 20E and FIG. 20F).

In FIG. 18, the positive electrode and the negative electrode are placed such that the separator is sandwiched between the positive electrode active material layer and the negative electrode active material layer. Note that in the secondary battery of one embodiment of the present invention, a region where the positive electrode active material layer and the negative electrode active material layer do not face each other is preferably small or not provided. In the case where the electrolyte contains an ionic liquid and a region where the negative electrode active material layer and the positive electrode active material layer do not face each other is provided, the charge and discharge efficiency of the secondary battery might decrease. Thus, in the secondary battery of one embodiment of the present invention, an end portion of the positive electrode active material layer and an end portion of the negative electrode active material layer are preferably aligned with each other to the utmost, for example. Therefore, the areas of the positive electrode active material layer and the negative electrode active material layer are preferably equal to each other when seen from above. Alternatively, the end portion of the positive electrode active material layer is preferably located inward from the end portion of the negative electrode active material layer.

Formation of multiple secondary batteries can be performed by placing a plurality of stacks 512 on the exterior body 509b. The stacks 512 are each sealed with the exterior bodies 509a and 509b in the region 514 so that the active material layers are surrounded, and then the stacks 512 are cut and divided outside the regions 514, whereby a plurality of secondary batteries can be individually separated.

In sealing, first, the frame-like resin layer 513 is formed over the exterior body 509b. Then, at least part of the resin layer 513 is irradiated with light under reduced pressure, so that at least part of the resin layer 513 is cured. Next, the sealing is performed in the region 514 by thermocompression bonding or welding under atmospheric pressure. Alternatively, it is possible that the sealing by light irradiation is not performed and only the sealing by thermocompression bonding or welding is performed.

Although FIG. 16 illustrates an example in which four sides of the exterior body 509 are sealed (referred to as four-side sealing in some cases), three sides may be sealed (referred to as three-side sealing in some cases) as illustrated in FIG. 13A and FIG. 13B.

Through the above process, the laminated secondary battery 600 can be fabricated.

### <Another Secondary Battery and Fabrication Method Thereof 1>

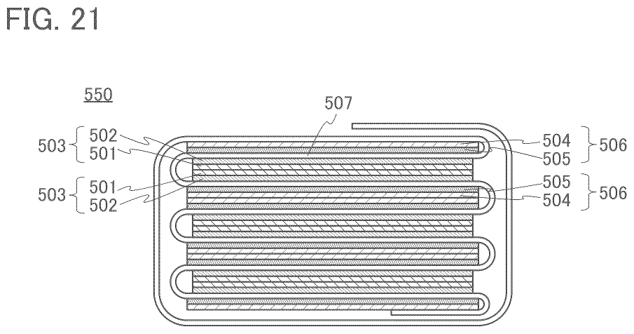

FIG. 21 illustrates an example of a cross-sectional view of a stack of one embodiment of the present invention. A stack 550 illustrated in FIG. 21 is fabricated by placing one folded separator between the positive electrode and the negative electrode.

In the stack 550, one separator 507 is folded a plurality of times to be sandwiched between the positive electrode active material layer 502 and the negative electrode active material layer 505. Since six positive electrodes 503 and six negative electrodes 506 are stacked in FIG. 21, the separator 507 is folded at least five times. The separator 507 is provided to be sandwiched between the positive electrode active material layer 502 and the negative electrode active material layer 505 and to have an extending portion folded such that the plurality of positive electrodes 503 and the plurality of negative electrodes 506 may be bound together with a tape or the like.

After the positive electrode 503 is placed, an electrolyte can be dripped on the positive electrode 503 in the method for fabricating the secondary battery of one embodiment of the present invention. Similarly, after the negative electrode 506 is placed, an electrolyte can be dripped on the negative electrode 506. In the method for fabricating the secondary battery of one embodiment of the present invention, an electrolyte can be dripped on the separator 507 before the separator is folded or after the folded separator 507 overlaps with the negative electrode 506 or the positive electrode 503. When an electrolyte is dripped on at least one of the negative electrode 506, the separator 507, and the positive electrode 503, the negative electrode 506, the separator 507, or the positive electrode 503 can be impregnated with the electrolyte.

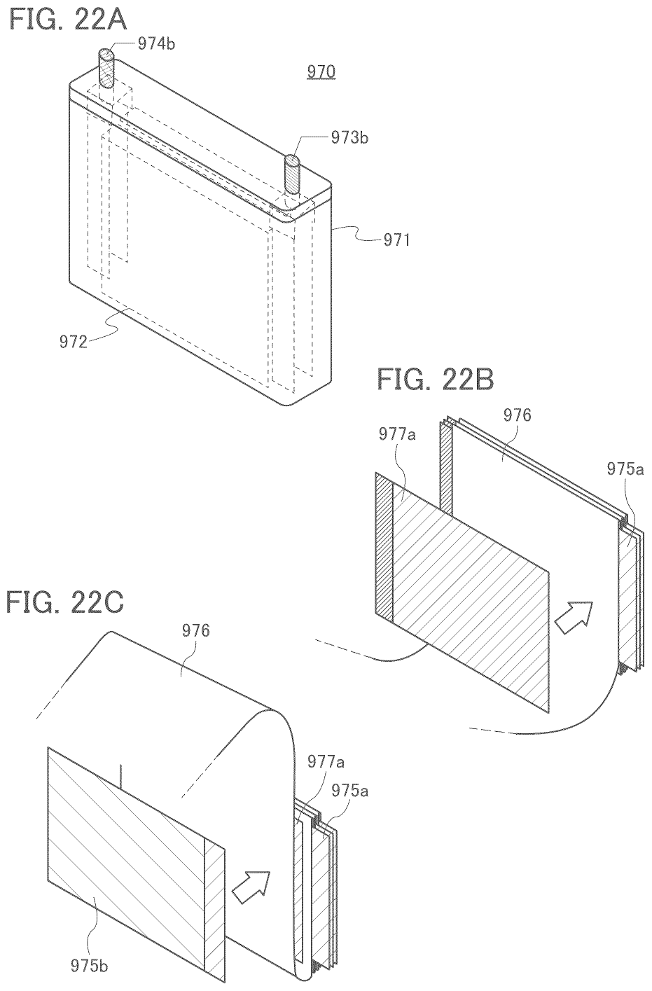

A secondary battery 970 illustrated in FIG. 22A includes a stack 972 inside a housing 971. A terminal 973b and a terminal 974b are electrically connected to the stack 972. At least part of the terminal 973b and at least part of the terminal 974b are exposed to the outside of the housing 971.

The stack 972 can have a stacked-layer structure of a positive electrode, a negative electrode, and a separator. Alternatively, the stack 972 can have a structure in which a positive electrode, a negative electrode, and a separator are wound, for example.

As the stack 972, the stack having the structure illustrated in FIG. 21 in which the separator is folded can be used, for example.

An example of a method for fabricating the stack 972 will be described with reference to FIG. 22B and FIG. 22C.

First, as illustrated in FIG. 22B, a belt-like separator 976 overlaps with a positive electrode 975a, and a negative electrode 977a overlaps with the positive electrode 975a with the separator 976 therebetween. After that, the separator 976 is folded to overlap with the negative electrode 977a. Next, as illustrated in FIG. 22C, a positive electrode 975b overlaps with the negative electrode 977a with the separator 976 therebetween. In this manner, the positive electrodes and the negative electrodes are sequentially placed with the folded separator therebetween, whereby the stack 972 can be fabricated. A structure including the stack fabricated in the above manner is sometimes referred to as a “zigzag structure”.

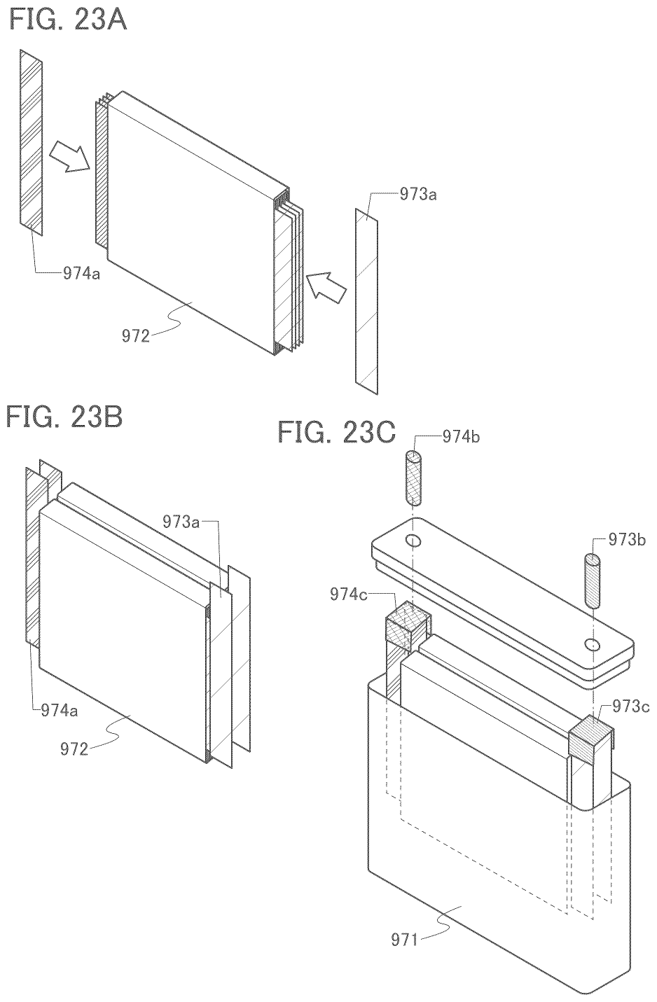

Next, an example of a method for fabricating the secondary battery 970 will be described with reference to FIG. 23A to FIG. 23C.

First, as illustrated in FIG. 23A, a positive electrode lead electrode 973a is electrically connected to the positive electrodes included in the stack 972. Specifically, for example, the positive electrodes included in the stack 972 are provided with tab regions, and the tab regions and the positive electrode lead electrode 973a can be electrically connected to each other by welding or the like. In addition, a negative electrode lead electrode 974a is electrically connected to the negative electrodes included in the stack 972.

One stack 972 may be placed inside the housing 971 or a plurality of stacks 972 may be placed inside the housing 971. FIG. 23B illustrates an example of preparing two stacks 972.

Next, as illustrated in FIG. 23C, the prepared stacks 972 are put in the housing 971, the terminal 973b and the terminal 974b are attached, and the housing 971 is sealed. It is preferable to electrically connect a conductor 973c to each of the positive electrode lead electrodes 973a included in the plurality of stacks 972. In addition, it is preferable to electrically connect a conductor 974c to each of the negative electrode lead electrodes 974a included in the plurality of stacks 972. The terminal 973b and the terminal 974b are electrically connected to the conductor 973c and the conductor 974c, respectively. Note that the conductor 973c may include a conductive region and an insulating region. In addition, the conductor 974c may include a conductive region and an insulating region.

For the housing 971, a metal material (e.g., aluminum) can be used. In the case where a metal material is used for the housing 971, the surface is preferably coated with a resin or the like. Alternatively, a resin material can be used for the housing 971.

The housing 971 is preferably provided with a safety valve, an overcurrent protection element, or the like. A safety valve is a valve for releasing a gas, in order to prevent the battery from exploding, when the pressure inside the housing 971 reaches a predetermined pressure.

### <Another Secondary Battery and Fabrication Method Thereof 2>

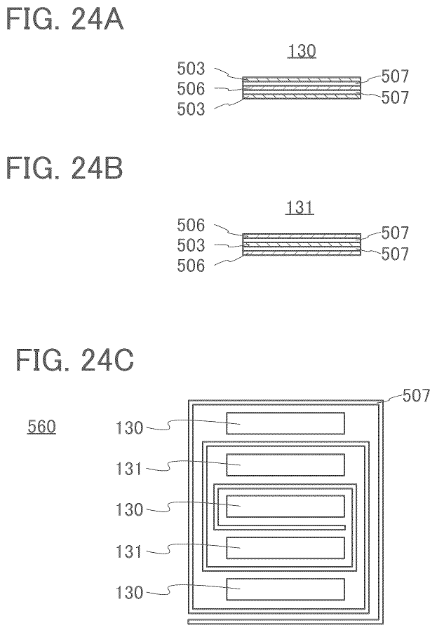

FIG. 24C illustrates an example of a cross-sectional view of a secondary battery of another embodiment of the present invention. A secondary battery 560 illustrated in FIG. 24C is fabricated using stacks 130 illustrated in FIG. 24A and stacks 131 illustrated in FIG. 24B. In FIG. 24C, the stacks 130, the stacks 131, and the separator 507 are selectively illustrated for the sake of clarity of the drawing.

As illustrated in FIG. 24A, in the stack 130, the positive electrode 503 including the positive electrode active material layers on both surfaces of the positive electrode current collector, the separator 507, the negative electrode 506 including the negative electrode active material layers on both surfaces of the negative electrode current collector, the separator 507, and the positive electrode 503 including the positive electrode active material layers on both surfaces of the positive electrode current collector are stacked in this order.

As illustrated in FIG. 24B, in the stack 131, the negative electrode 506 including the negative electrode active material layers on both surfaces of the negative electrode current collector, the separator 507, the positive electrode 503 including the positive electrode active material layers on both surfaces of the positive electrode current collector, the separator 507, and the negative electrode 506 including the negative electrode active material layers on both surfaces of the negative electrode current collector are stacked in this order.

The method for fabricating the secondary battery of one embodiment of the present invention can be utilized for fabricating the stacks. Specifically, in order to fabricate the stacks, an electrolyte is dripped on at least one of the negative electrode 506, the separator 507, and the positive electrode 503 at the time of stacking the negative electrode 506, the separator 507, and the positive electrode 503. Dripping a plurality of drops of the electrolyte enables the negative electrode 506, the separator 507, or the positive electrode 503 to be impregnated with the electrolyte.

As illustrated in FIG. 24C, the plurality of stacks 130 and the plurality of stacks 131 are covered with the wound separator 507.

After the stacks 130 are placed, an electrolyte can be dripped on the stacks 130 in the method for fabricating the secondary battery of one embodiment of the present invention. Similarly, after the stacks 131 are placed, an electrolyte can be dripped on the stacks 131. Moreover, an electrolyte can be dripped on the separator 507 before the separator 507 is folded or after the folded separator 507 overlaps with the stacks. Dripping a plurality of drops of the electrolyte enables the stacks 130, the stacks 131, or the separator 507 to be impregnated with the electrolyte.

### <Another Secondary Battery and Fabrication Method Thereof 3>

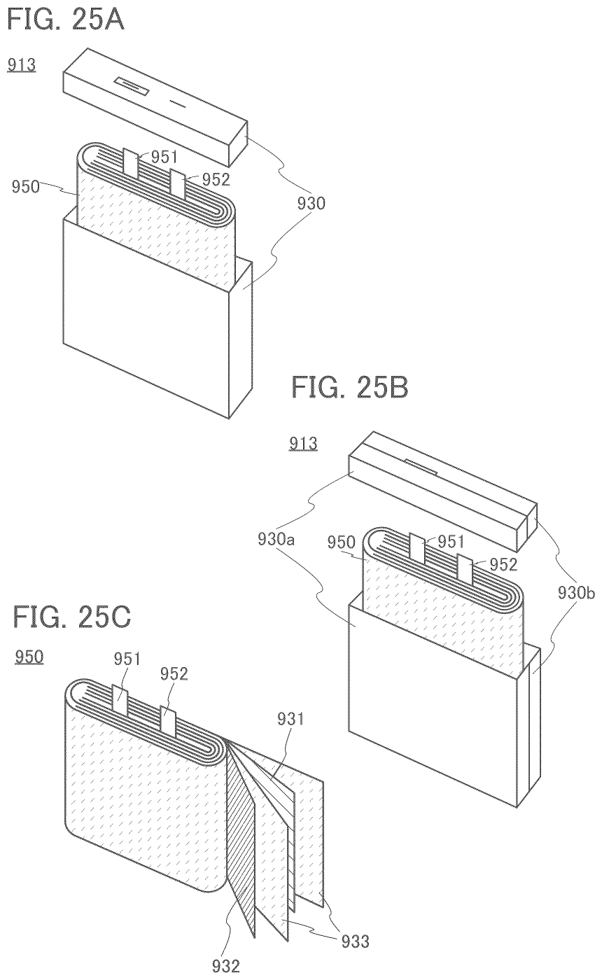

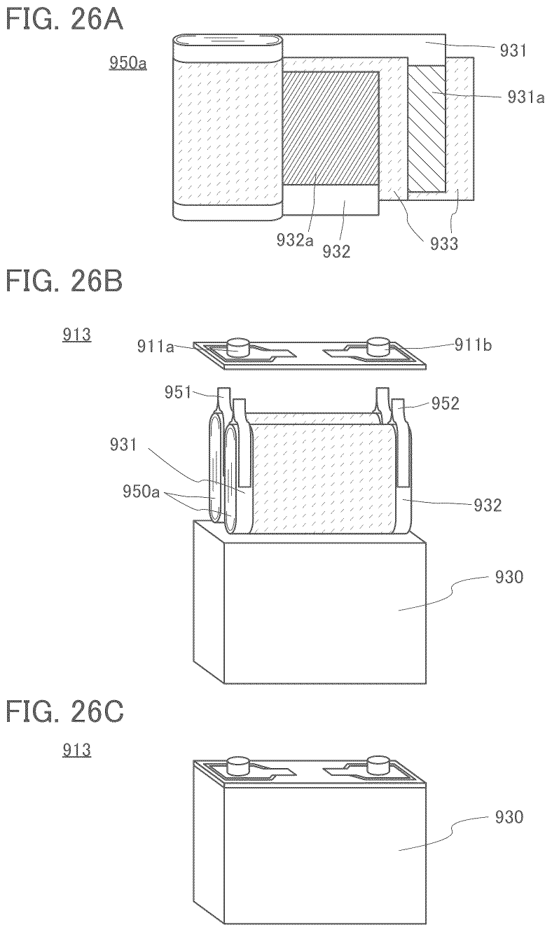

A secondary battery of another embodiment of the present invention will be described with reference to FIG. 25 and FIG. 26. The secondary battery described here can be referred to as a wound secondary battery or the like.

A secondary battery 913 illustrated in FIG. 25A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 25A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 25B, the housing 930 illustrated in FIG. 25A may be formed using a plurality of materials. For example, in the secondary battery 913 illustrated in FIG. 25B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

Furthermore, FIG. 25C illustrates the structure of the wound body 950. The wound body 950 includes a negative electrode 931, a positive electrode 932, and separators 933. The wound body 950 is a wound body obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be overlaid.

At the time of stacking the negative electrode 931, the separator 933, and the positive electrode 932 in the method for fabricating the secondary battery of one embodiment of the present invention, an electrolyte is dripped on at least one of the negative electrode 931, the separator 933, and the positive electrode 932. That is, an electrolyte is preferably dripped before the sheet of the stack is wound. Dripping a plurality of drops of the electrolyte enables the negative electrode 931, the separator 933, or the positive electrode 932 to be impregnated with the electrolyte.

As illustrated in FIG. 26A, the secondary battery 913 may include a wound body 950a. The wound body 950a illustrated in FIG. 26A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 26B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 26C, the wound body 950a and an electrolyte are covered with the housing 930, whereby the secondary battery 913 is obtained. The housing 930 is preferably provided with a safety valve, an overcurrent protection element, and the like. In order to prevent the battery from exploding, a safety valve is temporarily released when the internal pressure of the housing 930 exceeds a predetermined internal pressure.

As illustrated in FIG. 26B, the secondary battery 913 may include a plurality of wound bodies 950a. The use of the plurality of wound bodies 950a enables the secondary battery 913 to have higher charge and discharge capacity.

This embodiment can be combined with any of the other embodiments as appropriate.

### Embodiment 5

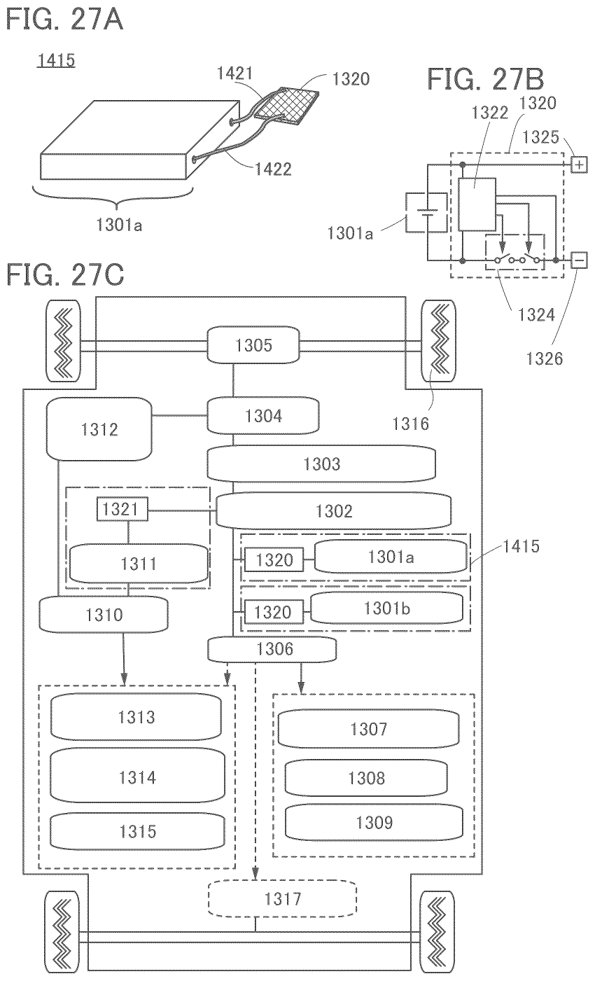

In this embodiment, application examples of the secondary battery of one embodiment of the present invention will be described with reference to FIG. 27 to FIG. 36.

### [Vehicle]

First, an example in which the secondary battery of one embodiment of the present invention is used in an electric vehicle (EV) will be described.

FIG. 27C shows a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 only needs high output and high capacity is not so much needed; the capacity of the second battery 1311 is lower than that of the first batteries 1301a and 1301b.

For example, as one or both of the first batteries 1301a and 1301b, the secondary battery fabricated by the method for fabricating the secondary battery of one embodiment of the present invention can be used.

Although this embodiment shows an example in which the two first batteries 1301a and 1301b are connected in parallel, three or more batteries may be connected in parallel. In the case where the first battery 1301a can store sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (for a low-voltage system) (such as an audio 1313, power windows 1314, and lamps 1315) through a DCDC circuit 1310.

The first battery 1301a will be described with reference to FIG. 27A.

FIG. 27A illustrates an example of a large battery pack 1415. One electrode of the battery pack 1415 is electrically connected to a control circuit portion 1320 through a wiring 1421. The other electrode is electrically connected to the control circuit portion 1320 through a wiring 1422. Note that the battery pack may have a structure in which a plurality of secondary batteries are connected in series.

The control circuit portion 1320 may include a memory circuit including a transistor using an oxide semiconductor. A charging control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, an output transistor of a charging circuit and an interruption switch can be turned off substantially at the same time.

FIG. 27B illustrates an example of a block diagram of the battery pack 1415 illustrated in FIG. 27A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery is a recommended voltage range, and when a voltage falls outside the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to a switch including a Si transistor using single crystal silicon; the switch portion 1324 may be formed using a power transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOz (gallium oxide, where z is a real number greater than 0), or the like. A memory element using an OS transistor can be freely placed by being stacked over a circuit using a Si transistor, for example; hence, integration can be easy. Furthermore, an OS transistor can be fabricated with a fabricating apparatus similar to that for a Si transistor and thus can be fabricated at low cost. That is, the control circuit portion 1320 using OS transistors can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42V (for a high-voltage system), and the second battery 1311 supplies electric power to in-vehicle parts for 14 V (for a low-voltage system). A lead storage battery is often used for the second battery 1311 due to cost advantage.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301 a and 1301b are desirably capable of fast charging.

The battery controller 1302 can set the charge voltage, charge current, and the like of the first batteries 1301a and 1301b. The battery controller 1302 can set charging conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

By mounting the secondary battery of one embodiment of the present invention on vehicles, next-generation clean energy vehicles such as hybrid vehicles (HVs), electric vehicles (EVs), and plug-in hybrid vehicles (PHVs) can be achieved. The secondary battery can also be mounted on transport vehicles such as agricultural machines such as electric tractors, motorized bicycles including motor-assisted bicycles, motorcycles, electric wheelchairs, electric carts, boats or ships, submarines, aircraft such as fixed-wing aircraft and rotary-wing aircraft, rockets, artificial satellites, space probes, planetary probes, and spacecraft. With the use of the method for fabricating the secondary battery of one embodiment of the present invention, a large secondary battery can be provided. Thus, the secondary battery of one embodiment of the present invention can be suitably used in transport vehicles.

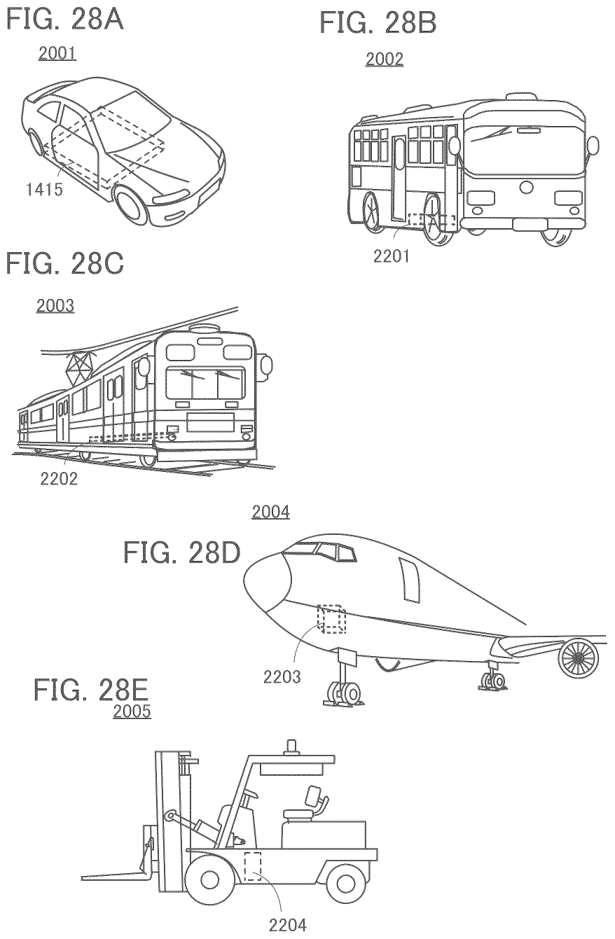

FIG. 28A to FIG. 28E illustrate transport vehicles each using the secondary battery of one embodiment of the present invention. A motor vehicle 2001 illustrated in FIG. 28A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, the secondary battery is provided at one position or several positions. The motor vehicle 2001 illustrated in FIG. 28A includes the battery pack 1415 illustrated in FIG. 27A. The battery pack 1415 includes a secondary battery module. The battery pack 1415 preferably further includes a charging control device that is electrically connected to the secondary battery module. The secondary battery module includes one or more secondary batteries.

The motor vehicle 2001 can be charged when the secondary battery included in the motor vehicle 2001 is supplied with electric power through external charging equipment by a plug-in system, a contactless power feeding system, or the like. In charging, a given method such as CHAdeMO (registered trademark) or Combined Charging System can be employed as a charging method, the standard of a connector, or the like as appropriate. A charging device may be a charging station provided in a commerce facility or a power source in a house. For example, with the use of the plug-in technique, a secondary battery mounted on the motor vehicle 2001 can be charged by being supplied with electric power from the outside. The charge can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 28B illustrates a large transporter 2002 having a motor controlled by electricity as an example of a transport vehicle. A secondary battery module of the transporter 2002 includes a cell unit of four secondary batteries with 3.5 V or higher and 4.7 V or lower, for example, and 48 cells are connected in series to have a maximum voltage of 170 V. A battery pack 2201 has the same function as the battery pack in FIG. 28A except the number of secondary batteries included in the secondary battery module; thus, the description is omitted.

FIG. 28C illustrates a large transport vehicle 2003 having a motor controlled by electricity as an example. The secondary battery module of the transport vehicle 2003 has 100 or more secondary batteries with 3.5 V or higher and 4.7 V or lower connected in series, and the maximum voltage is 600 V, for example. Thus, the secondary batteries are required to have a small variation in the characteristics. With the use of the method for fabricating the secondary battery of one embodiment of the present invention, a secondary battery with stable battery performance can be fabricated, and mass production at low cost is possible in view of the yield. A battery pack 2202 has the same function as the battery pack in FIG. 28A except the number of secondary batteries included in the secondary battery module; thus, the description is omitted.

FIG. 28D illustrates an aircraft 2004 having a combustion engine as an example. The aircraft 2004 illustrated in FIG. 28D is regarded as a kind of transport vehicles because it has wheels for takeoff and landing, and includes a battery pack 2203 that includes a charging control device and a secondary battery module obtained by connecting a plurality of secondary batteries.

The secondary battery module of the aircraft 2004 has eight 4 V secondary batteries connected in series and has a maximum voltage of 32 V, for example. The battery pack 2203 has the same function as the battery pack in FIG. 28A except the number of secondary batteries included in the secondary battery module; thus, the description is omitted.

FIG. 28E illustrates a transport vehicle 2005 that transports a load as an example. The transport vehicle 2005 includes a motor controlled by electricity and executes various operations with use of electric power supplied from secondary batteries of a secondary battery module of a battery pack 2204. The transport vehicle 2005 is not limited to be operated by a human who rides thereon as a driver, and an unmanned operation is also possible by CAN communication or the like. Although FIG. 28E illustrates a fork lift, there is no particular limitation and a battery pack including the secondary battery of one embodiment of the present invention can be mounted on industrial machines capable of being operated by CAN communication or the like, e.g., automatic transporters, working robots, and small construction equipment.

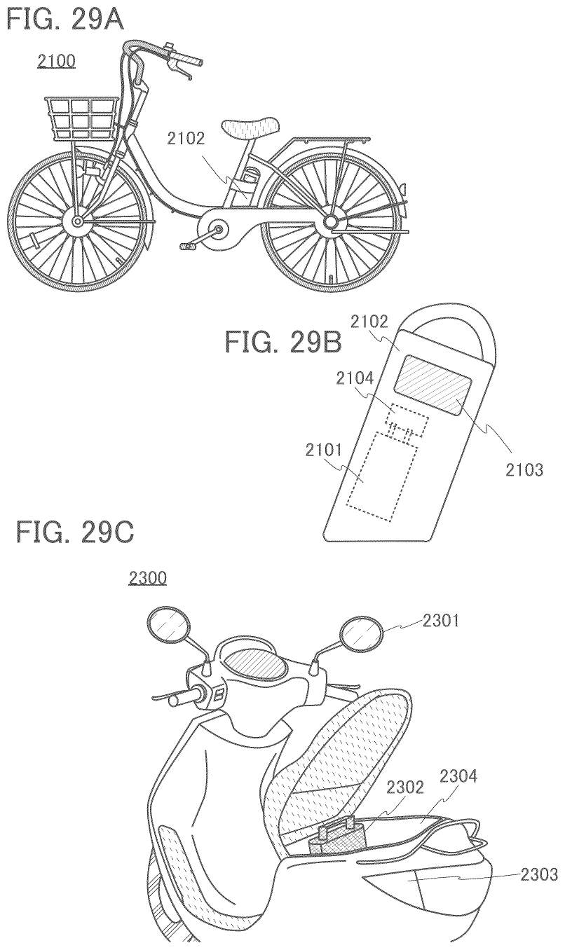

FIG. 29A shows an example of an electric bicycle using the secondary battery of one embodiment of the present invention. The secondary battery of one embodiment of the present invention can be used for an electric bicycle 2100 illustrated in FIG. 29A. A power storage device 2102 illustrated in FIG. 29B includes a plurality of secondary batteries and a protection circuit, for example.

The electric bicycle 2100 includes the power storage device 2102. The power storage device 2102 can supply electricity to a motor that assists a rider. The power storage device 2102 is portable, and FIG. 29B illustrates the state where the power storage device 2102 is detached from the bicycle. A plurality of secondary batteries 2101 of embodiments of the present invention are incorporated in the power storage device 2102, and the remaining battery capacity and the like can be displayed on a display portion 2103. The power storage device 2102 includes a control circuit 2104 capable of charging control or anomaly detection for the secondary battery, which is exemplified in one embodiment of the present invention. The control circuit 2104 is electrically connected to a positive electrode and a negative electrode of the secondary battery 2101. The control circuit 2104 may be provided with a small solid-state secondary battery. When the small solid-state secondary battery is provided in the control circuit 2104, electric power can be supplied to retain data in a memory circuit included in the control circuit 2104 for a long time. When the control circuit 2104 is used in combination with the secondary battery including the positive electrode active material 100 of one embodiment of the present invention in the positive electrode, the synergy on safety can be obtained. The secondary battery including the positive electrode active material 100 of one embodiment of the present invention in the positive electrode and the control circuit 2104 can greatly contribute to elimination of accidents due to secondary batteries, such as fires.

FIG. 29C illustrates an example of a two-wheeled vehicle including the secondary battery of one embodiment of the present invention. A motor scooter 2300 illustrated in FIG. 29C includes a power storage device 2302, side mirrors 2301, and indicator lights 2303. The power storage device 2302 can supply electricity to the indicator lights 2303. The power storage device 2302 including a plurality of secondary batteries including a positive electrode using the positive electrode active material 100 of one embodiment of the present invention can have high capacity and contribute to a reduction in size. To improve safety, a protection circuit that prevents overcharging and/or overdischarging of the secondary battery may be electrically connected to the secondary battery.

In the motor scooter 2300 illustrated in FIG. 29C, the power storage device 2302 can be stored in an under-seat storage unit 2304. The power storage device 2302 can be stored in the under-seat storage unit 2304 even with a small size.

### [Building]

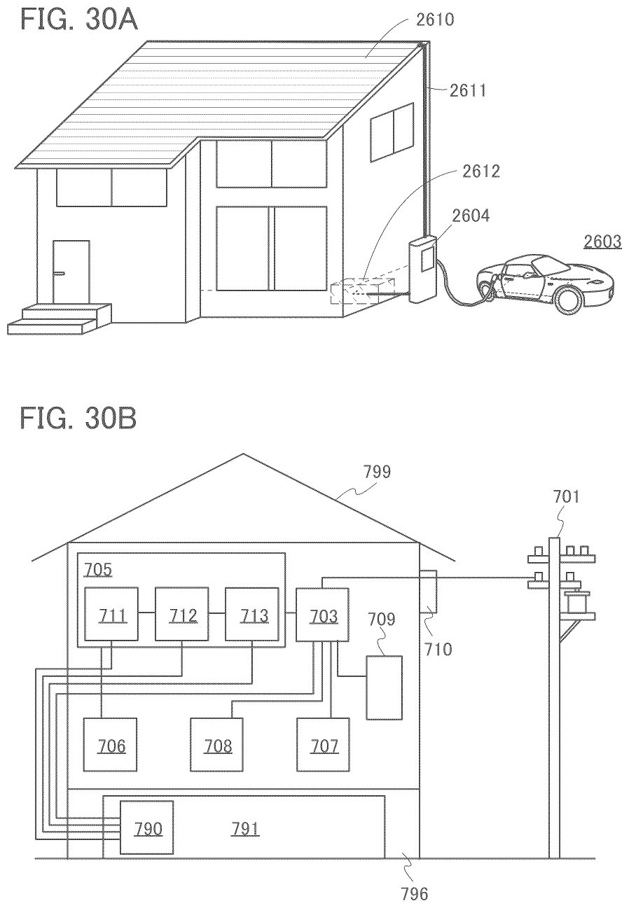

Next, examples in which the secondary battery of one embodiment of the present invention is mounted on a building will be described with reference to FIG. 30.

A house illustrated in FIG. 30A includes a power storage device 2612 including the secondary battery that has stable battery performance by employing the method for fabricating the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. The secondary battery included in a vehicle 2603 can be charged with the electric power stored in the power storage device 2612 through the charging device 2604. The power storage device 2612 is preferably provided in an underfloor space. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure or the like.

FIG. 30B illustrates an application example of a power storage device of one embodiment of the present invention. As illustrated in FIG. 30B, a large power storage device 791 obtained by the method for fabricating the secondary battery of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 per day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, the demand for electric power depending on a time period (or per hour) that is predicted by the predicting portion 712 can be checked.

[Electronic Device]

The secondary battery of one embodiment of the present invention can be used for one or both of an electronic device and a lighting device, for example. Examples of the electronic device include portable information terminals such as mobile phones, smartphones, and laptop computers; portable game machines; portable music players; digital cameras; and digital video cameras.

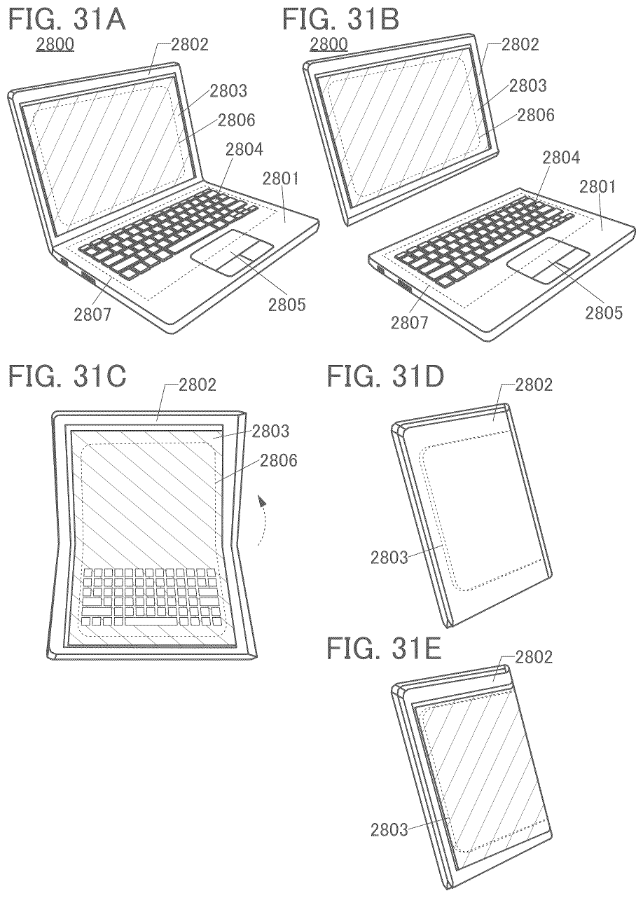

A personal computer 2800 illustrated in FIG. 31A includes a housing 2801, a housing 2802, a display portion 2803, a keyboard 2804, a pointing device 2805, and the like. A secondary battery 2807 is provided inside the housing 2801, and a secondary battery 2806 is provided inside the housing 2802. To improve safety, a protection circuit that prevents overcharging and/or overdischarging of the secondary battery 2807 may be electrically connected to the secondary battery 2807. A touch panel is used for the display portion 2803. As illustrated in FIG. 31B, the housing 2801 and the housing 2802 of the personal computer 2800 can be detached and the housing 2802 can be used alone as a tablet terminal.

The large secondary battery obtained by the method for fabricating the secondary battery of one embodiment of the present invention can be used as one or both of the secondary battery 2806 and the secondary battery 2807. The shape of the secondary battery obtained by the method for fabricating the secondary battery of one embodiment of the present invention can be changed freely by changing the shape of the exterior body. When the shapes of the secondary batteries 2806 and 2807 fit with the shapes of the housings 2801 and 2802, for example, the secondary batteries can have high capacity and thus the operating time of the personal computer 2800 can be lengthened. Moreover, the weight of the personal computer 2800 can be reduced. A flexible display is used for the display portion 2803 of the housing 2802. As the secondary battery 2806, the large secondary battery obtained by the method for fabricating the secondary battery of one embodiment of the present invention is used. With the use of a flexible film as the exterior body in the large secondary battery obtained by the method for fabricating the secondary battery of one embodiment of the present invention, a bendable secondary battery can be obtained. Thus, as illustrated in FIG. 31C, the housing 2802 can be used while being bent. In that case, part of the display portion 2803 can be used as a keyboard as illustrated in FIG. 31C.

Furthermore, the housing 2802 can be folded such that the display portion 2803 is placed inward as illustrated in FIG. 31D, or the housing 2802 can be folded such that the display portion 2803 faces outward as illustrated in FIG. 31E.

A bendable secondary battery to which the secondary battery of one embodiment of the present invention is applied can be mounted on an electronic device. In addition, it can be incorporated along an inside wall or an outer wall surface of a house or a building or a curved interior/exterior surface of a motor vehicle.

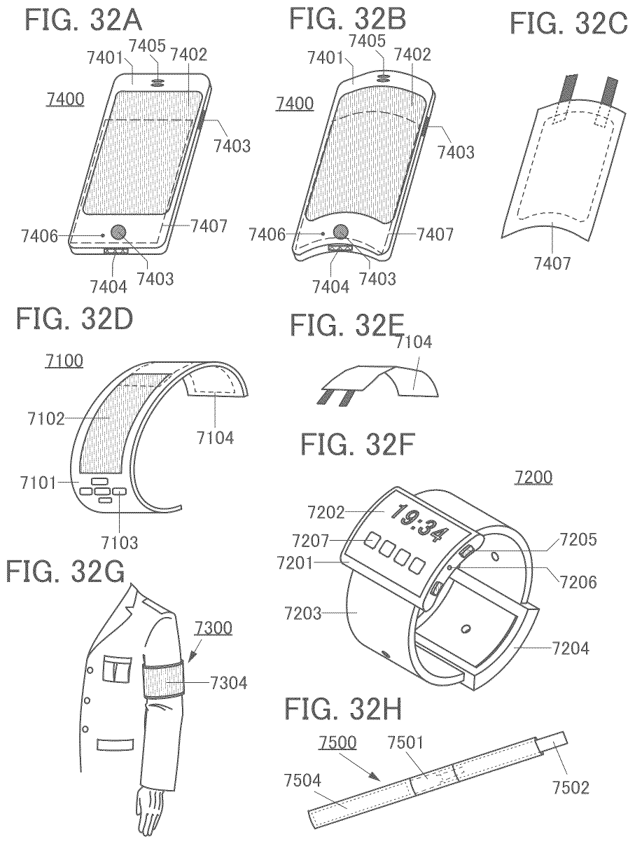

FIG. 32A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided. To improve safety, a protection circuit that prevents overcharging and/or overdischarging of the secondary battery 7407 may be electrically connected to the secondary battery 7407.

FIG. 32B illustrates the mobile phone 7400 that is curved. When the whole mobile phone 7400 is curved by external force, the secondary battery 7407 provided therein is also curved. FIG. 32C illustrates the secondary battery 7407 that is being bent at that time. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 32D illustrates an example of a bangle display device. A portable display device 7100 includes a housing 7101, a display portion 7102, operation buttons 7103, and a secondary battery 7104. To improve safety, a protection circuit that prevents overcharging and/or overdischarging of the secondary battery 7104 may be electrically connected to the secondary battery 7104. FIG. 32E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm to 150 mm inclusive. When the radius of curvature at the main surface of the secondary battery 7104 is in the range from 40 mm to 150 mm inclusive, the reliability can be kept high. When the secondary battery of one embodiment of the present invention is used as the secondary battery 7104, a lightweight portable display device with a long lifetime can be provided.

FIG. 32F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. To improve safety, a protection circuit that prevents overcharging and/or overdischarging of the secondary battery may be electrically connected to the secondary battery. For example, the secondary battery 7104 illustrated in FIG. 32E that is in the state of being curved can be installed in the housing 7201. Alternatively, the secondary battery 7104 illustrated in FIG. 32E can be installed in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 32G illustrates an example of an armband display device. A display device 7300 includes a display portion 7304 and the secondary battery of one embodiment of the present invention. To improve safety, a protection circuit that prevents overcharging and/or overdischarging of the secondary battery may be electrically connected to the secondary battery. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charge operation may also be performed by wireless power feeding without using the input/output terminal.

When the secondary battery of one embodiment of the present invention is used as the secondary battery included in the display device 7300, a lightweight display device with a long lifetime can be provided.

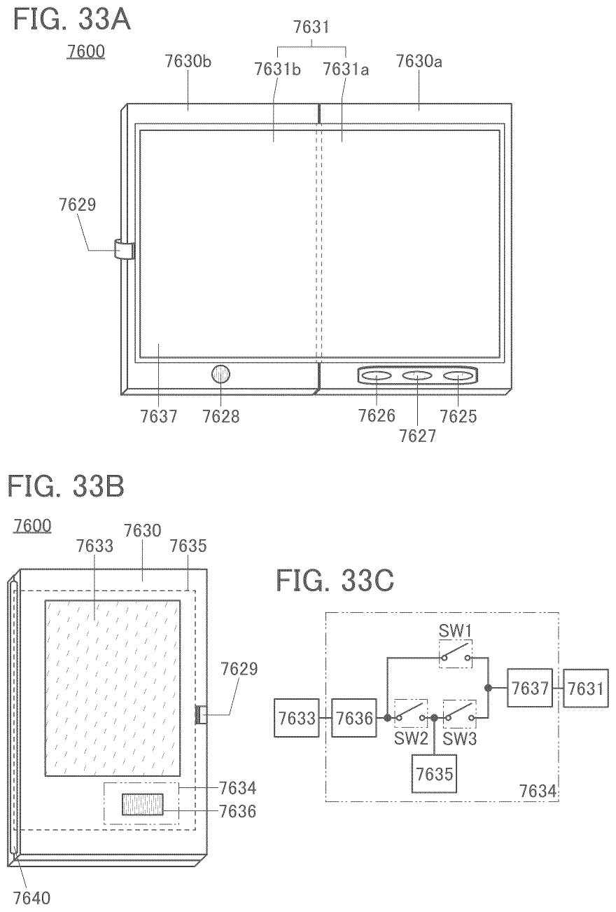

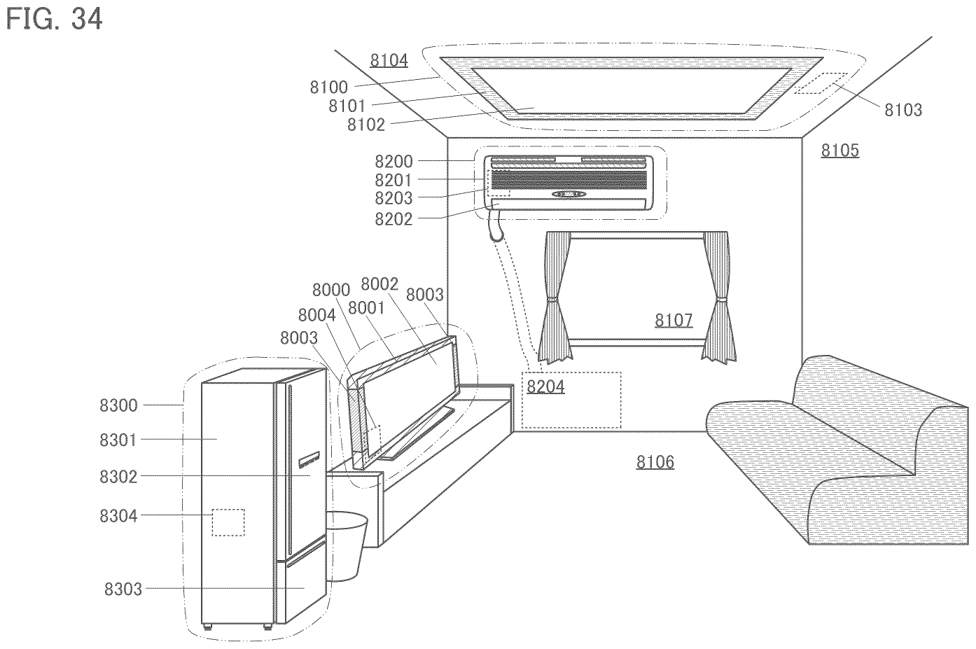

Examples of electronic devices each including the secondary battery of one embodiment of the present invention with excellent cycle performance are described with reference to FIG. 32H, FIG. 33, and FIG. 34.

When the secondary battery of one embodiment of the present invention is used as a secondary battery of an electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 32H is a perspective view of a device called a cigarette smoking device (electronic cigarette). In FIG. 32H, an electronic cigarette 7500 includes an atomizer 7501 including a heating element, a secondary battery 7504 that supplies electric power to the atomizer, and a cartridge 7502 including a liquid supply bottle, a sensor, or the like. To improve safety, a protection circuit that prevents overcharging and/or overdischarging of the secondary battery 7504 may be electrically connected to the secondary battery 7504. The secondary battery 7504 illustrated in FIG. 32H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIG. 33A and FIG. 33B illustrate an example of a tablet terminal that can be folded in half. A tablet terminal 7600 illustrated in FIG. 33A and FIG. 33B includes a housing 7630a, a housing 7630b, a movable portion 7640 connecting the housing 7630a and the housing 7630b to each other, a display portion 7631 including a display portion 7631a and a display portion 7631b, a switch 7625 to a switch 7627, a fastener 7629, and an operation switch 7628. A flexible panel is used for the display portion 7631, whereby a tablet terminal with a larger display portion can be provided. FIG. 33A illustrates the tablet terminal 7600 that is opened, and FIG. 33B illustrates the tablet terminal 7600 that is closed.

The tablet terminal 7600 includes a power storage unit 7635 inside the housing 7630a and the housing 7630b. The power storage unit 7635 is provided across the housing 7630a and the housing 7630b, passing through the movable portion 7640.

The entire region or part of the region of the display portion 7631 can be a touch panel region, and data can be input by touching text, an input form, an image including an icon, and the like displayed on the region. For example, it is possible that keyboard buttons are displayed on the entire display portion 7631a on the housing 7630a side, and information such as text or an image is displayed on the display portion 7631b on the housing 7630b side.

It is possible that a keyboard is displayed on the display portion 7631b on the housing 7630b side, and information such as text or an image is displayed on the display portion 7631a on the housing 7630a side. Furthermore, it is possible that a switching button for showing/hiding a keyboard on a touch panel is displayed on the display portion 7631 and the button is touched with a finger, a stylus, or the like to display a keyboard on the display portion 7631.

Touch input can be performed concurrently in a touch panel region in the display portion 7631a on the housing 7630a side and a touch panel region in the display portion 7631b on the housing 7630b side.

The switch 7625 to the switch 7627 may function not only as an interface for operating the tablet terminal 7600 but also as an interface that can switch various functions. For example, at least one of the switch 7625 to the switch 7627 may function as a switch for switching power on/off of the tablet terminal 7600. For another example, at least one of the switch 7625 to the switch 7627 may have a function of switching the display orientation between a portrait mode and a landscape mode or a function of switching display between monochrome display and color display. For another example, at least one of the switch 7625 to the switch 7627 may have a function of adjusting the luminance of the display portion 7631. The luminance of the display portion 7631 can be optimized in accordance with the amount of external light in use of the tablet terminal 7600 detected by an optical sensor incorporated in the tablet terminal 7600. Note that another sensing device including a sensor for sensing inclination, such as a gyroscope sensor or an acceleration sensor, may be incorporated in the tablet terminal, in addition to the optical sensor.

FIG. 33A illustrates an example in which the display portion 7631a on the housing 7630a side and the display portion 7631b on the housing 7630b side have substantially the same display area; however, there is no particular limitation on the display areas of the display portion 7631a and the display portion 7631b, and the display portions may have different sizes or different display quality. For example, one may be a display panel that can display higher-definition images than the other.

The tablet terminal 7600 is folded in half in FIG. 33B. The tablet terminal 7600 includes a housing 7630, a solar cell 7633, and a charge and discharge control circuit 7634 including a DCDC converter 7636. The secondary battery of one embodiment of the present invention is used as the power storage unit 7635.

Note that as described above, the tablet terminal 7600 can be folded in half, and thus can be folded when not in use such that the housing 7630a and the housing 7630b overlap with each other. By the folding, the display portion 7631 can be protected, which increases the durability of the tablet terminal 7600. With the power storage unit 7635 including the secondary battery of one embodiment of the present invention, which has high capacity and excellent cycle performance, the tablet terminal 7600 that can be used for a long time over a long period can be provided. To improve safety, a protection circuit that prevents overcharging and/or overdischarging of the secondary battery included in the power storage unit 7635 may be electrically connected to the secondary battery.

In addition, the tablet terminal 7600 illustrated in FIG. 33A and FIG. 33B can also have a function of displaying various kinds of information (e.g., a still image, a moving image, and a text image), a function of displaying a calendar, a date, or the time on the display portion, a touch-input function of operating or editing information displayed on the display portion by touch input, a function of controlling processing by various kinds of software (programs), and the like.

The solar cell 7633, which is attached on the surface of the tablet terminal 7600, can supply electric power to a touch panel, a display portion, a video signal processing portion, and the like. Note that the solar cell 7633 can be provided on one surface or both surfaces of the housing 7630 and the power storage unit 7635 can be charged efficiently. The use of a lithium-ion battery as the power storage unit 7635 brings an advantage such as a reduction in size.

The structure and operation of the charge and discharge control circuit 7634 illustrated in FIG. 33B are described with reference to a block diagram in FIG. 33C. The solar cell 7633, the power storage unit 7635, the DCDC converter 7636, a converter 7637, a switch SW1 to a switch SW3, and the display portion 7631 are illustrated in FIG. 33C, and the power storage unit 7635, the DCDC converter 7636, the converter 7637, and the switch SW1 to the switch SW3 correspond to the charge and discharge control circuit 7634 illustrated in FIG. 33B.

First, an operation example in which electric power is generated by the solar cell 7633 using external light is described. The voltage of electric power generated by the solar cell is raised or lowered by the DCDC converter 7636 to a voltage for charging the power storage unit 7635. When the display portion 7631 is operated with the electric power from the solar cell 7633, the switch SW1 is turned on and the voltage is raised or lowered by the converter 7637 to a voltage needed for the display portion 7631. When display on the display portion 7631 is not performed, the switch SW1 is turned off and the switch SW2 is turned on, so that the power storage unit 7635 is charged.

Note that the solar cell 7633 is described as an example of a power generation unit; however, one embodiment of the present invention is not limited to this example. The power storage unit 7635 may be charged using another power generation unit such as a piezoelectric element or a thermoelectric conversion element (Peltier element). For example, the charge may be performed with a non-contact electric power transmission module that performs charge by transmitting and receiving electric power wirelessly (without contact), or with a combination of the module and another charge unit.

FIG. 34 illustrates other examples of electronic devices. In FIG. 34, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. To improve safety, a protection circuit that prevents overcharging and/or overdischarging of the secondary battery 8004 may be electrically connected to the secondary battery 8004. The secondary battery 8004 of one embodiment of the present invention is provided in the housing 8001. The display device 8000 can be supplied with electric power from a commercial power source and can use electric power stored in the secondary battery 8004. Thus, the display device 8000 can be operated with the use of the secondary battery 8004 of one embodiment of the present invention as an uninterruptible power source even when electric power cannot be supplied from a commercial power source due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 34, an installation lighting device 8100 is an example of an electronic device including a secondary battery 8103 of one embodiment of the present invention. Specifically, the lighting device 8100 includes a housing 8101, a light source 8102, the secondary battery 8103, and the like. To improve safety, a protection circuit that prevents overcharging and/or overdischarging of the secondary battery 8103 may be electrically connected to the secondary battery 8103. Although FIG. 34 illustrates an example of the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power source and can use electric power stored in the secondary battery 8103. Thus, the lighting device 8100 can be operated with the use of the secondary battery 8103 of one embodiment of the present invention as an uninterruptible power source even when electric power cannot be supplied from a commercial power source due to power failure or the like.

Note that although the installation lighting device 8100 provided in the ceiling 8104 is illustrated in FIG. 34 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 34, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. To improve safety, a protection circuit that prevents overcharging and/or overdischarging of the secondary battery 8203 may be electrically connected to the secondary battery 8203. Although FIG. 34 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power source and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power source even when electric power cannot be supplied from a commercial power source due to power failure or the like.

Note that although the split-type air conditioner including the indoor unit and the outdoor unit is illustrated in FIG. 34 as an example, the secondary battery of one embodiment of the present invention can be used in an air conditioner in which the function of an indoor unit and the function of an outdoor unit are integrated in one housing.

In FIG. 34, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. To improve safety, a protection circuit that prevents overcharging and/or overdischarging of the secondary battery 8304 may be electrically connected to the secondary battery 8304. The secondary battery 8304 is provided in the housing 8301 in FIG. 34. The electric refrigerator-freezer 8300 can be supplied with electric power from a commercial power source and can use electric power stored in the secondary battery 8304. Thus, the electric refrigerator-freezer 8300 can be operated with the use of the secondary battery 8304 of one embodiment of the present invention as an uninterruptible power source even when electric power cannot be supplied from a commercial power source due to power failure or the like.

Note that among the electronic devices described above, a high-frequency heating apparatus such as a microwave oven and an electronic device such as an electric rice cooker require high electric power in a short time. Therefore, the tripping of a breaker of a commercial power source in use of the electronic device can be prevented by using the secondary battery of one embodiment of the present invention as an auxiliary power source for supplying electric power which cannot be supplied enough by a commercial power source.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power source.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

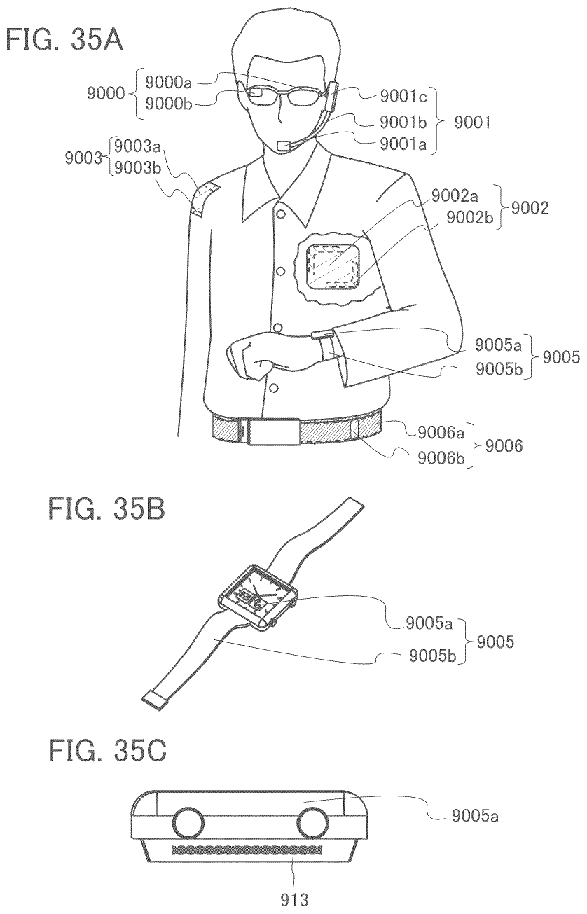

FIG. 35A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 9000 illustrated in FIG. 35A. The glasses-type device 9000 includes a frame 9000a and a display portion 9000b. The secondary battery is provided in a temple of the frame 9000a having a curved shape, whereby the glasses-type device 9000 can be lightweight, can have a well-balanced weight, and can be used continuously for a long time. To improve safety, a protection circuit that prevents overcharging and/or overdischarging of the secondary battery may be electrically connected to the secondary battery. With the use of the secondary battery of one embodiment of the present invention, space saving by downsizing of a housing can be achieved.

The secondary battery of one embodiment of the present invention can be provided in a headset-type device 9001. The headset-type device 9001 includes at least a microphone part 9001a, a flexible pipe 9001b, and an earphone portion 9001c. The secondary battery can be provided in the flexible pipe 9001b or the earphone portion 9001c. To improve safety, a protection circuit that prevents overcharging and/or overdischarging of the secondary battery may be electrically connected to the secondary battery. With the use of the secondary battery of one embodiment of the present invention, space saving by downsizing of a housing can be achieved.

The secondary battery of one embodiment of the present invention can be provided in a device 9002 that can be attached directly to a body. A secondary battery 9002b can be provided in a thin housing 9002a of the device 9002. To improve safety, a protection circuit that prevents overcharging and/or overdischarging of the secondary battery 9002b may be electrically connected to the secondary battery 9002b. With the use of the secondary battery of one embodiment of the present invention, space saving by downsizing of a housing can be achieved.

The secondary battery of one embodiment of the present invention can be provided in a device 9003 that can be attached to clothes. A secondary battery 9003b can be provided in a thin housing 9003a of the device 9003. To improve safety, a protection circuit that prevents overcharging and/or overdischarging of the secondary battery 9003b may be electrically connected to the secondary battery 9003b. With the use of the secondary battery of one embodiment of the present invention, space saving by downsizing of a housing can be achieved.

The secondary battery of one embodiment of the present invention can be provided in a belt-type device 9006. The belt-type device 9006 includes a belt portion 9006a and a wireless power feeding and receiving portion 9006b, and the secondary battery can be provided inside the belt portion 9006a. To improve safety, a protection circuit that prevents overcharging and/or overdischarging of the secondary battery may be electrically connected to the secondary battery. With the use of the secondary battery of one embodiment of the present invention, space saving by downsizing of a housing can be achieved.

The secondary battery of one embodiment of the present invention can be provided in a watch-type device 9005. The watch-type device 9005 includes a display portion 9005a and a belt portion 9005b, and the secondary battery can be provided in the display portion 9005a or the belt portion 9005b. To improve safety, a protection circuit that prevents overcharging and/or overdischarging of the secondary battery may be electrically connected to the secondary battery. With the use of the secondary battery of one embodiment of the present invention, space saving by downsizing of a housing can be achieved.

The display portion 9005a can display various kinds of information such as time and reception information of an e-mail and/or an incoming call.

In addition, the watch-type device 9005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 35B is a perspective view of the watch-type device 9005 that is detached from an arm.

FIG. 35C is a side view. FIG. 35C illustrates a state where the secondary battery 913 of one embodiment of the present invention is incorporated therein. The secondary battery 913, which is small and lightweight, overlaps with the display portion 9005a.

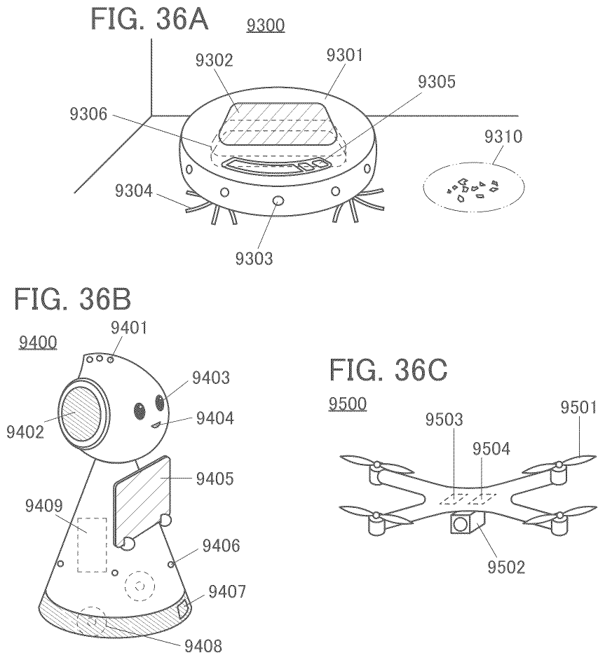

FIG. 36A illustrates an example of a cleaning robot. A cleaning robot 9300 includes a display portion 9302 placed on the top surface of a housing 9301, a plurality of cameras 9303 placed on the side surface of the housing 9301, a brush 9304, operation buttons 9305, a secondary battery 9306, a variety of sensors, and the like. To improve safety, a protection circuit that prevents overcharging and/or overdischarging of the secondary battery 9306 may be electrically connected to the secondary battery 9306. Although not illustrated, the cleaning robot 9300 is provided with a tire, an inlet, and the like. The cleaning robot 9300 is self-propelled, detects dust 9310, and sucks up the dust through the inlet provided on the bottom surface.

For example, the cleaning robot 9300 can determine whether there is an obstacle such as a wall, furniture, or a step by analyzing images taken by the cameras 9303. In the case where the cleaning robot 9300 detects an object, such as a wire, that is likely to be caught in the brush 9304 by image analysis, the rotation of the brush 9304 can be stopped. The cleaning robot 9300 includes a secondary battery 9306 of one embodiment of the present invention and a semiconductor device or an electronic component. The cleaning robot 9300 including the secondary battery 9306 of one embodiment of the present invention can be a highly reliable electronic device that can operate for a long time.

FIG. 36B illustrates an example of a robot. A robot 9400 illustrated in FIG. 36B includes a secondary battery 9409, an illuminance sensor 9401, a microphone 9402, an upper camera 9403, a speaker 9404, a display portion 9405, a lower camera 9406, an obstacle sensor 9407, a moving mechanism 9408, an arithmetic device, and the like. To improve safety, a protection circuit that prevents overcharging and/or overdischarging of the secondary battery 9409 may be electrically connected to the secondary battery 9409.

The microphone 9402 has a function of detecting a speaking voice of a user, an environmental sound, and the like. The speaker 9404 has a function of outputting sound. The robot 9400 can communicate with a user using the microphone 9402 and the speaker 9404.

The display portion 9405 has a function of displaying various kinds of information. The robot 9400 can display information desired by a user on the display portion 9405. The display portion 9405 may be provided with a touch panel. Moreover, the display portion 9405 may be a detachable information terminal, in which case charge and data communication can be performed when the display portion 9405 is set at the home position of the robot 9400.

The upper camera 9403 and the lower camera 9406 each have a function of taking an image of the surroundings of the robot 9400. The obstacle sensor 9407 can detect the presence of an obstacle in the direction where the robot 9400 advances with the moving mechanism 9408. The robot 9400 can move safely by recognizing the surroundings with the upper camera 9403, the lower camera 9406, and the obstacle sensor 9407.

The robot 9400 includes the secondary battery 9409 of one embodiment of the present invention and a semiconductor device or an electronic component. The robot 9400 including the secondary battery of one embodiment of the present invention can be a highly reliable electronic device that can operate for a long time.

FIG. 36C illustrates an example of a flying object. A flying object 9500 illustrated in FIG. 36C includes propellers 9501, a camera 9502, a secondary battery 9503, and the like and has a function of flying autonomously. To improve safety, a protection circuit that prevents overcharging and/or overdischarging of the secondary battery 9503 may be electrically connected to the secondary battery 9503.

For example, image data taken by the camera 9502 is stored in an electronic component 9504. The electronic component 9504 can analyze the image data to detect whether there is an obstacle in the way of the movement. Moreover, the electronic component 9504 can estimate the remaining battery level from a change in the power storage capacity of the secondary battery 9503. The flying object 9500 includes the secondary battery 9503 of one embodiment of the present invention. The flying object 9500 including the secondary battery of one embodiment of the present invention can be a highly reliable electronic device that can operate for a long time.

This embodiment can be implemented in appropriate combination with any of the other embodiments.

### Example 11

In this example, graphene of one embodiment of the present invention was fabricated and its physical properties were evaluated.

### <Fabrication of Graphene>

Graphene including fluorine was fabricated with reference to the flowchart in FIG. 6.

In Step S21, graphene oxide was prepared as the material 801. In Step S22, lithium fluoride was used as the material 802. In Step S23, lithium carbonate was used as the material 803.

In Step S31, 0.25 g of graphene oxide, 0.0125 g of lithium fluoride, 0.0125 g of lithium carbonate were mixed and collected in Step S32, whereby the mixture 804 was obtained in Step S33.

In Step S51, heating was performed. The heating conditions were 850° C., 10 hours, and a nitrogen atmosphere.

Next, in Step S52, the heated mixture was collected, whereby the graphene 583 was obtained in Step S53. The graphene 583 obtained in this example is hereinafter referred to as Sample Sm1.

### <Raman Spectroscopy>

NRS-5500 produced by JASCO corporation was used to measure Raman spectrum of Sample Sm1. The excitation wavelength was 532 nm. The measurement was performed at room temperature in an air atmosphere.

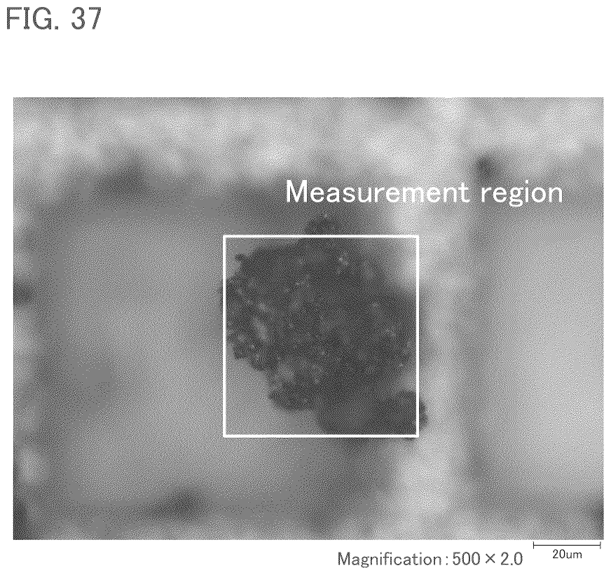

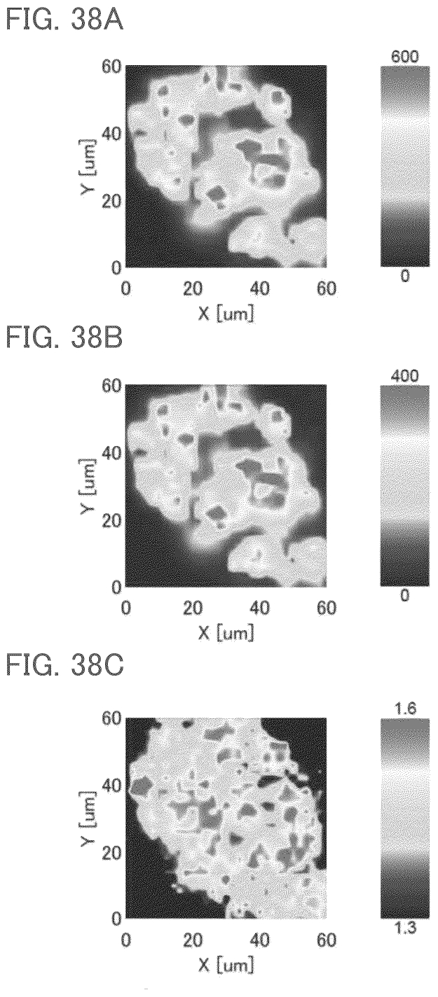

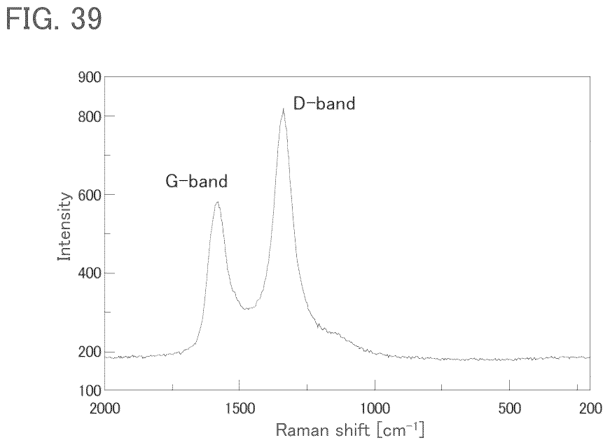

An optical micrograph of Sample Sm1 is illustrated in FIG. 37. FIG. 38A, FIG. 38B, and FIG. 38C show, respectively, the plane distribution in peak intensity of the D band, the plane distribution in peak intensity of the G band, and the ratio of the peak intensity of the D band to the peak intensity of the G band (D band peak intensity/G band peak intensity) in Raman spectra. FIG. 39 shows Raman spectrum in arbitrary positions of Sample Sm1.

G band was observed, which indicates sp² bond of carbon and the obtained Sample Sm1 contains graphene. In addition, D band was observed, which indicates the obtained graphene has a defect.

### <Tem Observation>

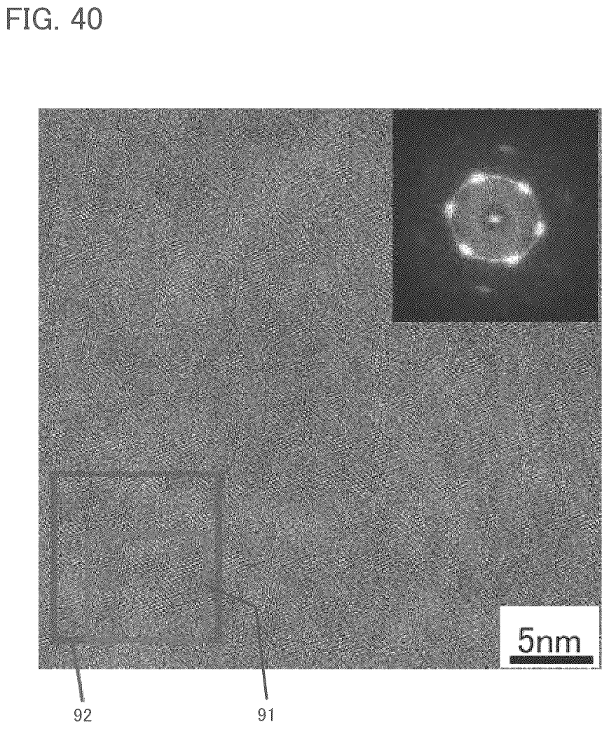

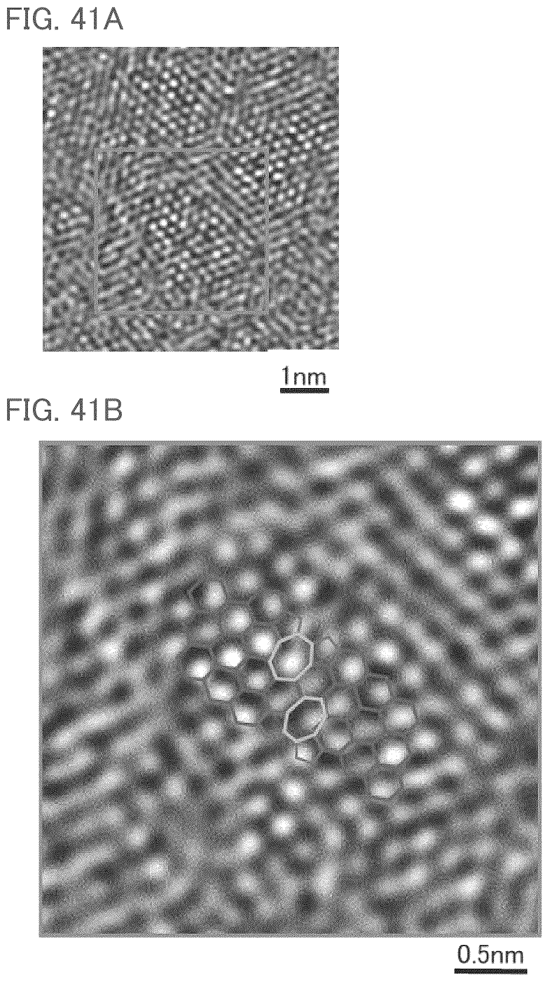

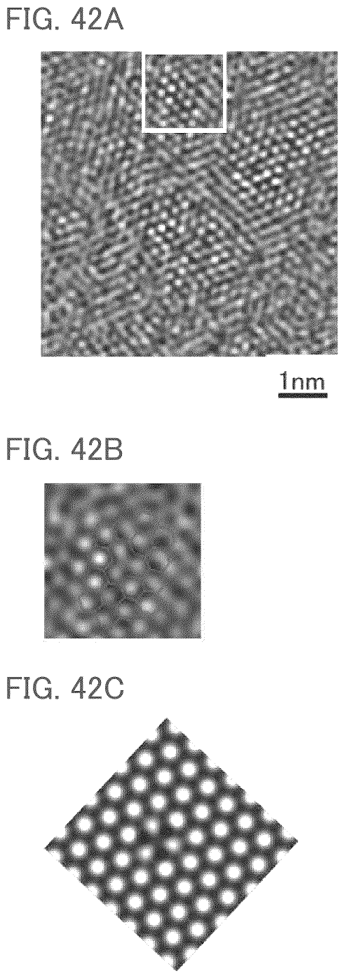

Next, Sample Sm1 was observed with TEM. For the observation, JEM-ARM200F produced by JEOL Ltd. was used. The accelerating voltage was 80 kV. The obtained TEM image is shown in FIG. 40. FIG. 41A and FIG. 42A show FFT filtering images of a region 91 shown by the square put in FIG. 40. FIG. 41B is an enlarged view of the region of the square put in FIG. 41A, and FIG. 42B is an enlarged view of the region of the square put in FIG. 42A.

The FFT filtering image refers to an image obtained by performing IFFT processing on an image that had obtained by performing FFT processing on a TEM image.

As shown in FIG. 41B, presence of a seven-membered ring was indicated.

As shown in FIG. 42B, presence of a twelve-membered ring is indicated. Note that the presence of the twelve-membered ring is indicated on the basis of the study using an image obtained by the first-principles calculation.

FIG. 42C shows a calculation result of the TEM image of the graphene with a twelve-membered ring. The structure of graphene with a twelve-membered ring is obtained by the first-principles calculation using a plane wave basis and a pseudo potential. GGA-PBE is used as the exchange-correlation functional. On the basis of the structure of graphene obtained by the first-principles calculation, an image defocused from a focus position is obtained by calculation from an aperture radius of an optical system for an electron beam, a convergence angle, and a spherical aberration coefficient. The acceleration voltage is 80 kV, the objective aperture radius is 6 nm⁻¹ the convergence angle is 0.3 mrad, and the defocus value is −10 nm.

It is indicated that the graphene of one embodiment of the present invention, which is obtained in this example, includes a many-membered ring such as a seven- or more-membered ring, and also includes a vacancy formed with a twelve-membered ring.

### <EDX>

Next, STEM image observation and EDX analysis of Sample Sm1 were performed.

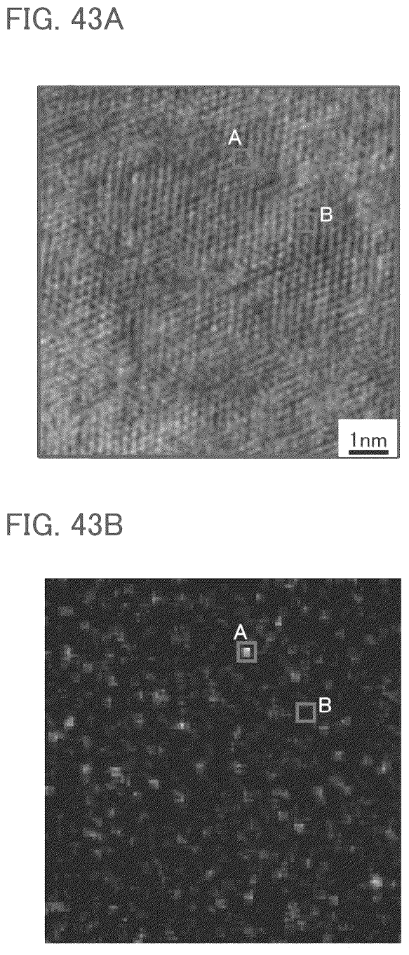

JEM-ARM200F produced by JEOL Ltd. was used for STEM observation and EDX analysis. The accelerating voltage was 80 kV. As an EDX analysis apparatus, JED-2300T produced by JEOL Ltd. was used. FIG. 43A shows a STEM image of the region 92 shown in FIG. 40. FIG. 43B shows an EDX plane analysis image corresponding to the observed point shown in FIG. 43A. When the spectrum of each of Region A and Region B shown by squares in the drawing was analyzed, fluorine was detected in each region. In addition, fluorine was detected in other regions and thus fluorine is considered to be widely distributed in a plane.

### REFERENCE NUMERALS

91: region, 92: region, 100: positive electrode active material, 130: stack, 131: stack, 500: secondary battery, 501: positive electrode current collector, 502: positive electrode active material layer, 503: positive electrode, 504: negative electrode current collector, 505: negative electrode active material layer, 506: negative electrode, 507: separator, 507a: region, 507b: region, 508: electrolyte, 509: exterior body, 509a: exterior body, 509b: exterior body, 510: positive electrode lead electrode, 511: negative electrode lead electrode, 512: stack, 513: resin layer, 514: region, 515a: electrolyte, 515b: electrolyte, 515c: electrolyte, 516: inlet, 550: stack, 560: secondary battery, 570: electrode, 570b: region, 571: current collector, 572: active material layer, 581: electrolyte, 582: particle, 582b: particle, 583: graphene, 584: acetylene black, 584b: material, 585: hole, 586: polymer film, 587: hole, 588: polymer film, 600: secondary battery, 670: fabricating apparatus, 671: component introduction chamber, 672: transfer chamber, 673: processing chamber, 676: component extraction chamber, 680: transfer mechanism, 691: stage, 694: nozzle, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 801: material, 802: material, 803: material, 804: mixture, 804b: mixture, 903: mixture, 904: mixture, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 970: secondary battery, 971: housing, 972: stack, 973a: positive electrode lead electrode, 973b: terminal, 973c: conductor, 974a: negative electrode lead electrode, 974b: terminal, 974c: conductor, 975a: positive electrode, 975b: positive electrode, 976: separator, 977a: negative electrode, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1415: battery pack, 1421: wiring, 1422: wiring, 2001: motor vehicle, 2002: transporter, 2003: transport vehicle, 2004: aircraft, 2005: transport vehicle, 2100: electric bicycle, 2101: secondary battery, 2102: power storage device, 2103: display portion, 2104: control circuit, 2201: battery pack, 2202: battery pack, 2203: battery pack, 2204: battery pack, 2300: scooter, 2301: side mirror, 2302: power storage device, 2303: indicator light, 2304: under-seat storage unit, 2603: vehicle, 2604: charging device, 2610: solar panel, 2611: wiring, 2612: power storage device, 2800: personal computer, 2801: housing, 2802: housing, 2803: display portion, 2804: keyboard, 2805: pointing device, 2806: secondary battery, 2807: secondary battery, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 7600: tablet terminal, 7625: switch, 7627: switch, 7628: operation switch, 7629: fastener, 7630: housing, 7630a: housing, 7630b: housing, 7631: display portion, 7631a: display portion, 7631b: display portion, 7633: solar cell, 7634: charge and discharge control circuit, 7635: power storage unit, 7636: DCDC converter, 7637: converter, 7640: movable portion, 8000: display device, 8001: housing, 8002: display portion, 8003: speaker portion, 8004: secondary battery, 8100: lighting device, 8101: housing, 8102: light source, 8103: secondary battery, 8104: ceiling, 8105: side wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 9000: glasses-type device, 9000a: frame, 9000b: display portion, 9001: headset-type device, 9001a: microphone part, 9001b: flexible pipe, 9001c: earphone portion, 9002: device, 9002a: housing, 9002b: secondary battery, 9003: device, 9003a: housing, 9003b: secondary battery, 9005: watch-type device, 9005a display portion, 9005b: belt portion, 9006: belt-type device, 9006a: belt portion, 9006b: wireless power feeding and receiving portion, 9300: cleaning robot, 9301: housing, 9302: display portion, 9303: camera, 9304: brush, 9305: operation button, 9306: secondary battery, 9310: dust, 9400: robot, 9401: illuminance sensor, 9402: microphone, 9403: upper camera, 9404: speaker, 9405: display portion, 9406: lower camera, 9407: obstacle sensor, 9408: moving mechanism, 9409: secondary battery, 9500: flying object, 9501: propeller, 9502: camera, 9503: secondary battery, 9504: electronic component

1. Graphene comprising a vacancy formed with a many-membered ring that is a nine- or more-membered ring composed of carbon atoms.

2. The graphene according to claim 1, wherein one or more of the carbon atoms included in the many-membered ring are terminated with fluorine.

3. The graphene according to claim 1, comprising a first peak observed at 1580 cm⁻¹ or in a neighborhood of 1580 cm⁻¹ and a second peak observed at 1360 cm⁻¹ or in a neighborhood of 1360 cm⁻¹ by Raman spectroscopy analysis.

4. An electrode comprising an active material particle and graphene,
wherein the graphene comprises a vacancy formed with a many-membered ring that is a nine- or more-membered ring composed of carbon atoms, and
wherein the graphene covers at least part of a surface of the active material particle.

5. The electrode according to claim 4,
wherein one or more of the carbon atoms included in the many-membered ring are terminated with fluorine.

6. The electrode according to claim 4,
wherein the graphene includes a first peak observed at 1580 cm⁻¹ or in a neighborhood of 1580 cm⁻¹ and a second peak observed at 1360 cm⁻¹ or in a neighborhood of 1360 cm⁻¹ by Raman spectroscopy analysis.

7. The electrode according to claim 4,
wherein the active material particle is a positive electrode active material particle.

8. The electrode according to claim 4,
wherein the active material particle is a negative electrode active material particle.

9. A secondary battery comprising:
the electrode according to claim 4, and
an electrolyte.

10. An electronic device comprising the secondary battery according to claim 9.

11. A vehicle comprising the secondary battery according to claim 9.
